(19) United States
(12) Patent Application Publication
(10) Pub. No.: US 2025/0356447 A1
(43) Pub. Date: Nov. 20, 2025

(54) METHODS, COMPUTER-READABLE STORAGE MEDIUMS, AND COMPUTING APPARATUS FOR OPERATING AN IDEA TRADING PLATFORM USING ARTIFICIAL INTELLIGENCE (AI) MODELS

(71) Applicant: Ideas Trading Center LLC, Princeton, NJ (US)

(72) Inventor: Ahmad Reza Kamarei, Princeton, NJ (US)

(21) Appl. No.: 19/279,618

(22) Filed: Jul. 24, 2025

Related U.S. Application Data
(63) Continuation-in-part of application No. PCT/US24/19440, filed on Mar. 11, 2024.
(60) Provisional application No. 63/489,676, filed on Mar. 10, 2023.

(51) Int. Cl. G06Q 50/18; G06Q 40/04

(52) U.S. Cl. CPC G06Q 50/184; G06Q 40/0421

(57) ABSTRACT

The present disclosure provides a method of operating an idea trading platform using artificial intelligence (AI) models. Further, the method may include validating first user credentials of a first user received through a first user interface to create an idea generator account. Further, the method includes evaluating the disclosure using an artificial intelligence (AI) model. Further, the method includes generating a patentability score using a first AI model based on the evaluating. Further, the method includes operating an ingestion engine to extract an idea title, an idea summary, and an idea specification and encoding the idea title, the idea summary, the idea specification, and the patentability score into an encoded package for storage. Further, the method includes generating an idea listing for display on a second user interface through operation of a listings generator. Further, the method includes notifying two or more idea purchaser accounts through operation of a reporter.

### FIELD OF INVENTION

The present disclosure relates to the field of data processing. More specifically, the present disclosure relates to methods, computer-readable storage mediums, and computing apparatus for operating an idea trading platform using artificial intelligence (AI) models.

### BACKGROUND

Traditional Complicated Method of benefiting from an idea is a method and system consisting of patenting the idea as an invention and then licensing or selling the patent. For this purpose, the idea initially needs to be reduced to practice, i.e., a prototype needs to be developed. This could be done by the idea generator and/or a third party under confidentiality agreement. As the next step, inventor hires a patent attorney or a patent agent to search the patents and literature to confirm that invention is patentable. Another search to check the marketability of the invention is highly recommended. The hired patent attorney/patent agent then prepares the patent application (provisional or non-provisional) and upon approval of the inventor, files the patent application with the US Patent and Trademark Office-USPTO (and possibly worldwide). After the patent application is filed with the USPTO, patent attorney/patent agent persistently prosecutes the patent application with the hope that the patent will be granted. The following quote from USPTO website clearly shows the difficulties of this Traditional Complicated Method: “The preparation of an application for patent and the conducting of the proceedings in the United States Patent and Trademark Office to obtain the patent is an undertaking requiring the knowledge of patent law and rules and Office practice and procedures, as well as knowledge of the scientific or technical matters involved in the particular invention. Inventors may prepare their own applications and file them in the USPTO and conduct the proceedings themselves, but unless they are familiar with these matters or study them in detail, they may get into considerable difficulty. While a patent may be obtained in many cases by persons not skilled in this work, there would be no assurance that the patent obtained would adequately protect the particular invention. Most inventors employ the services of “registered” patent attorneys or patent agents.”

If patent is granted (i.e., issued), the inventor (if the patent is not already assigned to others) can approach potential licensees or potential buyers with the hope of receiving royalty from licensing the patent or lump sum money from selling (assigning) the patent. Licensing is a time-consuming and costly process. The following quote from USPTO website clearly shows the difficulties of licensing a patent. “The drawing up of a license agreement (as well as assignments) is within the field of an attorney at law. Such an attorney should be familiar with patent matters as well. A few states have prescribed certain formalities to be observed in connection with the sale of patent rights.”

### (A) Patenting

The basic information concerning patents can be found on the website of the United States Patent and Trademark Office, USPTO (www.uspto.gov/patents/basics).

USPTO (or Office) is an agency of the U.S. Department of Commerce. The role of the USPTO is to grant patents for the protection of inventions and to register trademarks. It serves the interests of inventors and businesses with respect to their inventions and corporate products, and service identifications.

Through the preservation, classification, and dissemination of patent information, the Office promotes the industrial and technological progress of the nation and strengthens the economy. In discharging its patent related duties, the USPTO examines applications and grants patents on inventions when applicants are entitled to them.

A patent for an invention is the grant of a property right to the inventor, issued by the USPTO. Generally, the term of a new patent is 20 years from the date on which the application for the patent was filed in the United States.

The right conferred by the patent grant is “the right to exclude others from making, using, offering for sale, or selling” the invention in the United States or “importing” the invention into the United States. What is granted is not the right to make, use, offer for sale, sell or import, but the right to exclude others from making, using, offering for sale, selling or importing the invention. Once a patent is issued, the patentee must enforce the patent without aid of the USPTO.

### There are Three Types of Patents:

1. Utility patents may be granted to anyone who invents or discovers any new and useful process, machine, article of manufacture, or composition of matter, or any new and useful improvement thereof;
2. Design patents may be granted to anyone who invents a new, original, and ornamental design for an article of manufacture; and
3. Plant patents may be granted to anyone who invents or discovers and asexually reproduces any distinct and new variety of plant.

Any person who “invents or discovers any new and useful process, machine, manufacture, or composition of matter, or any new and useful improvement thereof, may obtain a patent,” subject to the conditions and requirements of the law. The word “process” is defined by law as a process, act, or method, and primarily includes industrial or technical processes. The term “machine” used in the statute needs no explanation. The term “manufacture” refers to articles that are made, and includes all manufactured articles. The term “composition of matter” relates to chemical compositions and may include mixtures of ingredients as well as new chemical compounds. These classes of subject matter taken together include practically everything that is made by man and the processes for making the products.

The patent law specifies that the subject matter must be “useful.” The term “useful” in this connection refers to the condition that the subject matter has a useful purpose and also includes operativeness, that is, a machine which will not operate to perform the intended purpose would not be called useful, and therefore would not be granted a patent.

Interpretations of the statute by the courts have defined the limits of the field of subject matter that can be patented, thus it has been held that the laws of nature, physical phenomena, and abstract ideas are not patentable subject matter.

A patent cannot be obtained upon a mere idea or suggestion. The patent is granted upon the new machine, manufacture, etc. and not upon the idea or suggestion of the new machine. A complete description of the actual machine or other subject matter for which a patent is sought is required.

In order for an invention to be patentable it must be new as defined in the patent law, which provides that an invention cannot be patented if: “(1) the claimed invention was patented, described in a printed publication, or in public use, on sale, or otherwise available to the public before the effective filing date of the claimed invention” or “(2) the claimed invention was described in a patent issued [by the U.S.] or in an application for patent published or deemed published [by the U.S.], in which the patent or application, as the case may be, names another inventor and was effectively filed before the effective filing date of the claimed invention.”

In the above patent prohibition (1), the term “otherwise available to the public” refers to other types of disclosures of the claimed invention such as, for example, an oral presentation at a scientific meeting, a demonstration at a trade show, a lecture or speech, a statement made on a radio talk show, a YouTube™ video, or a website or other on-line material. Even if the subject matter sought to be patented is not exactly shown by the prior art, and involves one or more differences over the most nearly similar thing already known, a patent may still be refused if the differences would be obvious. The subject matter sought to be patented must be sufficiently different from what has been used or described before that it may be said to be non-obvious to a person having ordinary skill in the area of technology related to the invention. For example, the substitution of one color for another, or changes in size, are ordinarily not patentable.

Congress established the United States Patent and Trademark Office to issue patents on behalf of the government. The USPTO administers the patent laws as they relate to the granting of patents for inventions, and performs other duties relating to patents. Applications for patents are examined to determine if the applicants are entitled to patents under the law and patents are granted when applicants are so entitled. The USPTO publishes issued patents and most patent applications 18 months from the earliest effective application filing date, and makes various other publications concerning patents.

The USPTO has no jurisdiction over questions of infringement and the enforcement of patents.

The work of examining applications for patents is divided among a number of examining Technology Centers (TCs) which provide examination for patent applications:

### Technology Center 1600: Biotechnology and Organic Fields

1620 Organic Chemistry
1650 Fermentation, Microbiology, Isolated and Recombinant Proteins/Enzyme
1610 Organic Compounds: Bio-affecting, Body Treating, Drug Delivery, Steroids, Herbicides, Pesticides, Cosmetics, and Drugs
1630 Molecular Biology, Bioinformatics, Nucleic Acids, Recombinant DNA and RNA, Gene Regulation, Nucleic Acid Amplification, Animals and Plants, Combinatorial/Computational Chemistry
1640 Immunology, Receptor/Ligands, Cytokines Recombinant Hormones, and Molecular Biology
1660 Plants

### Technology Center 1700: Chemical and Materials Engineering Fields

1740 Tires, Adhesive Bonding, Glass/Paper making, Plastics Shaping & Molding
1780 Miscellaneous Articles, Stock Material, Adhesive Composition, Fabrics
1790 Food, Analytical Chemistry, Sterilization, Biochemistry, Electrochemistry
1720 Fuel Cells, Batteries, Solar Cells, Liquid Crystal Composition
1760 Organic Chemistry, Polymers, Compositions
1770 Chemical Apparatus, Separation and Purification, Liquid and Gas Contact Apparatus
1710 Coating, Etching, Cleaning, Single Crystal Growth
1730 Metallurgy, Metal Working, Inorganic Chemistry, Catalysts, Electrophotography, Photolithography

### Technology Center 2100: Computer Architecture Software and Information Security

2110 Computer Error Control, Reliability, & Control Systems
2130 Memory Access and Control
2180 Computer Architecture and I/O
2150/2160 Data Bases & File Management
2190 Inter-process Communications & Software Development
2120 AI & Simulation/Modeling
2140/2170 Graphical User Interface and Document Processing

### Technology Center 2400: Computer Networks, Multiplex, Cable and Cryptography/Security

2410/2460/2470 Multiplex, VoIP
2420 Cable and Television
2480 Recording and Compression
2430/2490 Cryptography and Security
2440/2450 Computer Networks

### Technology Center 2600: Communications

2650 Videophones and Telephonic Communications; Audio Signals; Digital Audio Data Processing; Linguistics, Speech Processing and Audio Compression
2680 Telemetry and Code Generation; Vehicles and System Alarms; Selective Communication; Dynamic Storage Systems; Mechanical parts of Disk Drives; Signal Processing and Control Processing in Disk Drives
2620 Selective Visual Display Systems
2690 Selective Visual Display Systems
2630 Digital and Optical Communications
2640 Telecommunications: Analog Radio Telephone; Satellite and Power Control; Transceivers, Measuring and Testing; Bluetooth; Receivers and Transmitters; Equipment Details
2670 Facsimile; Printer; Color; halftone; Scanner; Computer Graphic Processing; 3-D Animation; Display Color; Attributes; Object Processing; Hardware and Memory
2610 Computer Graphic Processing, 3D Animation, Display Color Attribute, Object Processing, Hardware and Memory
2660 Digital Cameras; Image Analysis; Applications; pattern Recognition; Color and Compression; Enhancement and Transformation

### Technology Center 2800: Semiconductors, Electrical and Optical Systems and Components

2830/2840 Electrical Circuits and Systems
2850/2860 Printing/Measuring and Testing
2810/2820/2890 Semiconductors/Memory

### Technology Center 2900: Designs

Design

### Technology Center 3600: Transportation, Electronic Commerce, Construction, Agriculture, Licensing and Review

3610 Surface Transportation
3650 Material and Article Handling
3670 Wells, Earth Boring/Moving/Working, Excavating, Mining, Harvesters, Bridges, Roads, Petroleum, Closures, Connections, and Hardware
3620 Business Methods-Incentive Programs, Coupons; Operations Research; Electronic Shopping; Health Care; Point of Sale, Inventory, Accounting; Cost/Price, Reservations, Shipping and Transportation; Business Processing
3680 Business Methods-Incentive Programs, Coupons; Electronic Shopping; Business Cryptography, Voting; Health Care; Point of Sale, Inventory, Accounting; Business Processing, Electronic Negotiation
3690 Business Methods-Finance/Banking/Insurance
3630 Static Structures, Supports and Furniture
3640 Aeronautics, Agriculture, Fishing, Trapping, Vermin Destroying, Plant and Animal Husbandry, Weaponry, Nuclear Systems, and License and Review
3660 Computerized Vehicle Controls and Navigation, Radio Wave, Optical and Acoustic Wave Communication, Robotics, and Nuclear Systems

### Technology Center 3700: Mechanical Engineering, Manufacturing and Products

3710 Amusement and Education Devices
3720 Manufacturing Devices and Processes, Machine Tools and Hand Tools
3730 Sheet Container Making, Package Making, Receptacles, Shoes, Apparel, and Tool Driving or Impacting
3740 Thermal and Combustion Technology, Motive and Fluid Power Systems
3750 Fluid Handling and Dispensing
3760 Refrigeration, Vaporization, Ventilation, and Combustion
3770 Medical & Surgical Instruments, Treatment Devices, Surgery and Surgical Supplies
3780 Body Treatment, Kinestherapy, and Exercising
3790 Medical Instruments, Diagnostic Equipment, and Treatment Devices

It is notable that the above Technology Centers present a complicated method and system which is not suitable for an easy classification of ideas used in the present invention.

The fees charged to inventors by patent attorneys and agents for their professional services are not subject to regulation by the USPTO.

### a Non-Provisional Application for a Patent Includes:

1. A written document which comprises an idea specification (description and claims);
2. Drawings (when necessary)
3. An oath or declaration
4. Filing, search, and examination fees. Fees reduced by 50 percent for any qualified small entity and reduced by 75 percent for any qualified micro entity.

The filing date of an application for patent is the date on which an idea specification (including at least one claim) and any drawings necessary to understand the subject matter sought to be patented are received in the USPTO. USPTO offers inventors the option of filing a provisional application for patent, which was designed to provide a lower-cost first patent filing in the United States and to give U.S. applicants parity with foreign applicants. Claims and oath or declaration are not required for a provisional application. A provisional application provides the means to establish an early effective filing date in a patent application and permits the term “Patent Pending” to be applied in connection with the invention. Provisional applications may not be filed for design inventions. The filing date of a provisional application is the date on which a written description of the invention, and drawings, if necessary, are received in the USPTO. To be complete, a provisional application must also include the filing fee, and a cover sheet specifying that the application is a provisional application for patent. The applicant would then have up to 12 months to file a non-provisional application for patent as described above. The claimed subject matter in the later filed non-provisional application is entitled to the benefit of the filing date of the provisional application if it has support in the provisional application. Provisional applications are not examined on their merits. A provisional application will become abandoned by the operation of law 12 months from its filing date. The 12-month pendency for a provisional application is not counted toward the 20-year term of a patent granted on a subsequently filed non-provisional application that claims benefit of the filing date of the provisional application.

Publication of patent applications is required for patent applications filed on or after Nov. 29, 2000. On filing of a plant or utility application on or after Nov. 29, 2000, an applicant may request that the application not be published, but only if the invention has not been and will not be the subject of an application filed in a foreign country that requires publication 18 months after filing or under the Patent Cooperation Treaty. Publication occurs after the expiration of an 18-month period following the earliest effective filing date or priority date claimed by an application. Following publication, the application for patent is no longer held in confidence by the Office and any member of the public may request access to the entire file history of the application. As a result of publication, an applicant may assert provisional rights. These rights provide a patentee with the opportunity to obtain a reasonable royalty from a third party that infringes a published application claim provided actual notice is given to the third party by applicant, and patent issues from the application with a substantially identical claim. Thus, damages for pre-patent grant infringement by another are now available.

An oath or declaration is a formal statement that must be made by the inventor in a non-provisional application. Each inventor must sign an oath or declaration that includes certain statements required by law and the USPTO rules, including the statement that he or she believes himself or herself to be the original inventor or an original joint inventor of a claimed invention in the application and the statement that the application was made or authorized to be made by him or her.

An oath must be sworn to by the inventor before a notary public. A declaration may be submitted in lieu of an oath. A declaration does not need to be notarized. Oaths or declarations are required for design, plant, utility, and reissue applications. In addition to the required statements, the oath or declaration must set forth the legal name of the inventor, and, if not provided in an application data sheet, the inventor's mailing address and residence.

The idea specification must include a written “Description of the Invention” and of the manner and process of making and using it, and is required to be in such full, clear, concise, and exact terms as to enable any person skilled in the technological area to which the invention pertains, or with which it is most nearly connected, to make and use the same. The idea specification must set forth the precise invention for which a patent is solicited, in such manner as to distinguish it from other inventions and from what is old. It must describe completely a specific embodiment of the process, machine, manufacture, composition of matter, or improvement invented, and must explain the mode of operation or principle whenever applicable. The best mode contemplated by the inventor for carrying out the invention must be set forth. In the case of an improvement, the idea specification must particularly point out the part or parts of the process, machine, manufacture, or composition of matter to which the improvement relates, and the description should be confined to the specific improvement and to such parts as necessarily cooperate with it or as may be necessary to a complete understanding or description of it.

The “Title” of the invention, which should be as short and specific as possible (no more than 500 characters), should appear as a heading on the first page of the idea specification if it does not otherwise appear at the beginning of the application.

A brief “Abstract” of the technical disclosure in the idea specification, including that which is new in the art to which the invention pertains, must be set forth on a separate page preferably following the claims. The abstract should be in the form of a single paragraph of 150 words or less, under the heading “Abstract of the Disclosure.”

A “Brief Summary of the Invention” indicating its nature and substance, which may include a statement of the object of the invention, should precede the detailed description of the invention. The summary should be commensurate with the invention as claimed, and any object recited should be that of the invention as claimed.

The idea specification must conclude with a “Claim or Claims” particularly pointing out and distinctly claiming the subject matter that the applicant regards as the invention. The portion of the application in which the applicant sets forth the claim or claims is an important part of the application, as it is the claims that define the scope of the protection afforded by the patent and which questions of infringement are judged by the courts.

More than one claim may be presented, provided they differ substantially from each other and are not unduly multiplied. Claims may be presented in independent form (i.e., the claim stands by itself) or in dependent form, referring back to and further limiting another claim or claims in the same application. One or more claims may be presented in dependent form, referring back to and further limiting another claim or claims in the same application. Any dependent claim that refers back to more than one other claim is considered a “multiple dependent claim.” Multiple dependent claims shall refer to such other claims in the alternative only. A multiple dependent claim shall not serve as a basis for any other multiple dependent claim. Claims in dependent form shall be construed to include all of the limitations of the claim incorporated by reference into the dependent claim. A multiple dependent claim shall be construed to incorporate all the limitations of each of the particular claims in relation to which it is being considered. The claim or claims must conform to the invention as set forth in the remainder of the idea specification and the terms and phrases used in the claims must find clear support or antecedent basis in the description so that the meaning of the terms in the claims may be ascertainable by reference to the description.

Applications, other than provisional applications, filed in the USPTO and accepted as complete applications are assigned for examination to the respective examining Technology Centers having charge of the areas of technology related to the invention. In the examining TC, applications are taken up for examination by the examiner to whom they have been assigned in the order in which they have been filed or in accordance with examining procedures established by the Director. Applications will not be advanced out of turn for examination or for further action except as provided by the rules, or upon order of the Director to expedite the business of the Office, or upon a showing that, in the opinion of the Director, will justify advancing them. The examination of the application consists of a study of the application for compliance with the legal requirements and a search through U.S. patents, publications of patent applications, foreign patent documents, and available literature, to see if the claimed invention is new, useful and non-obvious and if the application meets the requirements of the patent statute and rules of practice. If the examiner's decision on patentability is favorable, a patent is granted.

If two or more inventions are claimed in a single application, and are regarded by the Office to be of such a nature (i.e., independent and distinct) that a single patent should not be issued for both of them, the applicant will be required to limit the application to one of the inventions. The other invention may be made the subject of a separate application which, if filed while the first application is still pending, will be entitled to the benefit of the filing date of the first application. A requirement to restrict the application to one invention may be made before further action by the examiner.

The applicant is notified in writing of the examiner's decision by an Office “Action” which is normally mailed to the attorney or agent of record. The reasons for any adverse action or any objection or requirement are stated in the Office action and such information or references are given as may be useful in aiding the applicant to judge the propriety of continuing the prosecution of his or her application. If the claimed invention is not directed to patentable subject matter, the claims will be rejected. If the examiner finds that the claimed invention lacks novelty or differs only in an obvious manner from what is found in the prior art, the claims may also be rejected. It is not uncommon for some or all of the claims to be rejected on the first Office action by the examiner; relatively few applications are allowed as filed.

The applicant must request reconsideration in writing, and must distinctly and specifically point out the supposed errors in the examiner's Office action. The applicant must reply to every ground of objection and rejection in the prior Office action. The applicant's reply must appear throughout to be a bona fide attempt to advance the case to final action or allowance. The mere allegation that the examiner has erred will not be received as a proper reason for such reconsideration. In amending an application in reply to a rejection, the applicant must clearly point out why he or she thinks the amended claims are patentable in view of the state of the art disclosed by the prior references cited or the objections made. He or she must also show how the claims as amended avoid such references or objections. After reply by the applicant, the application will be reconsidered, and the applicant will be notified as to the status of the claims—that is, whether the claims are rejected, or objected to, or whether the claims are allowed, in the same manner as after the first examination. The second Office action usually will be made final on the second or later consideration, the rejection or other action may be made final. The applicant's reply is then limited to appeal in the case of rejection of any claim and further amendment is restricted. Petition may be taken to the Director in the case of objections or requirements not involved in the rejection of any claim. Reply to a final rejection or action must include cancellation of, or appeal from the rejection of, each claim so rejected and, if any claim stands allowed, compliance with any requirement or objection as to form. In making such final rejection, the examiner repeats or states all grounds of rejection then considered applicable to the claims in the application.

If, on examination of the application, or at a later stage during the reconsideration of the application, the patent application is found to be allowable, a Notice of Allowance and Fee(s) Due will be sent to the applicant, or to applicant's attorney or agent of record. If timely payment of the fee(s) is not made, the application will be regarded as abandoned. The patent grant then is delivered or mailed on the day of its grant, or as soon thereafter as possible, to the inventor's attorney or agent if there is one of record, otherwise directly to the inventor. On the date of the grant, the patent file becomes open to the public for applications not opened earlier by publication of the application.

The patent is issued in the name of the United States under the seal of the United States Patent and Trademark Office, and is either signed by the Director of the USPTO or is electronically written thereon and attested by an Office official. The patent contains a grant to the patentee, and a printed copy of the idea specification and drawing is annexed to the patent and forms a part of it. The grant confers “the right to exclude others from making, using, offering for sale, or selling the invention throughout the United States or importing the invention into the United States” and its territories and possessions for which the term of the patent shall be generally 20 years from the date on which the application for the patent was filed in the United States. The exact nature of the right conferred must be carefully distinguished, and the key is in the words “right to exclude” in the phrase just quoted. The patent does not grant the right to make, use, offer for sale or sell or import the invention but only grants the exclusive nature of the right. Any person is ordinarily free to make, use, offer for sale or sell or import anything he or she pleases, and a grant from the government is not necessary. The patent only grants the right to exclude others from making, using, offering for sale or selling or importing the invention. Since the patent does not grant the right to make, use, offer for sale, or sell, or import the invention, the patentee's own right to do so is dependent upon the rights of others and whatever general laws might be applicable. A patentee, merely because he or she has received a patent for an invention, is not thereby authorized to make, use, offer for sale, or sell, or import the invention if doing so would violate any law.

A patentee may not make, use, offer for sale, or sell, or import his or her own invention if doing so would infringe the prior rights of others. A patentee may not violate the federal antitrust laws, such as by resale price agreements or entering into combination in restraints of trade, or the pure food and drug laws, by virtue of having a patent. Ordinarily there is nothing that prohibits a patentee from making, using, offering for sale, or selling, or importing his or her own invention, unless he or she thereby infringes another's patent that is still in force. The term of the patent shall be generally 20 years from the date on which the application for the patent was filed in the United States.

All utility patents are subject to the payment of maintenance fees which must be paid to maintain the patent in force. These fees are due at 3.5, 7.5 and 11.5 years from the date the patent is granted and can be paid without a surcharge during the “window period,” which is the six-month period preceding each due date, e.g., three years to three years and six months. Failure to pay the current maintenance fee on time may result in expiration of the patent. A six-month grace period is provided when the maintenance fee may be paid with a surcharge. The grace period is the six-month period immediately following the due date. The USPTO does not mail notices to patent owners that maintenance fees are due. If, however, the maintenance fee is not paid on time, efforts are made to remind the responsible party that the maintenance fee may be paid during the grace period with a surcharge. If the maintenance fee is not paid on time and the maintenance fee and surcharge are not paid during the grace period, the patent expires on the date the grace period ends.

After the patent has expired anyone may make, use, offer for sale, or sell or import the invention without permission of the patentee, provided that matter covered by other unexpired patents is not used.

The Office records assignments, grants, and similar instruments sent to it for recording, and the recording serves as notice. If an assignment, grant, or conveyance of a patent or an interest in a patent (or an application for patent) is not recorded in the Office within three months from its date, it is void against a subsequent purchaser.

The owner of a patent may grant licenses to others. Since the patentee has the right to exclude others from making, using, offering for sale, or selling or importing the invention, no one else may do any of these things without his or her permission. A patent license agreement is in essence nothing more than a promise by the licensor not to sue the licensee. No particular form of license is required; a license is a contract and may include whatever provisions the parties agree upon, including the payment of royalties, etc. Patents may be owned jointly by two or more persons as in the case of a patent granted to joint inventors, or in the case of the assignment of a part interest in a patent. Any joint owner of a patent, no matter how small the part interest, may make, use, offer for sale and sell and import the invention for his or her own profit provided they do not infringe another's patent rights, without regard to the other owners, and may sell the interest or any part of it, or grant licenses to others, without regard to the other joint owner, unless the joint owners have made a contract governing their relation to each other. It is accordingly dangerous to assign a part interest without a definite agreement between the parties as to the extent of their respective rights and their obligations to each other if the above result is to be avoided.

Infringement of a patent consists of the unauthorized making, using, offering for sale, or selling any patented invention within the United States or U.S. Territories, or importing into the United States of any patented invention during the term of the patent. If a patent is infringed, the patentee may sue for relief in the appropriate federal court. The patentee may ask the court for an injunction to prevent the continuation of the infringement and may also ask the court for an award of damages because of the infringement. In such an infringement suit, the defendant may raise the question of the validity of the patent, which is then decided by the court. The defendant may also aver that what is being done does not constitute infringement. Infringement is determined primarily by the language of the claims of the patent and, if what the defendant is making does not fall within the language of any of the claims of the patent, there is no literal infringement.

Suits for infringement of patents follow the rules of procedure of the federal courts. From the decision of the district court, there is an appeal to the Court of Appeals for the Federal Circuit. The Supreme Court may thereafter take a case by writ of certiorari. If the United States Government infringes a patent, the patentee has a remedy for damages in the United States Court of Federal Claims. The government may use any patented invention without permission of the patentee, but the patentee is entitled to obtain compensation for the use by or for the government. The Office has no jurisdiction over questions relating to infringement of patents. In examining applications for patent, no determination is made as to whether the invention sought to be patented infringes any prior patent. An improvement invention may be patentable, but it might infringe a prior unexpired patent for the invention improved upon, if there is one.

A patentee who makes or sells patented articles, or a person who does so for or under the patentee is required to mark the articles with the word “patent” and the number of the patent. The penalty for failure to mark is that the patentee may not recover damages from an infringer unless the infringer was duly notified of the infringement and continued to infringe after the notice. The marking of an article as patented when it is not in fact patented is against the law and subjects the offender to a penalty. Some people mark articles sold with the terms “Patent Applied For” or “Patent Pending.” These phrases have no legal effect, but only give information that an application for patent has been filed in the USPTO. The protection afforded by a patent does not start until the actual grant of the patent. False use of these phrases or their equivalent is prohibited.

Since the rights granted by a U.S. patent extend only throughout the territory of the United States and have no effect in a foreign country, an inventor who wishes patent protection in other countries must apply for a patent in each of the other countries or in regional patent offices. Almost every country has its own patent law, and a person desiring a patent in a particular country must make an application for patent in that country, in accordance with the requirements of that country. The laws of many countries differ in various respects from the patent law of the United States. In most foreign countries, publication of the invention before the date of the application will bar the right to a patent. Most foreign countries require that the patented invention must be manufactured in that country after a certain period, usually three years. If there is no manufacture within this period, the patent may be void in some countries, although in most countries the patent may be subject to the grant of compulsory licenses to any person who may apply for a license.

There is a treaty relating to patents adhered to by 176 countries (at the time of this printing), including the United States, and is known as the Paris Convention for the Protection of Industrial Property. It provides that each country guarantees to the citizens of the other countries the same rights in patent and trademark matters that it gives to its own citizens. The treaty also provides for the right of priority in the case of patents, trademarks and industrial designs (design patents). This right means that, on the basis of a regular first application filed in one of the member countries, the applicant may, within a certain period of time, apply for protection in all the other member countries. These later applications will then be regarded as if they had been filed on the same day as the first application. Thus, these later applicants will have priority over applications for the same invention that may have been filed during the same period of time by other persons. Moreover, these later applications, being based on the first application, will not be invalidated by any acts accomplished in the interval, such as, for example, publication or exploitation of the invention, the sale of copies of the design, or use of the trademark. The period of time mentioned above, within which the subsequent applications may be filed in the other countries, is 12 months in the case of first applications for patent and six months in the case of industrial designs and trademarks. Another treaty, known as the Patent Cooperation Treaty (PCT) is adhered to by over 148 countries including the United States. The treaty facilitates the filing of applications for patent on the same invention in member countries by providing, among other things, for centralized filing procedures and a standardized application format. The timely filing of an international application affords applicants an international filing date in each country which is designated in the international application and provides (1) a search of the invention and (2) a later time period within which the national applications for patent must be filed.

Under U.S. law it is necessary, in the case of inventions made in the United States, to obtain a license from the Director of the USPTO before applying for a patent in a foreign country. The filing of an application for a U.S. patent constitutes the request for a license and the granting or denial of such request is indicated in the filing receipt mailed to each applicant. After six months from the U.S. filing, a license is not required unless the invention has been ordered to be kept secret.

The patent laws of the United States make no discrimination with respect to the citizenship of the inventor. Any inventor, regardless of his or her citizenship, may apply for a patent on the same basis as a U.S. citizen. There are, however, a number of particular points of special interest to applicants located in foreign countries. The application for patent in the United States must be made by the inventor and the inventor must sign the oath or declaration (with certain exceptions), differing from the law in many countries where the signature of the inventor and an oath of inventorship are not necessary. No U.S. patent can be obtained if the invention was patented abroad before applying in the United States by the inventor or his or her legal representatives if the foreign application was filed more than 12 months before filing in the United States. An oath or alternatively a declaration must be made with respect to every application. When the applicant is in a foreign country the oath or affirmation may be before any diplomatic or consular officer of the United States, or before any officer having an official seal and authorized to administer oaths in the foreign country, whose authority shall be proved by a certificate of a diplomatic or consular officer of the United States. The oath is attested in all cases by the proper official seal of the officer before whom the oath is made. When the oath is taken before an officer in the country foreign to the United States, all the application papers (except the drawing) must be attached together and a ribbon passed one or more times through all the sheets of the application, and the ends of the ribbons brought together under the seal before the latter is affixed and impressed, or each sheet must be impressed with the official seal of the officer before whom the oath was taken. A declaration merely requires the use of a specific averment. A foreign applicant may be represented by any patent attorney or agent who is registered to practice before the United States Patent and Trademark Office.

### (B) Non-Profit Organizations Supporting Invention/Patenting

There are a few organizations which encourage, support and assist creative and innovative individuals to market their inventions.

National Academy of Inventors (www.academyofinventors.org) is a member organization comprising U.S. and international universities, and governmental and non-profit research institutes, with over 4,000 individual inventor members and Fellows spanning more than 250 institutions worldwide.

California Invention Center, CIC (www.californiainventioncenter.org) using the motto “today's inventions are tomorrow's products”, provides a focus on the process of invention as the key element in technology dispersion. The CIC activities are designed to encourage and facilitate creative individuals to draw on new and existing technologies to address societal needs and economic opportunities.

United Inventors Association of America, UIAUSA (www.uiausa.org) with the mission of “empowering investors through education”, provides educational resources and opportunities to the independent inventing community, while encouraging honest and ethical business practices among industry service provides.

### (C) References Concerning “Idea”

Other references concerning “Idea” were reviewed to ensure that the current invention is new, useful and not-obvious to those skilled in the art.
How to Sell an Idea (www.wikihow.com/Sell-an-Idea) is out of the idea specification of the present invention.
How to Sell an Idea (www.cbsnews.com/news/how-to-sell-an-idea/) is out of the idea specification of the present invention.
You Might Have A Great Idea, But Can You Sell It?(www.forbes.com/sites/wadefulton/2012/06/12/you-might-have-a-great-idea-but-can-you-sell-it/) is out of the idea specification of the present invention.
How to Protect Your Ideas Without a Patent (www.wikihow.com/protect-your-ideas-without-a-patent) is out of the idea specification of the present invention.

### (D) Invention Promoters/Promotion Firms

There are some for-profit firms that promote inventions using the Traditional Complicated Method of benefiting from an idea (i.e., converting idea to invention and patent, and then licensing or selling the patent). Invention promoters/promotion firms were reviewed to ensure that the present invention is new, useful and no-obvious to those skilled in the business of invention promotion. Invention promoters/promotion firms engage with inventors in different ways and at various stages of the Traditional Complicated Method as is evident from reviewing their websites:
Invent My Idea (www. Inventmyidea.com) business practice is out of the idea specification of the present invention.
Invention Home (patent.inventionhome.com) business practice is out of the idea specification of the present invention.
Invent Help (www. Inventhelp.com) business practice is out of the idea specification of the present invention.
Intellectual Ventures (www.intellectualventures.com) business practice is out of the idea specification of the present invention.
Tele Brands (www.telebrands.com) business practice is out of the idea specification of the present invention.
Davidson (https://idea.davison.com) business practice is out of the idea specification of the present invention.
Idea (www.Idea.com) business practice is out of the idea specification of the present invention.
Idea Connection (www.ideaconnection.com) business practice is out of the idea specification of the present invention.
Edison Nation (www.edisonnation.com) business practice is out of the idea specification of the present invention.
Tech Connect Hub (www.techconnecthub.com) business practice is out of the idea specification of the present invention.
For Sale by Inventor (https://forsalebyinventor.com) business practice is out of the idea specification of the present invention.
Invention Land (www.inventionland.com) business practice is out of the idea specification of the present invention.
Idea Lab (www.idealab.com) business practice is out of the idea specification of the present invention.
Idea Pros (www.ideapros.com) business practice is out of the idea specification of the present invention.
Aiello Design (www.aiellodesign.com) business practice is out of the idea specification of the present invention.
Enhance Innovations (www.enhancepd.com) business practice is out of the idea specification of the present invention.
Dr. Brooks Innovation (www.drbrooks-innovations.com) business practice is out of the idea specification of the present invention.
Invention City (www.inventioncity.com) business practice is out of the idea specification of the present invention.

Clearly, none of these invention promoters/promotion firms—who are skilled in the art—have come up with the Novel Easy Method of the present invention for trading ideas. The newness, usefulness and non-obviousness of the invented Novel Easy Method is quite evident.

### (E) Trade Secret

According to US Patent and Trademark Office, trade secrets can play a big role in a business's financial health and competitiveness. Trade secrets foster innovations and provide competitive advantages.

### A Trade Secret:

is information that has either actual or potential independent economic value by virtue of not being generally known,
has value to others who cannot legitimately obtain the information, and
is subject to reasonable efforts to maintain its secrecy. All three elements are required; if any element ceases to exist, then the trade secret will also cease to exist. Otherwise, there is no limit on the amount of time a trade secret is protected.

Examples of trade secrets include chemical formulas, food recipes, product design, customer and contact lists, pricing schedules, manufacturing techniques and marketing strategies.

While it is easy to understand the importance of a trade secret, underlying big name brand products or services, trade secrets come in all sizes and are important to companies of all sizes.

The failure to identify and protect trade secrets can result in loss of competitive advantage, loss of core business technologies and reduced profitability.

(F) Comparison of Novel Easy Method with Traditional Complicated Methods

The Novel Easy Method of benefiting from an idea with the Traditional Complicated Method of benefiting from an idea. Compared to the Novel Easy Method, all steps in the Traditional Complicated Method—except final step of patent selling or licensing—are considered costly avoidable steps. In Traditional Complicated Method, although reduction to practice (developing a prototype) needs some time and money, but the most expensive and time-consuming step is patenting (from hiring a registered patent attorney/agent to securing issuance of a patent). According to Invest NI (www.nibusinessinfo.co.uk), advantages and disadvantages of getting a patent are as follows: Advantages of Patents
A patent gives you the right to stop others from copying, manufacturing, selling or importing your invention without your permission.
You get protection for a pre-determined period, allowing you to keep competitors at bay.
You can then use your invention yourself.
Alternatively, you can license your patent for others to use it or you can sell it. This can provide an important source of revenue for your business.

### Disadvantages of Patents

Public Knows It: Your patent application means making certain technical information about your invention publicly available. It might be that keeping your invention secret may keep competitors at bay more effectively.
Time Window: Applying for a patent can be a very time-consuming and lengthy process (typically three to four years)—markets may change or technology may overtake your invention by the time you get a patent.
Cost: it will cost you money whether you are successful or not—the application, searches for existing patents and a patent attorney's fees can all contribute to a reasonable outlay [the cost of obtaining a patent in US is about $5,000 to $15,000]. The potential for making a profit should outweigh the time, effort and money it takes to get and maintain a patent. Not all patents have financial value.
Annual Fee: You'll need to remember to pay your annual fee or your patent will lapse.
Infringement: You'll need to be prepared to defend your patent. Taking action against an infringer can be very expensive. On the other hand, a patent can act as a deterrent, making defense unnecessary.
Countries One-by-One: Because patents are territorial, you will only be able to stop competition in the country in which you hold a patent. If you believe your invention has potential in other countries, and you intend to develop those markets, you will also need to budget for the cost of applying for a patent in your target market. You may be able to offset this cost against the patented item's projected income over the lifetime of the patent.

Further, the realm of innovation management and intellectual property valuation is a cornerstone of modern economic development. As businesses increasingly rely on intellectual assets to drive growth and competitive advantage, the ability to evaluate ideas for their potential as patentable inventions, novel contributions, or commercially viable concepts has become critical. This evaluation process is not merely administrative; it is a linchpin for fostering innovation, mitigating legal risks, and ensuring that valuable ideas are appropriately protected and commercialized.

The objective of this evaluation process is to enhance the efficiency and objectivity with which ideas can be assessed. Traditional methods often involve manual evaluations by experts, which can be time-consuming, prone to bias, and may lack consistency. Moreover, existing systems may struggle to scale with increasing volumes of submissions, potentially leading to delays in decision-making and reduced productivity for organizations.

One of the most significant challenges in this context is the limited capacity of traditional evaluation frameworks to handle the complexities of modern innovation ecosystems. For instance, evaluating the novelty of an idea or determining its utility often requires extensive prior art searches, which can be both labor-intensive and costly. Additionally, traditional workflows may lack integration with advanced tools for trend analysis or predictive analytics, making it difficult for organizations to stay ahead of emerging technological trends.

Another issue arises from the potential for bias in evaluation processes. Subjective assessments can lead to inconsistencies, where similar ideas are evaluated differently based on the evaluator's perspective. This can result in inefficiencies; as high-quality ideas may be overlooked or low-quality ones given undue consideration.

Moreover, the integration of patent search tools into evaluation systems is often cumbersome and may not provide comprehensive or reliable results. This can undermine the credibility of evaluations and create legal risks for organizations relying on such systems.

In summary, the challenges associated with existing evaluation methods highlight a pressing need for improved systems that can more effectively and efficiently assess ideas, reduce bias, and integrate advanced tools to support decision-making. Therefore, there is a need for improved methods, computer-readable storage mediums and computing apparatus of operating an idea trading platform using artificial intelligence (AI) models.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of operating an idea trading platform using artificial intelligence (AI) models. Further, the method may include validating first user credentials of a first user received through a first user interface to create an idea generator account. Further, the method may include receiving an idea package comprising a disclosure from the idea generator account. Further, the disclosure includes an idea title, an idea summary, and an idea specification. Further, the method may include evaluating the disclosure using one or more artificial intelligence (AI) models. Further, the one or more AI models includes a first artificial intelligence (AI) model. Further, the first AI model may be configured for assessing novelty, obviousness, and usefulness of the disclosure. Further, the method may include generating a patentability score using the first AI model based on the assessing of the novelty, the obviousness, and the usefulness of the disclosure. Further, the patentability score corresponds to a metric representing a patentability of the disclosure. Further, the method may include operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database. Further, the method may include generating an idea listing, comprising the idea title and the patentability score for display through a listings catalog on a second user interface comprising one or more idea listings through operation of a listings generator. Further, the listings catalog includes the idea listing. Further, the method may include notifying two or more idea purchaser accounts of the idea listing through operation of a reporter.

The present disclosure provides a computing apparatus for operating an idea trading platform using artificial intelligence (AI) models. Further, the computing apparatus may include a processor. Further, the computing apparatus may include a memory storing instructions to be executed by the processor. Further, the computing apparatus may be configured for validating first user credentials of a first user received through a first user interface to create an idea generator account. Further, the computing apparatus may be configured for receiving an idea package comprising a disclosure from the idea generator account. Further, the disclosure includes an idea title, an idea summary, and an idea specification. Further, the computing apparatus may be configured for evaluating the disclosure using one or more artificial intelligence (AI) models. Further, the one or more AI models includes a first artificial intelligence (AI) model. Further, the first AI model may be configured for assessing novelty, obviousness, and usefulness of the disclosure. Further, the computing apparatus may be configured for generating a patentability score using the first AI model based on the assessing of the novelty, the obviousness, and the usefulness of the disclosure. Further, the patentability score corresponds to a metric representing a patentability of the disclosure. Further, the computing apparatus may be configured for operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database. Further, the computing apparatus may be configured for generating an idea listing, comprising the idea title and the patentability score for display through a listings catalog on a second user interface comprising one or more idea listings through operation of a listings generator. Further, the listings catalog includes the idea listing. Further, the computing apparatus may include notifying two or more idea purchaser accounts of the idea listing through operation of a reporter.

The present disclosure provides a computer-readable storage medium for operating an idea trading platform using artificial intelligence (AI) models. Further, the computer-readable storage medium may include instructions that when executed by a computer, configure the computer for validating first user credentials of a first user received through a first user interface to create an idea generator account. Further, the computer-readable storage medium may include instructions that when executed by a computer, configure the computer for receiving an idea package comprising a disclosure from the idea generator account. Further, the disclosure includes an idea title, an idea summary, and an idea specification. Further, the computer-readable storage medium may include instructions that when executed by a computer, configure the computer for evaluating the disclosure using one or more artificial intelligence (AI) models. Further, the one or more AI models includes a first artificial intelligence (AI) model. Further, the first AI model may be configured for assessing novelty, obviousness, and usefulness of the disclosure. Further, the computer-readable storage medium may include instructions that when executed by a computer, configure the computer for generating a patentability score using the first AI model based on the assessing of the novelty, the obviousness, and the usefulness of the disclosure. Further, the patentability score corresponds to a metric representing a patentability of the disclosure. Further, the computer-readable storage medium may include instructions that when executed by a computer, configure the computer for operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database. Further, the computer-readable storage medium may include instructions that when executed by a computer, configure the computer for generating an idea listing, comprising the idea title and the patentability score for display through a listings catalog on a second user interface comprising one or more idea listings through operation of a listings generator. Further, the listings catalog includes the idea listing. Further, the computer-readable storage medium may include instructions that when executed by a computer, configure the computer for notifying two or more idea purchaser accounts of the idea listing through operation of a reporter.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an idea trading platform 100 in accordance with one embodiment.

FIG. 2 illustrates the idea trading platform 100 in accordance with one embodiment.

FIG. 3 illustrates the idea trading platform 100 in accordance with one embodiment.

FIG. 4 illustrates a user interface 400 in accordance with one embodiment.

FIG. 5 illustrates a user interface 500 in accordance with one embodiment.

FIG. 6 illustrates a user interface 600 accordance with one embodiment.

FIG. 7 illustrates a routine 700 in accordance with one embodiment.

FIG. 8 illustrates a routine 800 in accordance with one embodiment.

FIG. 9 illustrates a routine 900 in accordance with one embodiment.

FIG. 10 illustrates a routine 1000 in accordance with one embodiment.

FIG. 11 illustrates a routine 1100 in accordance with one embodiment.

FIG. 12 illustrates a simplified system 1200 in which a server 1204 and a client device 1206 are communicatively coupled via a network 1202.

FIG. 13 illustrates a system 1300 in accordance with one embodiment.

FIG. 14 is an example block diagram of a computing device 1400 that may incorporate embodiments of the present invention.

FIG. 15A illustrates a flowchart of a method 1500 of operating an idea trading platform using artificial intelligence (AI) models, in accordance with some embodiments.

FIG. 15B illustrates a continuation of the flowchart of the method 1500 of operating an idea trading platform using artificial intelligence (AI) models, in accordance with some embodiments.

FIG. 16 illustrates a flowchart of a method 1600 of operating an idea trading platform using artificial intelligence (AI) models including generating a patent search report, in accordance with some embodiments.

FIG. 17A illustrates a flowchart of a method 1700 of operating an idea trading platform using artificial intelligence (AI) models including generating the one or more idea listings for the second user, in accordance with some embodiments.

FIG. 17B illustrates a continuation of the flowchart of the method 1700 of operating an idea trading platform using artificial intelligence (AI) models including generating the one or more idea listings for the second user, in accordance with some embodiments.

FIG. 18 illustrates a flowchart of a method 1800 of operating an idea trading platform using artificial intelligence (AI) models including generating a commercial potential report, in accordance with some embodiments.

FIG. 19 illustrates a flowchart of a method 1900 of operating an idea trading platform using artificial intelligence (AI) models including generating at least one insight using the fourth additional AI model, in accordance with some embodiments.

FIG. 20 illustrates a flowchart of a method 2000 of operating an idea trading platform using artificial intelligence (AI) models including determining at least one risk associated with the patentability of an idea described in the disclosure using the fourth AI model, in accordance with some embodiments.

FIG. 21 illustrates a flowchart of a method 2100 of operating an idea trading platform using artificial intelligence (AI) models including updating the disclosure using at least one generative model, in accordance with some embodiments.

FIG. 22 illustrates a flowchart of a method 2200 of operating an idea trading platform using artificial intelligence (AI) models including operating the ingestion engine for encoding the legal insight to an encoded legal insight comprised in the encoded package for storage in the idea trading platform database, in accordance with some embodiments.

FIG. 23 is an illustration of an online platform 2300 consistent with various embodiments of the present disclosure.

FIG. 24 is a block diagram of a computing device 2400 for implementing the methods disclosed herein, in accordance with some embodiments.

### DETAILED DESCRIPTION

In an embodiment, a method of operating an idea trading platform involves validating first user credentials of a first user received through a first user interface to create an idea generator account. The method receives an idea package comprising a disclosure, idea classification, a declaration of ownership, and at least one list price from the idea generator account, wherein the disclosure comprises an idea title, an idea summary, and an idea specification. The method evaluates the disclosure for novelty, obviousness, and usefulness through operation of a comparator, wherein the comparator compares the idea classification and the disclosure to other intellectual property on patent publication databases, non-patent databases, and idea trading platform databases. The method operates an ingestion engine to extract the idea title, the idea summary, and the idea specification from the disclosure and encoding the idea summary and the idea specification into an encoded package comprising an encoded idea summary and an encoded idea specification for storage in the idea trading platform database. The method generates an idea listing, comprising the at least one list price and the idea title, for display through a listings catalog on a second user interface comprising a plurality of idea listings organized by the idea classifications of the plurality of idea listings through operation of the listings generator. The method notifies a plurality of idea purchaser accounts of the idea listing through operation of a reporter. The method receives funds from an idea purchaser account for the at least one list price and retrieves the encoded package through operation of an arbiter. The method decodes the encoded package and displaying a secure document viewer through the second user interface. The method transfers the funds to the idea generator account through operation of the arbiter and removes the idea listing from the listings catalog.

In an embodiment, the comparator may be configured to perform a patent search the disclosure. The comparator may be configured to run several patent searching techniques using automation. Patent searching techniques have evolved significantly through automation, leveraging advanced technologies to streamline and enhance the patent search process. One of the key automation methods used in patent searching is the utilization of specialized software tools and databases designed for patent searchers and intellectual property professionals. These tools employ various algorithms and search functionalities to efficiently retrieve relevant patent documents based on specific search criteria.

One common automation technique is the use of keyword-based searches. Patent search software allows users to input keywords, phrases, or technical terms related to their invention or area of interest. The software then scans vast patent databases, including global patent offices like the United States Patent and Trademark Office (USPTO), the European Patent Office (EPO), and the World Intellectual Property Organization (WIPO), to identify patents containing the specified keywords.

Another automation method is the use of classification systems and taxonomies. Patents are classified according to specific categories and subcategories based on their subject matter and technical fields. Automated patent search tools leverage these classification systems, such as the Cooperative Patent Classification (CPC) system, International Patent Classification (IPC) system, and United States Patent Classification (USPC) system, to narrow down search results and retrieve patents within specific technology areas or domains.

Natural language processing (NLP) and machine learning techniques are also increasingly used to automate patent searches. NLP algorithms analyze the text of patent documents to extract key concepts, identify relevant technical terms, and understand the context of patent claims and descriptions. Machine learning algorithms can then be trained on large datasets of patent documents to improve search accuracy, relevance, and efficiency over time.

Furthermore, citation analysis and patent family searching are automated techniques used to identify related patents and patent applications. Citation analysis involves examining the citations within patent documents to uncover prior art references, related inventions, and patent landscapes. Patent family searching involves identifying and retrieving related patents and applications filed in multiple countries or jurisdictions based on priority claims and family relationships.

In an embodiment, the method receives the first user credentials, comprising a first user identity, a first user nationality, and a first user account type, wherein the first user account type is selected as an idea generator. The method operates a validator to check the first user credentials against a plurality of stored accounts in a user credentials database, wherein the plurality of stored accounts comprises a plurality of idea generator account and the plurality of idea purchaser accounts. The method generates the idea generator account for the first user based on absence of matching both the first user identity and the first user nationality, in the plurality of idea generator account and the plurality of idea purchaser accounts.

The verification of a user's identity can be done through various means that such as uploading documents. Different types of documents serve as means for identity verification across various contexts. Government-issued photo identification documents, like passports, national identity cards, driver's licenses, and military IDs, are among the most common. These documents typically display a photograph of the individual, alongside essential details such as name, date of birth, and other identifying information. Birth certificates, official records issued by government authorities, record an individual's birth and are often used, particularly in cases where government-issued photo IDs are unavailable. Social security cards, unique to the United States, feature a nine-digit number assigned to individuals for social security purposes and are used for identity verification and employment eligibility. Additionally, utility bills, bank statements, and employment ID cards serve to verify identity and residency, providing names, addresses, and other pertinent details. Immigration documents, such as green cards, visas, and residence permits, confirm both identity and immigration status. Marriage certificates, student ID cards from educational institutions, voter registration cards, and various other official documents may also be utilized for identity verification, contingent upon the specific requirements of the organization or institution conducting the verification process.

The method receives second user credentials from the second user comprising a second user identity, a second user nationality, second user organization, and a second user account type, wherein the second user account type is selected as an idea purchaser. The method operates a validator to check the second user credentials against a plurality of stored accounts in a user credentials database, wherein the plurality of stored accounts comprises a plurality of idea generator account and the plurality of idea purchaser accounts. The method generates the idea purchaser account for the second user based on absence of matches for the second user identity and the second user nationality, and absence of restrictions for the second user organization in the plurality of idea generator account and the plurality of idea purchaser accounts.

The restrictions for the second user organization may be user limits setting restriction to how many users from an organization may sign up for a purchaser account. Other restrictions may include limits to how quickly users from a particular organization sign up. This may be done to prevent hostile actors from attempting to game the system.

In an embodiment, at least one list price comprises an idea summary list price and an idea specification list price.

In an embodiment, the idea purchaser account may be presented with an agreement following the purchase of an idea summary and an idea specification. The agreement displayed for the purchase of the idea summary may provide limitations as to the use of the information provided in the summary and bind the idea purchaser account to a non-disclosure agreement, in addition to restrictions based on international agreements. The agreement displayed for the purchase of the idea specification may provide different limitations and conditions for the transfer of the idea specification. These limitations and conditions may be based on the transfer of right for the idea.

In an embodiment, the method receives the funds from the idea purchaser account for the idea summary list price and retrieving the encoded package through operation of the arbiter. The method decodes the encoded package and extracts the encoded idea summary. The method communicates the encoded idea summary to the secure document viewer on the second user interface. The method operates the secure document viewer to decode and display the idea summary on the second user interface.

In an embodiment, the method receives the funds from the idea purchaser account for the idea specification list price and retrieving the encoded package through operation of the arbiter. The method decodes the encoded package and extracts the encoded idea summary and the encoded idea specification. The method communicates the encoded idea summary and the encoded idea specification to the secure document viewer on the second user interface. The method operates the secure document viewer to decode and display the idea summary and the idea specification on the second user interface.

In an embodiment, the encoding of disclosure may be done using an Advanced encryption standard (AES). Different encryption algorithms are utilized for securing document storage and viewing, each offering unique features and levels of security. Advanced Encryption Standard (AES) is one of the most widely used encryption algorithms for document storage and transmission. AES operates on symmetric-key cryptography, meaning the same key is used for both encryption and decryption. It offers high-speed encryption and supports key lengths of 128, 192, or 256 bits, making it highly secure against brute force attacks. Another commonly used encryption algorithm is Rivest-Shamir-Adleman (RSA), which operates on asymmetric-key cryptography. RSA utilizes public and private key pairs for encryption and decryption, with the public key used for encryption and the private key used for decryption. RSA is particularly useful for securely transmitting encryption keys and establishing secure communication channels. Additionally, Triple DES (3DES) is a symmetric-key encryption algorithm that applies the Data Encryption Standard (DES) cipher three times to increase security. While 3DES offers backward compatibility with legacy systems, it is slower and less secure compared to AES. Furthermore, Elliptic Curve Cryptography (ECC) is gaining popularity for its ability to provide strong encryption with shorter key lengths, making it suitable for resource-constrained environments such as mobile devices and IoT devices. ECC is based on the algebraic structure of elliptic curves over finite fields and offers high levels of security with shorter key lengths compared to traditional encryption algorithms.

In an embodiment, the idea listing is automatically removed after a predetermined time. The idea listing may be configured on a timer for sale that may be set by the idea trading platform to prevent idea listings from appearing too long in the listings catalog. In an embodiment the idea listing may be limited to 6 months before being pulled if no interests is presented in the idea.

In an embodiment, a computing apparatus comprises a processor and a memory storing instructions that, when executed by the processor, configure the apparatus to validate first user credentials of a first user received through a first user interface to create an idea generator account. The computing apparatus receives an idea package comprising a disclosure, idea classification, a declaration of ownership, and at least one list price from the idea generator account, wherein the disclosure comprises an idea title, an idea summary, and an idea specification. The computing apparatus evaluates the disclosure for novelty, obviousness, and usefulness through operation of a comparator, wherein the comparator compares the idea classification and the disclosure to other intellectual property on patent publication databases, non-patent databases, and idea trading platform databases. The computing apparatus operates an ingestion engine to extract the idea title, the idea summary, and the idea specification from the disclosure and encoding the idea summary and the idea specification into an encoded package comprising an encoded idea summary and an encoded idea specification for storage in the idea trading platform database. The computing apparatus generates an idea listing, comprising the at least one list price and the idea title, for display through a listings catalog on a second user interface comprising a plurality of idea listings organized by the idea classifications of the plurality of idea listings through operation of the listings generator. The computing apparatus notifies a plurality of idea purchaser accounts of the idea listing through operation of a reporter. The computing apparatus receives funds from an idea purchaser account for the at least one list price and retrieves the encoded package through operation of an arbiter. The computing apparatus decodes the encoded package and displaying a secure document viewer through the second user interface. The computing apparatus transfers the funds to the idea generator account through operation of the arbiter and removing the idea listing from the listings catalog.

In an embodiment, the computing apparatus receives the first user credentials, comprising a first user identity, a first user nationality, and a first user account type, wherein the first user account type is selected as an idea generator. The computing apparatus operates a validator to check the first user credentials against a plurality of stored accounts in a user credentials database, wherein the plurality of stored accounts comprises a plurality of idea generator account and the plurality of idea purchaser accounts. The computing apparatus generates the idea generator account for the first user based on absence of matching both the first user identity and the first user nationality, in the plurality of idea generator account and the plurality of idea purchaser accounts.

The computing apparatus receives second user credentials from the second user comprising a second user identity, a second user nationality, second user organization, and a second user account type, wherein the second user account type is selected as an idea purchaser. The computing apparatus operates a validator to check the second user credentials against a plurality of stored accounts in a user credentials database, wherein the plurality of stored accounts comprises a plurality of idea generator account and the plurality of idea purchaser accounts. The computing apparatus generates the idea purchaser account for the second user based on absence of matching the second user identity and the second user nationality, and absence of restrictions for the second user organization in the plurality of idea generator account and the plurality of idea purchaser accounts.

In an embodiment, at least one list price comprises an idea summary list price and an idea specification list price.

In an embodiment, the computing apparatus is configured to receive the funds from the idea purchaser account for the idea summary list price and retrieve the encoded package through operation of the arbiter. The computing apparatus decodes the encoded package and extracts the encoded idea summary. The computing apparatus communicates the encoded idea summary to the secure document viewer on the second user interface. The computing apparatus operates the secure document viewer to decode and display the idea summary on the second user interface.

In an embodiment, the computing apparatus is configured to receive the funds from the idea purchaser account for the idea specification list price and retrieve the encoded package through operation of the arbiter. The computing apparatus decodes the encoded package and extracts the encoded idea summary and the encoded idea specification. The computing apparatus communicates the encoded idea summary and the encoded idea specification to the secure document viewer on the second user interface. The computing apparatus operates the secure document viewer to decode and display the idea summary and the idea specification on the second user interface.

In an embodiment, the secure document viewer may be a web based document viewer opened through a browser. Web-based secure document viewers are online tools or applications designed to enable users to securely view documents over the internet while maintaining confidentiality, integrity, and accessibility. These viewers often incorporate encryption, access controls, and other security measures to protect sensitive information from unauthorized access and ensure that documents are viewed only by authorized individuals. They allow users to access documents from any device with an internet connection, eliminating the need to download or store files locally, which reduces the risk of data breaches or loss. Web-based secure document viewers typically support various file formats, including PDF, Microsoft Office documents, images, and videos, providing users with a versatile platform for viewing a wide range of content. Additionally, these viewers often offer features such as watermarking, digital rights management (DRM), document expiration, and audit trails to further enhance security and compliance with regulatory requirements.

In an embodiment, the idea listing is automatically removed after a predetermined time.

In an embodiment, a non-transitory computer-readable storage medium, the computer-readable storage medium including instructions that when executed by a computer, cause the computer to validate first user credentials of a first user received through a first user interface to create an idea generator account. The instructions cause the computer to receive an idea package comprising a disclosure, idea classification, a declaration of ownership, and at least one list price from the idea generator account, wherein the disclosure comprises an idea title, an idea summary, and an idea specification. The instructions cause the computer to evaluate the disclosure for novelty, obviousness, and usefulness through operation of a comparator, wherein the comparator compares the idea classification and the disclosure to other intellectual property on patent publication databases, non-patent databases, and idea trading platform databases. The instructions cause the computer to operate an ingestion engine to extract the idea title, the idea summary, and the idea specification from the disclosure and encoding the idea summary and the idea specification into an encoded package comprising an encoded idea summary and an encoded idea specification for storage in the idea trading platform database. The instructions cause the computer to generate an idea listing, comprising the at least one list price and the idea title, for display through a listings catalog on a second user interface comprising a plurality of idea listings organized by the idea classifications of the plurality of idea listings through operation of the listings generator. The instructions cause the computer to notify a plurality of idea purchaser accounts of the idea listing through operation of a reporter. The instructions cause the computer to receive funds from an idea purchaser account for the at least one list price and retrieving the encoded package through operation of an arbiter. The instructions cause the computer to decode the encoded package and display a secure document viewer through the second user interface. The instructions cause the computer to transfer the funds to the idea generator account through operation of the arbiter and remove the idea listing from the listings catalog.

In an embodiment, the computer-readable storage medium includes instructions that cause the computer to receive the first user credentials, comprising a first user identity, a first user nationality, and a first user account type, wherein the first user account type is selected as an idea generator. The instructions cause the computer to operate a validator to check the first user credentials against a plurality of stored accounts in a user credentials database, wherein the plurality of stored accounts comprises a plurality of idea generator account and the plurality of idea purchaser accounts. The instructions cause the computer to generate the idea generator account for the first user based on absence of matching both the first user identity and the first user nationality, in the plurality of idea generator account and the plurality of idea purchaser accounts.

In an embodiment, the computer-readable storage medium includes instructions that cause the computer to receive second user credentials from the second user comprising a second user identity, a second user nationality, second user organization, and a second user account type, wherein the second user account type is selected as an idea purchaser. The instructions cause the computer to operate a validator to check the second user credentials against a plurality of stored accounts in a user credentials database, wherein the plurality of stored accounts comprises a plurality of idea generator account and the plurality of idea purchaser accounts. The instructions cause the computer to generate the idea purchaser account for the second user based on absence of matching the second user identity and the second user nationality, and absence of restrictions for the second user organization in the plurality of idea generator account and the plurality of idea purchaser accounts.

In an embodiment, the at least one list price comprises an idea summary list price and an idea specification list price.

In an embodiment, the computer-readable storage medium includes instructions that cause the computer to receive the funds from the idea purchaser account for the idea summary list price and retrieve the encoded package through operation of the arbiter. The instructions cause the computer to decode the encoded package and extract the encoded idea summary. The instructions cause the computer to communicate the encoded idea summary to the secure document viewer on the second user interface. The instructions cause the computer to operate the secure document viewer to decode and display the idea summary on the second user interface.

In an embodiment, the computer-readable storage medium includes instructions that cause the computer to receive the funds from the idea purchaser account for the idea specification list price and retrieving the encoded package through operation of the arbiter. The instructions cause the computer to decode the encoded package and extracting the encoded idea summary and the encoded idea specification. The instructions cause the computer to communicate the encoded idea summary and the encoded idea specification to the secure document viewer on the second user interface. The instructions cause the computer to operate the secure document viewer to decode and display the idea summary and the idea specification on the second user interface.

In an embodiment, the idea trading platform may be operated to address the following unmet needs:
1. What should creative people around the globe who come up with new, useful and non-obvious ideas do if they cannot afford to reduce their ideas to practice (develop prototype)?
2. What should such creative people do if they cannot afford to pay the filing fees for a patent application (application filing, search, examination and post-allowance) in one country let alone several countries (PCT fees include national stage, international stage and fees to foreign offices)?
3. What should such creative people do if they cannot afford to hire a registered patent attorney/patent agent?
4. What should such creative people do if they cannot wait to complete the time-consuming and lengthy process of patenting to see if they can finally benefit from their idea knowing that few inventions make it to the marketplace and fewer still are commercially successful?
5. What should such creative people do if they cannot handle the legal complexity and ups and downs of patenting their ideas and, if their patent is issued, the time-consuming and costly licensing process?
6. Should such creative people disclose their new, useful and non-obvious ideas for free without any financial reward, or should they remain unsupported and unappreciated?
7. Should society prevent such creative people's new, useful and non-obvious ideas from coming to fruition for the sake of promoting the scientific and technological progress of the nations and strengthening their economies?
8. How can businesses have their fingers on the pulse of the global pool of creative minds?
9. How can businesses stay ahead of their competition?
10. How can businesses be alerted to new ideas as soon as the ideas become available?
11. How can businesses buy in-confidence a new, useful and non-obvious idea in their field of business and keep it as a trade secret or apply for a patent?
12. What should businesses that have difficulty hiring creative employees (particularly research and development) do to benefit from new, useful and non-obvious ideas to kindle their business enterprises?
13. What should businesses that have difficulty paying for all costs related to obtaining a patent do to be competitive in their business enterprises?

In response, the idea trading platform may be operated in accordance with a computerized method for trading ideas that allows authenticated idea generators to classify their original new, useful and non-obvious ideas according to the Nice Agreement concerning international classification of goods and services and sell their classified ideas directly and confidentially to idea reviewers and/or buyers.

### Features and Benefits of Novel Easy Method:

Simplicity (for both idea sellers and idea buyers)
Efficiency (direct sale, no patenting, no licensing)
Versatility (availability of ideas on all goods and services)
Low cost (aside from a negligible examination fee, there is no cost to the idea sellers)
Fast result (time to determining if an idea is sellable is less than 6 months)
Contingent service fee (service fee to the independent idea trading center will be paid only if the idea is reviewed for pay and/or it is sold to a buyer)
Mutual benefit (both idea sellers and idea buyers benefit from trading ideas using this method)

In an embodiment, the present invention is practiced as follows:

### Step 1) Signing Declaration

As a first part of submission of an idea for registration, idea generator must sign a declaration (fillable PDF form) to assure potential idea reviewer(s) or buyer that the followings are true to the best of his/her knowledge:
1. Authentication of the idea generator: proving he/she is the original generator, owner and seller of the idea (intellectual property), and all rights, title and interests of the idea fully belong to him/her without any deception or false representation.
2. Originality of the idea: his/her idea is new and useful, all information about his/her idea is true, he/she has not copied the idea from anybody's else idea, invention or patent (published or pending).
3. Non-obviousness of the idea: his/her idea has not been obvious to others, does not involve one or more obvious differences (for example, substitution of one color for another or changes in size) over the most nearly similar thing already known, his/her idea is sufficiently different from what has been used or described before.
4. Free and clear status of the idea: he/she has not applied for any patent, trademark or copyright at any intellectual property/patent office, nor he/she has sold, licensed, pledged or assigned his/her idea or substantially the same idea to any third party.
5. Lack of earlier disclosure of the idea: his/her idea has not described in any printed publication, or in public use, or on sale, or otherwise available to the public (for example speech, statement made on a radio talk show, a YouTube™ video, or a website or other on-line materials, oral presentation at a scientific meeting, a demonstration at a trade show or a lecture) before its submission for registration, six (6) months after its submission (“the sales period”) and at no time if the idea is sold.
6. Lack of omission: he/she has not omitted or hidden any important information from his/her idea.

### Step 2) Preparation of the Idea for Submission

The idea generator should complete a pre-approved fillable PDF or any suitable computerized form (“Idea Registration Form”) showing the title of the idea, designating class of the idea, writing detailed description and summary description of the idea, and suggesting the selling price for the idea.
1. Title of the idea: must be truthful reflecting the totality of the idea.
2. Designated class of the idea before submission:

Rationale: Each day, creative individuals around the globe come up with countless numbers of ideas which are new, useful and non-obvious. If these ideas are not properly classified, the result will be a chaotic situation where there is not any efficient way to manage these ideas, let alone to benefit the idea seller and idea buyer. Without an easy, reliable, internationally recognized classification system, implementation of the Novel Easy Method will not be possible. In other words, idea trading is not possible without a designated “Class” for the idea. Classification of ideas according to International Patent Classification (IPC) or according to Cooperative Patent Classification (CPC) is complicated and needs knowledge and expertise usually found with the technical employees of patent offices.

IPC provides a hierarchical system of language independent symbols for the classification of patents and utility models according to the different areas of technology to which they pertain. CPC is the result of a partnership between the EPO and the USPTO in their joint effort to develop a common, internationally compatible classification system for technical documents, in particular patent publications, which will be used by both offices in the patent granting process.

The CIP and CPC classification systems are not easy or practical to use for an average idea generator in different countries around the globe.

We need an easy, reliable and internationally recognized classification system for ideas.

In the current innovation, the idea generator should designate, in the pre-approved fillable PDF form for idea preparation, the “Class” of goods or services according to the Nice Agreement concerning the international classification of goods and services. For each idea, designation of up to two classes are acceptable (the first designation is mandatory, and the second designation is optional).

The Nice Agreement is a multilateral treaty, administered by the World Intellectual Property Organization (WIPO), establishes the international classification of goods and services for the purposes of registering trademarks and service marks. The trademark offices of contracting states must indicate, in official documents and publications in connection with each registration, the numbers of the classes of the classification to which the goods or services for which the mark is registered belong. Use of the Nice Classification is mandatory not only for the national registration of marks in countries party to the Nice Agreement, but also for the international registration of marks effected by the African Intellectual Property Organization (OAPI), the African Regional Intellectual Property Organization (ARIPO), the Benelux Office for Intellectual Property (BOIP), the European Union Intellectual Property Office (EUIPO) and the International Bureau of World Intellectual Property Organization (WIPO). The Nice Classification is also applied in a number of countries not party to the Nice Agreement.

Classes of Goods and Services according to the Nice Agreement concerning the international classification of goods and services are as follows (goods=products):

### Goods:

Class 1: Chemicals
Class 2: Paints
Class 3: Cosmetics and Cleaning Preparations
Class 4: Lubricants and Fuels
Class 5: Pharmaceuticals Class 6: Metal Goods
Class 7: Machinery Class 8: Hand Tools
Class 9: Electrical and Scientific Apparatus
Class 10: Medical Apparatus
Class 11: Environmental Control Apparatus
Class 12: Vehicles
Class 13: Firearms (ideas will not be accepted)
Class 14: Jewelry
Class 15: Musical Instruments
Class 16: Paper Goods and Printed Matter
Class 17: Rubber Goods
Class 18: Leather Goods
Class 19: Non-Metallic Building Materials
Class 20: Furniture and articles not otherwise classified
Class 21: Housewares and Glass
Class 22: Cordage and Fibers
Class 23: Yarns and Threads
Class 24: Fabrics
Class 25: Clothing
Class 26: Fancy Goods
Class 27: Floorcoverings
Class 28: Toys and Sporting Goods
Class 29: Meats and Processed Foods
Class 30: Staple Foods
Class 31: Natural Agricultural Products
Class 32: Light Beverages
Class 33: Wines and Spirits
Class 34: Smokers Articles (ideas will not be accepted)

### Services:

Class 35: Advertising and Business
Class 36: Insurance and Financial
Class 37: Building Construction and Repair
Class 38: Communications
Class 39: Transportation and Storage
Class 40: Materials Treatment
Class 41: Education and Entertainment
Class 42: Computer and Scientific
Class 43: Hotels and Restaurants
Class 44: Medical, Beauty and Agricultural
Class 45: Personal and Legal

### Detailed Description of the Idea Covers the Following Aspects of the Idea:

The problem that the idea generator wants to solve or the challenge he/she wants to meet.
The new idea or solution-described accurately and adequately, that solves the problem and meets the challenge.
Feasibility/operativeness of the idea.
Readiness of the idea for implementation (e.g., developed prototype).
Extent and breadth of usefulness of the idea to customers or consumers.
Cost of idea implementation.
Profitability of the idea, if implemented.
Potential market of the idea, if implemented
Competitive advantages of the productor service developed based on the idea, if implemented.
If available, figures, graphs and charts to better convey the idea to potential buyers.

### Summary Description of the Idea Covers the Following Aspects:

Accurate and true representative summary of the detailed description of the idea in one non-misleading paragraph. Nothing should be written in the summary description of idea that is not already written in the detailed description of the idea.

### Suggested Selling Price for the Idea:

The idea generator should suggest a reasonable selling price for his/her idea. This request is made from the available table of idea prices (for example between $1,000 to $10,000). Review of summary description of idea by potential buyers (without any limit in the number of reviewers) will earn seller between twenty percent (20%) to forty percent (40%) of the suggested selling price from each reviewer.

### Step 3) Submission of the Idea for Examination, Registration and Posting

The Idea generator confidentially submits his/her idea in a completed fillable PDF form to an independent idea trading center for examination and, upon acceptance, registration and posting.
1. Acceptable Ideas: Ideas may be about any new and useful process, act, method, machine, manufacture (articles that are made and all manufactured articles), composition of matter (chemical compositions including mixtures of ingredients as well as new chemical compounds), or any new and useful improvement thereof.
2. Unacceptable Ideas:
   Ideas about the laws of nature and physical phenomena.
   Ideas promoting restriction or abuse of human rights, discrimination, hatred, crimes, hate crime, violence, terrorism, narcotics and substance misuse, pornography and suicide.
   Ideas about firearms and smoking articles.
      Step 4) Examination, Registration and Posting of the Ideas for Sale of Entire Idea and/or Paid Review of Summary Description of the Idea

Upon receipt of the idea by the independent idea trading center, it is examined to make sure that idea submission/registration form is filled out property and completely, it does not contain misspelling and/or grammatical errors, and the small examination fee is paid.

The accepted ideas are assigned an Idea Number and securely preserved in three separate files: File 1) Original Submission/Registration Form (archived), File 2) Buy Entire Idea, File 3) Review Summary Description. At this time, registration of the Idea is complete.

For posting the idea, the following information about the registered Idea will be included in the List of Registered Ideas which is organized according to the Nice Agreement concerning the international classification of goods and services (goods=products):
Designated class of the Idea
Idea number
Title of idea
Price for buying entire idea.
Price for review of summary description of the idea

In the List of Registered Ideas, the most recently accepted idea will be placed at the top of other ideas in its class.

Step 5) Buying Entire Idea and/or Reviewing Summary Description of the Idea

Potential buyers visit the list of posted Registered Ideas and choose a summary description of the ideas they want to review, or the entire ideas they want to buy. Upon agreeing to the terms of the trade, buyer can download PDF file of either summary description of the idea or the entire idea. This transaction is considered final with no cancellation, return or refund.

While all rights, title and interests of the idea are transferred to the buyer of the entire idea, no rights, title or interests of the idea is transferred to the reviewers of summary description.

However, there is no limit on the number of reviewers for summary description.

### Step 6) Monetary Compensation of the Idea Generator

The idea generator will receive his/her monetary compensation from the paid review(s) and/or sale of his/her idea. In a specific embodiment, the present invention is practiced as follows:

An online method, system, program or application (“app”) is used in a way that authenticated idea generators classify their original new, useful and non-obvious ideas according to the Nice Agreement concerning international classification of goods and services and sell their ideas directly and confidentially to idea reviewers and/buyer.

The following forty-three (43) examples are included herein as exemplary embodiments of the present invention.

Example 1) An idea generator from Brazil filled and signed the declaration form (authenticating his identity, originality and ownership of his new, useful and non-obvious idea), prepared his idea by completing the pre-authorized document format including (title: New valuable bio-compounds from agricultural waste) and designated Class of his idea according to the Nice Agreement concerning international classification of goods and services (Class 1: Chemicals), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 1 in the list of registered ideas.

Two reviewers from Belgium and Saudi Arabia were interested to review the one-paragraph summary description of the idea. Upon payment, each of the reviewers were permitted to view the secure document information containing the summary description. Idea generator received his monetary compensation (70% or 35% of the sales price). A company from Germany bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 2) An idea generator from Mexico filled and signed the declaration form (authenticating his identity, originality and ownership of his new, useful and non-obvious idea), prepared his idea by completing the pre-authorized document format including (title: A paint that changes color by season) and designated Class of his idea according to the Nice Agreement concerning international classification of goods and services (Class2: Paints), wrote detailed summary and descriptions, and suggested selling price of $1000), and sent it confidentially to the independent idea center.

The idea is examined, accepted and registered by assigning an idea number. The idea number, title, price for sale of the entire idea and for review of the summary description of the idea were posted under Class 2 in the list of registered ideas.

A reviewer from United States was interested to review the one-paragraph summary description of the idea. Upon payment, the reviewer was permitted to view the secure document information containing the summary description. Idea generator received his monetary compensation (70% of 35% of the sales price). A company from United States bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 3) An idea generator from France filled and signed the declaration form (authenticating his identity, originality and ownership of his new, useful and non-obvious idea), prepared his idea by completing the pre-authorized document format including (title: Age-defying face cream with glow) and designated Class of his idea according to the Nice Agreement concerning international classification of goods and services (Class 3: Cosmetics and Cleaning Preparations), wrote detailed summary and descriptions, and suggested selling price of $4000), and sent it confidentially to the independent idea center.

The idea is examined, accepted and registered by assigning an idea number. The idea number, title, price for sale of the entire idea and for review of the summary description of the idea were posted under Class 3 in the list of registered ideas.

Five reviewers from United States, France, Germany, United Arab Emirate and Belgium were interested to review the one-paragraph summary description of the idea. Upon payment, each of the reviewers were permitted to view the secure document information containing the summary description. Idea generator received his monetary compensation (70% of 35% of the sales price). A company from Canada bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 4) An idea generator from Venezuela filled and signed the declaration form (authenticating his identity, originality and ownership of his new, useful and non-obvious idea), prepared his idea by completing the pre-authorized document format including (title: Safe fragrant fuel) and designated Class of his idea according to the Nice Agreement concerning international classification of goods and services (Class 4: Lubricants and Fuels), wrote detailed summary and descriptions, and suggested selling price of $4500), and sent it confidentially to the independent idea center.

The idea is examined, accepted and registered by assigning an idea number. The idea number, title, price for sale of the entire idea and for review of the summary description of the idea were posted under Class 4 in the list of registered ideas.

Two reviewers from United States and Canada were interested to review the one-paragraph summary description of the idea. Upon payment, each of the reviewers were permitted to view the secure document information containing the summary description. Idea generator received his monetary compensation (70% of 35% of the sales price). A company from United States bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 5) An idea generator from India filled and signed the declaration form (authenticating his identity, originality and ownership of his new, useful and non-obvious idea), prepared his idea by completing the pre-authorized document format including (title: A new medical food to help patients with high blood pressure) and designated Class of his idea according to the Nice Agreement concerning international classification of goods and services (Class 5 Pharmaceuticals), wrote detailed summary and descriptions, and suggested selling price of $5000) and sent it confidentially to the independent idea center.

The idea is examined, accepted and registered by assigning an idea number. The idea number, title, price for sale of the entire idea and for review of the summary description of the idea were posted under Class 5 in the list of registered ideas.

Two reviewers from England and Canada were interested to review the one-paragraph summary description of the idea. Upon payment, each of the reviewers were permitted to view the secure document information containing the summary description. Idea generator received his monetary compensation (70% of 35% of the sales price). A company from United States bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 6) An idea generator from Thailand filled and signed the declaration form (authenticating his identity, originality and ownership of his new, useful and non-obvious idea), prepared his idea by completing the pre-authorized document format including (title: Environmentally-safe, inexpensive metal containers) and designated Class of his idea according to the Nice Agreement concerning international classification of goods and services (Class 6: Metal Goods), wrote detailed summary and descriptions, and suggested selling price of $800), and sent it confidentially to the independent idea center.

The idea is examined, accepted and registered by assigning an idea number. The idea number, title, price for sale of the entire idea and for review of the summary description of the idea were posted under Class 6 in the list of registered ideas.

Two reviewers from Vietnam and Indonesia were interested to review the one-paragraph summary description of the idea. Upon payment, each of the reviewers were permitted to view the secure document information containing the summary description. Idea generator received his monetary compensation (70% of 35% of the sales price). A company from Indonesia bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 7) An idea generator from Paraguay filled and signed the declaration form (authenticating his identity, originality and ownership of his new, useful and non-obvious idea), prepared his idea by completing the pre-authorized document format including (title: Car engine reserve package) and designated Class of his idea according to the Nice Agreement concerning international classification of goods and services (Class7: Machinery), wrote detailed summary and descriptions, and suggested selling price of $900), and sent it confidentially to the independent idea center.

The idea is examined, accepted and registered by assigning an idea number. The idea number, title, price for sale of the entire idea and for review of the summary description of the idea were posted under Class 7 in the list of registered ideas.

Two reviewers from Paraguay and Uruguay were interested to review the one-paragraph summary description of the idea. Upon payment, each of the reviewers were permitted to view the secure document information containing the summary description. Idea generator received his monetary compensation (70% of 35% of the sales price). A company from Paraguay bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 8) An idea generator from Bangladesh filled and signed the declaration form (authenticating his identity, originality and ownership of his new, useful and non-obvious idea), prepared his idea by completing the pre-authorized document format including (title: Knife that needs “code” to open) and designated Class of his idea according to the Nice Agreement concerning international classification of goods and services (Class8: Hand Tools), wrote detailed summary and descriptions, and suggested selling price of $1000), and sent it confidentially to the independent idea center.

The idea is examined, accepted and registered by assigning an idea number. The idea number, title, price for sale of the entire idea and for review of the summary description of the idea were posted under Class 8 in the list of registered ideas.

Two reviewers from United States and Egypt were interested to review the one-paragraph summary description of the idea. Upon payment, each of the reviewers were permitted to view the secure document information containing the summary description. Idea generator received his monetary compensation (70% of 35% of the sales price). A company from Germany bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 9) An idea generator from Indonesia filled and signed the declaration form (authenticating his identity, originality and ownership of his new, useful and non-obvious idea), prepared his idea by completing the pre-authorized document format including (title: An electronic science teacher for home) and designated Class of his idea according to the Nice Agreement concerning international classification of goods and services (Class 9: Electrical and Scientific Apparatus), wrote detailed summary and descriptions, and suggested selling price of $3000), and sent it confidentially to the independent idea center.

The idea is examined, accepted and registered by assigning an idea number. The idea number, title, price for sale of the entire idea and for review of the summary description of the idea were posted under Class 9 in the list of registered ideas.

Two reviewers from Jordan and Morocco were interested to review the one-paragraph summary description of the idea. Upon payment, each of the reviewers were permitted to view the secure document information containing the summary description. Idea generator received his monetary compensation (70% of 35% of the sales price). A company from Morocco bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 10) An idea generator from England filled and signed the declaration form (authenticating his identity, originality and ownership of his new, useful and non-obvious idea), prepared his idea by completing the pre-authorized document format including (title: Painless needle for repeated injections) and designated Class of his idea according to the Nice Agreement concerning international classification of goods and services (Class 10: Medical Apparatus), wrote detailed summary and descriptions, and suggested selling price of $2500), and sent it confidentially to the independent idea center.

The idea is examined, accepted and registered by assigning an idea number. The idea number, title, price for sale of the entire idea and for review of the summary description of the idea were posted under Class 10 in the list of registered ideas.

Two reviewers from France and Poland were interested to review the one-paragraph summary description of the idea. Upon payment, each of the reviewers were permitted to view the secure document information containing the summary description. Idea generator received his monetary compensation (70% of 35% of the sales price). A company from France bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 11) An idea generator from Portugal filled and signed the declaration form (authenticating his identity, originality and ownership of his new, useful and non-obvious idea), prepared his idea by completing the pre-authorized document format including (title: A musical apparatus that fixes temperature, relative humidity and fragrance in the air) and designated Class of his idea according to the Nice Agreement concerning international classification of goods and services (Class 11: Environmental Control Apparatus), wrote detailed summary and descriptions, and suggested selling price of $4000), and sent it confidentially to the independent idea center.

The idea is examined, accepted and registered by assigning an idea number. The idea number, title, price for sale of the entire idea and for review of the summary description of the idea were posted under Class 11 in the list of registered ideas.

Two reviewers from United States and Kuwait were interested to review the one-paragraph summary description of the idea. Upon payment, each of the reviewers were permitted to view the secure document information containing the summary description. Idea generator received his monetary compensation (70% of 35% of the sales price). A company from Kuwait bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 12) An idea generator from United States filled and signed the declaration form (authenticating his identity, originality and ownership of his new, useful and non-obvious idea), prepared his idea by completing the pre-authorized document format including (title: Stopping a moving car by hanging magnet from helicopter) and designated Class of his idea according to the Nice

Agreement concerning international classification of goods and services (Class12: Vehicles), wrote detailed summary and descriptions, and suggested selling price of $4500), and sent it confidentially to the independent idea center.

The idea is examined, accepted and registered by assigning an idea number. The idea number, title, price for sale of the entire idea and for review of the summary description of the idea were posted under Class 12 in the list of registered ideas.

Two reviewers from Italy and Denmark were interested to review the one-paragraph summary description of the idea. Upon payment, each of the reviewers were permitted to view the secure document information containing the summary description. Idea generator received his monetary compensation (70% of 35% of the sales price). A company from New Zealand bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 13) An idea generator from Pakistan filled and signed the declaration form (authenticating his identity, originality and ownership of his new, useful and non-obvious idea), prepared his idea by completing the pre-authorized document format including (title: This is how your favorite jewel can sing) and designated Class of his idea according to the Nice Agreement concerning international classification of goods and services (Class 14: Jewelry), wrote detailed summary and descriptions, and suggested selling price of $3000), and sent it confidentially to the independent idea center.

The idea is examined, accepted and registered by assigning an idea number. The idea number, title, price for sale of the entire idea and for review of the summary description of the idea were posted under Class 14 in the list of registered ideas.

Two reviewers from China and Thailand were interested to review the one-paragraph summary description of the idea. Upon payment, each of the reviewers were permitted to view the secure document information containing the summary description. Idea generator received his monetary compensation (70% of 35% of the sales price). A company from Thailand bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 14) An idea generator from Austria filled and signed the declaration form (authenticating his identity, originality and ownership of his new, useful and non-obvious idea), prepared his idea by completing the pre-authorized document format including (title: A programmable piano accordion) and designated Class of his idea according to the Nice Agreement concerning international classification of goods and services (Class15: Musical Instruments), wrote detailed summary and descriptions, and suggested selling price of $4000), and sent it confidentially to the independent idea center.

The idea is examined, accepted and registered by assigning an idea number. The idea number, title, price for sale of the entire idea and for review of the summary description of the idea were posted under Class 15 in the list of registered ideas.

Two reviewers from United States and Japan were interested to review the one-paragraph summary description of the idea. Upon payment, each of the reviewers were permitted to view the secure document information containing the summary description. Idea generator received his monetary compensation (70% of 35% of the sales price). A company from Germany bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 15) An idea generator from Iceland filled and signed the declaration form (authenticating his identity, originality and ownership of his new, useful and non-obvious idea), prepared his idea by completing the pre-authorized document format including (title: A paper-holder that corrects your hand-written spelling) and designated Class of his idea according to the Nice Agreement concerning international classification of goods and services (Class16: Paper Goods and Printed Matter), wrote detailed summary and descriptions, and suggested selling price of $3500) and sent it confidentially to the independent idea center.

The idea is examined, accepted and registered by assigning an idea number. The idea number, title, price for sale of the entire idea and for review of the summary description of the idea were posted under Class 16 in the list of registered ideas.

Two reviewers from South Korea and Brazil were interested to review the one-paragraph summary description of the idea. Upon payment, each of the reviewers were permitted to view the secure document information containing the summary description. Idea generator received his monetary compensation (70% of 35% of the sales price). A company from Brazil bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 16) An idea generator from India filled and signed the declaration form (authenticating his identity, originality and ownership of his new, useful and non-obvious idea), prepared his idea by completing the pre-authorized document format including (title: Converting natural rubber to a nutritionally-valuable product) and designated Class of his idea according to the Nice Agreement concerning international classification of goods and services (Class 17: Rubber Goods), wrote detailed summary and descriptions, and suggested selling price of $1500), and sent it confidentially to the independent idea center.

The idea is examined, accepted and registered by assigning an idea number. The idea number, title, price for sale of the entire idea and for review of the summary description of the idea were posted under Class 17 in the list of registered ideas.

Two reviewers from India and Saudi Kuwait were interested to review the one-paragraph summary description of the idea. Upon payment, each of the reviewers were permitted to view the secure document information containing the summary description. Idea generator received his monetary compensation (70% of 35% of the sales price). A company from Kuwait bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 17) An idea generator from Italy filled and signed the declaration form (authenticating his identity, originality and ownership of his new, useful and non-obvious idea), prepared his idea by completing the pre-authorized document format including (title: Non-sticky leather arm chair) and designated Class of his idea according to the Nice Agreement concerning international classification of goods and services (Class 18: Leather Goods), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 18 in the list of registered ideas.

Two reviewers from France and Brazil were interested to review the one-paragraph summary description of the idea. Upon payment, each of the reviewers were permitted to view the secure document information containing the summary description. Idea generator received his monetary compensation (70% of 35% of the sales price). A company from Germany bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 18) An idea generator from Chile filled and signed the declaration form (authenticating his identity, originality and ownership of his new, useful and non-obvious idea), prepared his idea by completing the pre-authorized document format including (title: A super strong non-metallic iron beam) and designated Class of his idea according to the Nice Agreement concerning international classification of goods and services (Class 19: Non-Metallic Building Materials), wrote detailed summary and descriptions, and suggested selling price of $3500), and sent it confidentially to the independent idea center.

The idea is examined, accepted and registered by assigning an idea number. The idea number, title, price for sale of the entire idea and for review of the summary description of the idea were posted under Class 19 in the list of registered ideas.

Two reviewers from Saudi Arabia and South Korea were interested to review the one-paragraph summary description of the idea. Upon payment, each of the reviewers were permitted to view the secure document information containing the summary description. Idea generator received his monetary compensation (70% of 35% of the sales price). A company from South Korea bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 19) An idea generator from Germany filled and signed the declaration form (authenticating his identity, originality and ownership of his new, useful and non-obvious idea), prepared his idea by completing the pre-authorized document format including (title: A desk that plays your favorite music and creates your favorite fragrance) and designated Class of his idea according to the Nice Agreement concerning international classification of goods and services (Class 20: Furniture and Articles Otherwise Classified), wrote detailed summary and descriptions, and suggested selling price of $1000), and sent it confidentially to the independent idea center.

The idea is examined, accepted and registered by assigning an idea number. The idea number, title, price for sale of the entire idea and for review of the summary description of the idea were posted under Class 20 in the list of registered ideas.

Two reviewers from Hungary and Spain were interested to review the one-paragraph summary description of the idea. Upon payment, each of the reviewers were permitted to view the secure document information containing the summary description. Idea generator received his monetary compensation (70% of 35% of the sales price). A company from Spain bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 20) An idea generator from Mexico filled and signed the declaration form (authenticating his identity, originality and ownership of his new, useful and non-obvious idea), prepared his idea by completing the pre-authorized document format including (title: Kitchenware suggesting international foods based on available ingredients) and designated Class of his idea according to the Nice Agreement concerning international classification of goods and services (Class 21: Housewares and Glass), wrote detailed summary and descriptions, and suggested selling price of $700), and sent it confidentially to the independent idea center.

The idea is examined, accepted and registered by assigning an idea number. The idea number, title, price for sale of the entire idea and for review of the summary description of the idea were posted under Class 21 in the list of registered ideas.

Two reviewers from Finland and Sweden were interested to review the one-paragraph summary description of the idea. Upon payment, each of the reviewers were permitted to view the secure document information containing the summary description. Idea generator received his monetary compensation (70% of 35% of the sales price). A company from Sweden bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 21) An idea generator from Greece filled and signed the declaration form (authenticating his identity, originality and ownership of his new, useful and non-obvious idea), prepared his idea by completing the pre-authorized document format including (title: Vacuum sack keeping content cold or warm) and designated Class of his idea according to the Nice Agreement concerning international classification of goods and services (Class 22: Cordage and Fibers), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 22 in the list of registered ideas.

Two reviewers from Morocco and Algeria were interested to review the one-paragraph summary description of the idea. Upon payment, each of the reviewers were permitted to view the secure document information containing the summary description. Idea generator received his monetary compensation (70% of 35% of the sales price). A company from Morocco bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 22) An idea generator from India filled and signed the declaration form (authenticating his identity, originality and ownership of his new, useful and non-obvious idea), prepared his idea by completing the pre-authorized document format including (title: Three-chain silk, wool and cotton yarn) and designated Class of his idea according to the Nice Agreement concerning international classification of goods and services (Class 23: Yarns and Threads), wrote detailed summary and descriptions, and suggested selling price of $700), and sent it confidentially to the independent idea center.

The idea is examined, accepted and registered by assigning an idea number. The idea number, title, price for sale of the entire idea and for review of the summary description of the idea were posted under Class 23 in the list of registered ideas.

Two reviewers from Pakistan and Bangladesh were interested to review the one-paragraph summary description of the idea. Upon payment, each of the reviewers were permitted to view the secure document information containing the summary description. Idea generator received his monetary compensation (70% of 35% of the sales price). A company from Pakistan bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 23) An idea generator from China filled and signed the declaration form (authenticating his identity, originality and ownership of his new, useful and non-obvious idea), prepared his idea by completing the pre-authorized document format including (title: Anti-dust curtains) and designated Class of his idea according to the Nice Agreement concerning international classification of goods and services (Class 24: Fabrics), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 24 in the list of registered ideas.

Two reviewers from South Africa and Ghana were interested to review the one-paragraph summary description of the idea. Upon payment, each of the reviewers were permitted to view the secure document information containing the summary description. Idea generator received his monetary compensation (70% of 35% of the sales price). A company from South Africa bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 24) An idea generator from China filled and signed the declaration form (authenticating his identity, originality and ownership of his new, useful and non-obvious idea), prepared his idea by completing the pre-authorized document format including (title: Handkerchief that you can write on) and designated Class of his idea according to the Nice Agreement concerning international classification of goods and services (Class 25: Clothing), wrote detailed summary and descriptions, and suggested selling price of $1000), and sent it confidentially to the independent idea center.

The idea is examined, accepted and registered by assigning an idea number. The idea number, title, price for sale of the entire idea and for review of the summary description of the idea were posted under Class 25 in the list of registered ideas.

Two reviewers from Canada and Belgium were interested to review the one-paragraph summary description of the idea. Upon payment, each of the reviewers were permitted to view the secure document information containing the summary description. Idea generator received his monetary compensation (70% of 35% of the sales price). A company from Canada bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 25) An idea generator from Italy filled and signed the declaration form (authenticating his identity, originality and ownership of his new, useful and non-obvious idea), prepared his idea by completing the pre-authorized document format including (title: Christmas ornament that sings bird songs) and designated Class of his idea according to the Nice Agreement concerning international classification of goods and services (Class 26: Fancy Goods), wrote detailed summary and descriptions, and suggested selling price of $1000), and sent it confidentially to the independent idea center.

The idea is examined, accepted and registered by assigning an idea number. The idea number, title, price for sale of the entire idea and for review of the summary description of the idea were posted under Class 26 in the list of registered ideas.

Two reviewers from England and Spain were interested to review the one-paragraph summary description of the idea. Upon payment, each of the reviewers were permitted to view the secure document information containing the summary description. Idea generator received his monetary compensation (70% of 35% of the sales price). A company from Spain bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 26) An idea generator from Thailand filled and signed the declaration form (authenticating his identity, originality and ownership of his new, useful and non-obvious idea), prepared his idea by completing the pre-authorized document format including (title: Floor cover-cool in summer and warm in winter) and designated Class of his idea according to the Nice Agreement concerning international classification of goods and services (Class27: Floor Coverings), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 27 in the list of registered ideas.

Two reviewers from Sweden and Argentina were interested to review the one-paragraph summary description of the idea. Upon payment, each of the reviewers were permitted to view the secure document information containing the summary description. Idea generator received his monetary compensation (70% of 35% of the sales price). A company from Sweden bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 27) An idea generator from Mexico filled and signed the declaration form (authenticating his identity, originality and ownership of his new, useful and non-obvious idea), prepared his idea by completing the pre-authorized document format including (title: A smart toy that measures your IQ) and designated Class of his idea according to the Nice Agreement concerning international classification of goods and services (Class28: Toys and Sporting Goods), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 28 in the list of registered ideas.

Three reviewers from Australia, Canada and Kuwait were interested to review the one-paragraph summary description of the idea. Upon payment, each of the reviewers were permitted to view the secure document information containing the summary description. Idea generator received his monetary compensation (70% of 35% of the sales price). A company from Chile bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 28) An idea generator from Austria filled and signed the declaration form (authenticating his identity, originality and ownership of his new, useful and non-obvious idea), prepared his idea by completing the pre-authorized document format including (title: Mixture of animal & vegetable meats for different cultures) and designated Class of his idea according to the Nice Agreement concerning international classification of goods and services (Class 29: Meats and Processed Foods), wrote detailed summary and descriptions, and suggested selling price of $1000) and sent it confidentially to the independent idea center.

The idea is examined, accepted and registered by assigning an idea number. The idea number, title, price for sale of the entire idea and for review of the summary description of the idea were posted under Class 29 in the list of registered ideas.

Two reviewers from United States and Germany were interested to review the one-paragraph summary description of the idea. Upon payment, each of the reviewers were permitted to view the secure document information containing the summary description. Idea generator received his monetary compensation (70% of 35% of the sales price). A company from New Zealand bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 29) An idea generator from China filled and signed the declaration form (authenticating his identity, originality and ownership of his new, useful and non-obvious idea), prepared his idea by completing the pre-authorized document format including (title: Wheat flour with modified gluten) and designated Class of his idea according to the Nice Agreement concerning international classification of goods and services (Class 30: Staple Foods), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 30 in the list of registered ideas.

Two reviewers from United States were interested to review the one-paragraph summary description of the idea. Upon payment, each of the reviewers were permitted to view the secure document information containing the summary description. Idea generator received his monetary compensation (70% of 35% of the sales price). A company from United States bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 30) An idea generator from China filled and signed the declaration form (authenticating his identity, originality and ownership of his new, useful and non-obvious idea), prepared his idea by completing the pre-authorized document format including (title: Low-cholesterol whole egg) and designated Class of his idea according to the Nice Agreement concerning international classification of goods and services (Class 31: Natural Agricultural Products), wrote detailed summary and descriptions, and suggested selling price of $3000), and sent it confidentially to the independent idea center.

The idea is examined, accepted and registered by assigning an idea number. The idea number, title, price for sale of the entire idea and for review of the summary description of the idea were posted under Class 31 in the list of registered ideas.

Two reviewers from Norway and England were interested to review the one-paragraph summary description of the idea. Upon payment, each of the reviewers were permitted to view the secure document information containing the summary description. Idea generator received his monetary compensation (70% of 35% of the sales price). A company from Norway bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 31) An idea generator from Ireland filled and signed the declaration form (authenticating his identity, originality and ownership of his new, useful and non-obvious idea), prepared his idea by completing the pre-authorized document format including (title: A healthy bubbly energy drink-hot or cold) and designated Class of his idea according to the Nice Agreement concerning international classification of goods and services (Class32: Light Beverages), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class32 in the list of registered ideas.

Two reviewers from China and South Korea were interested to review the one-paragraph summary description of the idea. Upon payment, each of the reviewers were permitted to view the secure document information containing the summary description. Idea generator received his monetary compensation (70% of 35% of the sales price). A company from China bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 32) An idea generator from Australia filled and signed the declaration form (authenticating his identity, originality and ownership of his new, useful and non-obvious idea), prepared his idea by completing the pre-authorized document format including (title: How to optimally mix white and red wines for difficult tastes) and designated Class of his idea according to the Nice Agreement concerning international classification of goods and services (Class 33: Wines and Spirits), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 33 in the list of registered ideas.

Two reviewers from France and Italy were interested to review the one-paragraph summary description of the idea. Upon payment, each of the reviewers were permitted to view the secure document information containing the summary description. Idea generator received his monetary compensation (70% of 35% of the sales price). A company from Italy bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 33) An idea generator from Brazil filled and signed the declaration form (authenticating his identity, originality and ownership of his new, useful and non-obvious idea), prepared his idea by completing the pre-authorized document format including (title: How you can make your ad campaign more durable) and designated Class of his idea according to the Nice Agreement concerning international classification of goods and services (Class35: Advertising and Business Services), wrote detailed summary and descriptions, and suggested selling price of $3000), and sent it confidentially to the independent idea center.

The idea is examined, accepted and registered by assigning an idea number. The idea number, title, price for sale of the entire idea and for review of the summary description of the idea were posted under Class35 in the list of registered ideas.

Four reviewers from Brazil, England, Denmark and Canada were interested to review the one-paragraph summary description of the idea. Upon payment, each of the reviewers were permitted to view the secure document information containing the summary description. Idea generator received his monetary compensation (70% of 35% of the sales price). A company from United States bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 34) An idea generator from United States filled and signed the declaration form (authenticating his identity, originality and ownership of his new, useful and non-obvious idea), prepared his idea by completing the pre-authorized document format including (title: A life insurance plan that you can change the face value at any time) and designated Class of his idea according to the Nice Agreement concerning international classification of goods and services (Class36: Insurance and Financial Services), wrote detailed summary and descriptions, and suggested selling price of $5000), and sent it confidentially to the independent idea center.

The idea is examined, accepted and registered by assigning an idea number. The idea number, title, price for sale of the entire idea and for review of the summary description of the idea were posted under Class 36 in the list of registered ideas.

Two reviewers from United States and England were interested to review the one-paragraph summary description of the idea. Upon payment, each of the reviewers were permitted to view the secure document information containing the summary description. Idea generator received his monetary compensation (70% of 35% of the sales price). A company from United States bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 35) An idea generator from Japan filled and signed the declaration form (authenticating his identity, originality and ownership of his new, useful and non-obvious idea), prepared his idea by completing the pre-authorized document format including (title: Remote home repair at a quarter price to customer) and designated Class of his idea according to the Nice Agreement concerning international classification of goods and services (Class 37: Building Construction and Repair), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 37 in the list of registered ideas.

Two reviewers from United Arab Emirate and Egypt were interested to review the one-paragraph summary description of the idea. Upon payment, each of the reviewers were permitted to view the secure document information containing the summary description. Idea generator received his monetary compensation (70% of 35% of the sales price). A company from United Arab Emirate bought the idea by paying the full sale price and was permitted view the secure document information containing the entire idea. At the same time, all the rights, titles and interests of the idea were also transferred to the buyer.

This transaction was considered final with no cancellation, return or refund. The Idea generator received his monetary compensation (70% of the sale price).

Example 36) An idea generator from Poland filled and signed the declaration form (authenticating his identity, originality and ownership of his new, useful and non-obvious idea), prepared his idea by completing the pre-authorized document format including (title: A communication system that automatically rewards the best response) and designated Class of his idea according to the Nice Agreement concerning international classification of goods and services (Class38: Communication Services), wrote detailed summary and descriptions, and suggested selling price of $1000), and sent it confidentially to the independent idea center.

The idea is examined, accepted and registered by assigning an idea number. The idea number, title, price for sale of the entire idea and for review of the summary description of the idea were posted under Class 38 in the list of registered ideas.

Two reviewers from Greece and Iraq were interested to review the one-paragraph summary description of the idea. Upon payment, each of the reviewers were permitted to view the secure document information containing the summary description. Idea generator received his monetary compensation (70% of 35% of the sales price). A company from Greece bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 37) An idea generator from Iceland filled and signed the declaration form (authenticating his identity, originality and ownership of his new, useful and non-obvious idea), prepared his idea by completing the pre-authorized document format including (title: Two-layer vacuum wall for energy saving during storage) and designated Class of his idea according to the Nice Agreement concerning international classification of goods and services (Class 39: Two-layer vacuum wall for energy saving during storage), wrote detailed summary and descriptions, and suggested selling price of $3000), and sent it confidentially to the independent idea center.

The idea is examined, accepted and registered by assigning an idea number. The idea number, title, price for sale of the entire idea and for review of the summary description of the idea were posted under Class 39 in the list of registered ideas.

Two reviewers from Finland and Japan were interested to review the one-paragraph summary description of the idea. Upon payment, each of the reviewers were permitted to view the secure document information containing the summary description. Idea generator received his monetary compensation (70% of 35% of the sales price). A company from Finland bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 38) An idea generator from Belgium filled and signed the declaration form (authenticating his identity, originality and ownership of his new, useful and non-obvious idea), prepared his idea by completing the pre-authorized document format including (title: Mobile air purifier in polluted cities) and designated Class of his idea according to the Nice Agreement concerning international classification of goods and services (Class 40: Material Treatment), wrote detailed summary and descriptions, and suggested selling price of $5000), and sent it confidentially to the independent idea center.

The idea is examined, accepted and registered by assigning an idea number. The idea number, title, price for sale of the entire idea and for review of the summary description of the idea were posted under Class 40 in the list of registered ideas.

Two reviewers from India and Pakistan were interested to review the one-paragraph summary description of the idea. Upon payment, each of the reviewers were permitted to view the secure document information containing the summary description. Idea generator received his monetary compensation (70% of 35% of the sales price). A company from India bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 39) An idea generator from Japan filled and signed the declaration form (authenticating his identity, originality and ownership of his new, useful and non-obvious idea), prepared his idea by completing the pre-authorized document format including (title: The best entertaining education for lazy people) and designated Class of his idea according to the Nice Agreement concerning international classification of goods and services (Class 41: Education and Entertainment Services), wrote detailed summary and descriptions, and suggested selling price of $2000), and sent it confidentially to the independent idea center.

The idea is examined, accepted and registered by assigning an idea number. The idea number, title, price for sale of the entire idea and for review of the summary description of the idea were posted under Class 41 in the list of registered ideas.

Two reviewers from United States and Egypt were interested to review the one-paragraph summary description of the idea. Upon payment, each of the reviewers were permitted to view the secure document information containing the summary description. Idea generator received his monetary compensation (70% of 35% of the sales price). A company from United States bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 40) An idea generator from Netherland filled and signed the declaration form (authenticating his identity, originality and ownership of his new, useful and non-obvious idea), prepared his idea by completing the pre-authorized document format including (title: A software that senses your mental status and recommends needed action) and designated Class of his idea according to the Nice Agreement concerning international classification of goods and services (Class 42: Computer and Scientific Services), wrote detailed summary and descriptions, and suggested selling price of $5000), and sent it confidentially to the independent idea center.

The idea is examined, accepted and registered by assigning an idea number. The idea number, title, price for sale of the entire idea and for review of the summary description of the idea were posted under Class 42 in the list of registered ideas.

Two reviewers from United States and Canada were interested to review the one-paragraph summary description of the idea. Upon payment, each of the reviewers was permitted to view the secure document information containing the summary description. Idea generator received his monetary compensation (70% of 35% of the sales price). A company from United States bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 41) An idea generator from United States filled and signed the declaration form (authenticating his identity, originality and ownership of his new, useful and non-obvious idea), prepared his idea by completing the pre-authorized document format including (title: The best message on napkin wins the meal!) and designated Class of his idea according to the Nice Agreement concerning international classification of goods and services (Class 43: Hotels and Restaurants Services), wrote detailed summary and descriptions, and suggested selling price of $1000), and sent it confidentially to the independent idea center.

The idea is examined, accepted and registered by assigning an idea number. The idea number, title, price for sale of the entire idea and for review of the summary description of the idea were posted under Class 43 in the list of registered ideas.

Two reviewers from Mexico and Canada were interested to review the one-paragraph summary description of the idea. Upon payment, each of the reviewers were permitted to view the secure document information containing the summary description. Idea generator received his monetary compensation (70% of 35% of the sales price). A company from Mexico bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 42) An idea generator from Canada filled and signed the declaration form (authenticating his identity, originality and ownership of his new, useful and non-obvious idea), prepared his idea by completing the pre-authorized document format including (title: How to design value-added medical services in a community) and designated Class of his idea according to the Nice Agreement concerning international classification of goods and services (Class 44: Medical, Beauty and Agricultural Services), wrote detailed summary and descriptions, and suggested selling price of $4000), and sent it confidentially to the independent idea center.

The idea is examined, accepted and registered by assigning an idea number. The idea number, title, price for sale of the entire idea and for review of the summary description of the idea were posted under Class 4 in the list of registered ideas.

Two reviewers from Switzerland and Japan were interested to review the one-paragraph summary description of the idea. Upon payment, each of the reviewers were permitted to view the secure document information containing the summary description. Idea generator received his monetary compensation (70% of 35% of the sales price). A company from Japan bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

Example 43) An idea generator from England filled and signed the declaration form (authenticating his identity, originality and ownership of his new, useful and non-obvious idea), prepared his idea by completing the pre-authorized document format including (title: Remote babysitting) and designated Class of his idea according to the Nice Agreement concerning international classification of goods and services (Class45: Personal and Legal Services), wrote detailed summary and descriptions, and suggested selling price of $1500), and sent it confidentially to the independent idea center.

The idea is examined, accepted and registered by assigning an idea number. The idea number, title, price for sale of the entire idea and for review of the summary description of the idea were posted under Class 45 in the list of registered ideas.

Two reviewers from Canada and United States were interested to review the one-paragraph summary description of the idea. Upon payment, each of the reviewers were permitted to view the secure document information containing the summary description. Idea generator received his monetary compensation (70% of 35% of the sales price). A company from Finland bought the idea by paying the full sale price and was permitted view the secure document information containing the entire idea. At the same time, all the rights, titles and interests of the idea were also transferred to the buyer. This transaction was considered final with no cancellation, return or refund. The Idea generator received his monetary compensation (70% of the sale price).

The above examples confirm the usefulness (i.e., meeting the aforementioned unmet needs in a simple, efficient-without patenting or licensing, versatile, speedy and low-cost) of the current invention: Novel Easy Method for trading ideas.

Further, the present disclosure describes an AI-powered Ideas Trading Platform.

In some embodiments, the present disclosure describes empowering Ideas Trading platform with AI technologies. Further, the empowering has the following strategic, operational, and market-driven advantages:
1. Enhanced Idea Evaluation
   AI-native patentability: AI can assess novelty, non-obviousness, and utility-giving each idea a credible, third-party patentability score.
   Faster screening: AI can quickly evaluate hundreds of ideas, reducing the manual burden on reviewers and ensuring only promising ideas are elevated.
   Bias reduction: AI provides more objective assessments, minimizing subjective bias in idea evaluation.
   Use free or paid patent search platforms to provide patent search reports.
2. Improved Buyer Confidence
   Trustworthy reports: AI-generated patent search reports offer credible documentation that buyers can rely on before engaging.
   Standardized assessment: All ideas come with uniform evaluation metrics (e.g., novelty score, prior art references), creating a level playing field.
3. Streamlined Operations
   Automated workflows: AI can automate idea classification, matching, filtering, and even initial due diligence steps.
   Scalability: As idea submissions increase, AI ensures the platform remains efficient without proportional staff increases.
4. Competitive Differentiation
   Market first: Positioning ITC as the first “AI-native” idea marketplace strengthens its brand identity.
   Technology leadership: AI integration signals innovation, making ITC attractive to investors, partners, and high-value idea contributors.
5. Advanced Matching and Personalization
   Buyer-idea matching: AI can recommend ideas to buyers based on their past interests, sector focus, or patent portfolio.
   Predictive analytics: Helps forecast commercial potential of submitted ideas.
6. Data-Driven Insights
   Trend analysis: AI can mine idea submissions to identify innovation trends across industries (goods and services) or geographies.
   Platform intelligence: Continuous learning improves idea scoring models, enhancing future evaluations.
7. Reduced Legal and Financial Risk
   Prior art detection: AI helps flag potential infringement risks early.
   Due diligence support: Buyers and reviewers receive deeper, more reliable technical and legal insights.

In countries where a formal provisional patent system is established, including the United States, India, Australia, New Zealand, and South Africa, a notable trend has been observed in the filing of Provisional Patent Applications (PPAs) with respective governmental patent offices. The number of Provisional Patent Applications (PPAs) filed with the respective governmental patent offices in 2023 is as follows:
United States: 149,310
India (total patent filings): 80,211 (only a portion of these are provisional)
Australia: 4,335
New Zealand: 410
South Africa: 1,150

The conversion rate of PPAs into Non-Provisional Patent Applications (NPPAs) varies across countries and years. However, reliable data from the United States Patent and Trademark Office (USPTO) suggests that approximately 50% to 60% of filed PPAs are followed by a corresponding non-provisional patent application within the stipulated 12-month deadline. This conversion rate is influenced by factors such as industry, applicant type (individual vs. corporate), and patent attorney involvement.

The remaining 40% to 50% of PPAs are typically abandoned due to various reasons, including but not limited to: a decision not to pursue the idea further; inability to secure funding; or reassessment of patentability and commercial viability.

According to the provisions of the present platform, the practice of filing Provisional Patent Applications (PPAs) by patent attorneys or agents in designated jurisdictions, including the United States, India, Australia, New Zealand, and South Africa, shall be considered analogous to submitting a “Completed Idea Registration Form” through the Ideas Trading Platform. This equivalence permits the submitted PPAs to undergo evaluation and potential procurement on the platform, thus enabling the trading of innovative ideas and inventions.

In some embodiments, the present disclosure introduces an AI-native algorithm designed to evaluate ideas based on factors such as novelty, non-obviousness, and utility. This system addresses the technical problem of subjective evaluation in idea assessment by providing objective, third-party scores. In some embodiments, the algorithm may leverage neural networks trained on patent data to identify patterns indicative of inventive steps. The specific technology being improved is the process of patent eligibility determination. Example implementations include using TensorFlow-based models for pattern recognition or PyTorch for sequence modeling in assessing non-obviousness.

In some embodiments, the present disclosure describes automated idea classification and filtering. Further, this feature organizes ideas based on predefined criteria, such as novelty thresholds or industry-specific standards. The technical problem here is the manual intervention required in traditional idea processing systems. In some embodiments, automated classification may involve keyword-based filtering or similarity checks against prior art databases. The specific technology being improved is the efficiency of idea evaluation processes. Example implementations include rule-based systems for novelty assessment or fuzzy logic for similarity matching.

In some embodiments, the present disclosure addresses the technical problem of inherent bias in manual evaluations, the invention employs algorithms that minimize subjective influences by relying on objective metrics. In some embodiments, bias reduction may involve training models to avoid over-reliance on demographic factors during scoring. The specific technology being improved is the fairness and transparency of idea evaluation systems. Example implementations include crowdsourcing validation or reinforcement learning for unbiased scoring.

In some embodiments, the present disclosure describes predictive analytics for commercial potential feature that forecasts an idea's commercial success using historical data from past submissions. The technical problem is the lack of actionable insights for decision-making. In some embodiments, predictive analytics may integrate sentiment analysis on market trends or regression models based on past successes. The specific technology being improved is the ability to assess market viability. Example implementations include using machine learning models trained on commercial success indicators.

In some embodiments, the present disclosure describes buyer-idea matching and recommendation that tailors suggestions based on buyer preferences, improving strategic alignment between ideas and business goals. The technical problem is the lack of personalized recommendations in idea matching systems. In some embodiments, matching may involve collaborative filtering algorithms or preference-based search mechanisms. The specific technology being improved is the efficiency of resource allocation in innovation management. Example implementations include matching algorithms that consider strategic focus areas or industry-specific criteria.

In some embodiments, the present disclosure describes data-driven innovation trend analysis feature that analyzes submission patterns, identifying emerging trends and opportunities. The technical problem is the reliance on outdated or anecdotal trend insights. In some embodiments, trend analysis may involve clustering algorithms for identifying emerging technologies or sentiment analysis on industry discussions. The specific technology being improved is trend forecasting in innovation management. Example implementations include using GPT models for horizon scanning or topic modeling for trend identification.

In some embodiments, the present disclosure describes improvement of system performance over time by incorporating feedback from users. The technical problem is the static nature of many AI systems without continuous improvement. In some embodiments, learning may involve active learning frameworks or reinforcement learning based on user feedback. The specific technology being improved is the adaptability and scalability of AI models. Example implementations include iterative training using user corrections or dynamic model updates based on performance metrics.

In some embodiments, the present disclosure describes flagging potential infringements and supporting legal assessments, reducing financial and legal risks. The technical problem is the complexity and cost of traditional prior art searches. In some embodiments, detection may involve AI-driven keyword search or semantic analysis tools for efficient due diligence. The specific technology being improved is intellectual property risk management. Example implementations include systems integrating patent databases or AI-driven similarity checks.

In some embodiments, the present disclosure describes a scalability feature that enables the platform to handle increased submissions without proportional staff expansion, improving operational efficiency. The technical problem is the linear scalability of traditional evaluation systems. In some embodiments, scalability may involve distributed computing frameworks or modular system architectures. The specific technology being improved is the performance and scalability of innovation management platforms. Example implementations include load-balancing algorithms for distributed processing or cloud-based infrastructure for scalable operations.

In some embodiments, the platform described in the present disclosure integrates with external databases to enhance prior art detection accuracy. The technical problem is limited access to comprehensive prior art information. In some embodiments, integration may involve API connections to global patent databases or semantic search across unstructured data. This improvement enhances the reliability of prior art identification.

In some embodiments, the platform described in the present disclosure enables teams to track changes and collaborate on idea development. The technical problem is ineffective collaboration and version control in innovation management. In some embodiments, collaboration tools may include real-time editing or change tracking systems integrated with project management software. This improvement supports team productivity and idea evolution.

In some embodiments, the platform described in the present disclosure allows users to define specific criteria for scoring, tailoring evaluations to their needs. The technical problem is one-size-fits-all evaluation standards. In some embodiments, customization may involve user-defined weightings or adaptive scoring algorithms based on individual preferences. This improvement enhances flexibility and relevance of idea assessments.

In some embodiments, the platform described in the present disclosure provides instant feedback on idea viability through automated checks. The technical problem is delayed validation in idea submissions. In some embodiments, real-time validation may include automated grammar checks, patentability filters, or similarity checks against existing technologies. This improvement accelerates the idea evaluation process.

In some embodiments, the platform described in the present disclosure analyzes potential societal and economic impacts of an idea. The technical problem is overlooking broader implications in idea development. In some embodiments, impact analysis may involve scenario planning tools or stakeholder mapping to assess long-term effects. This improvement supports strategic decision-making for innovation prioritization.

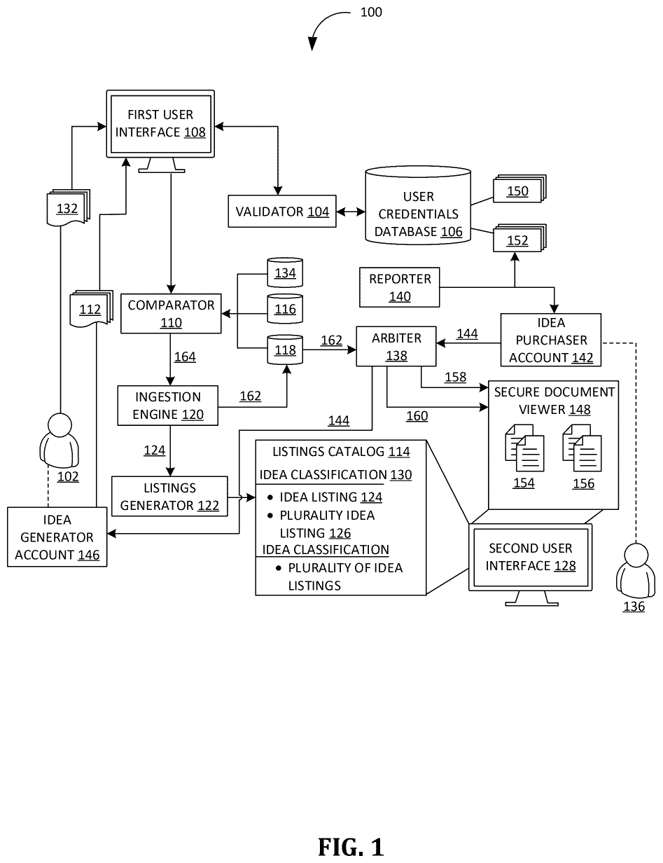

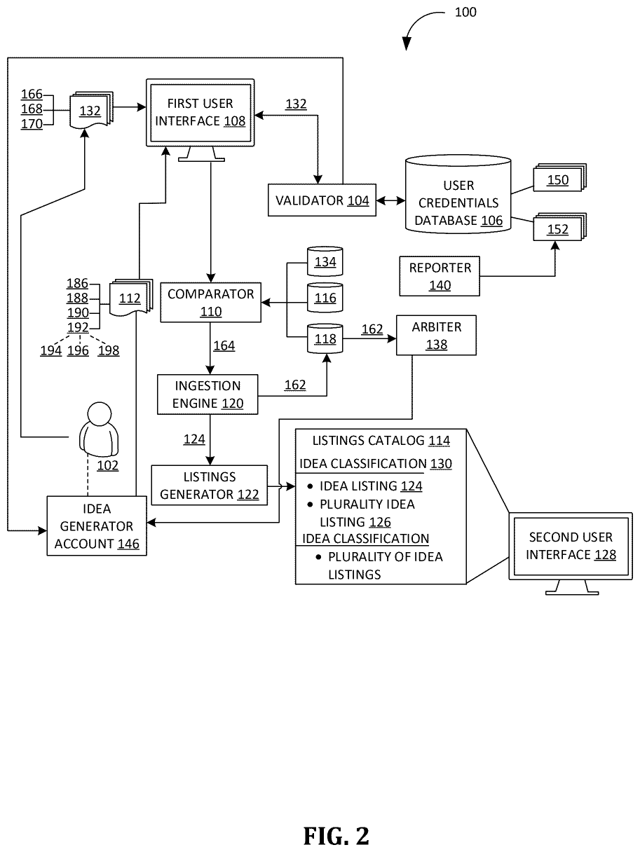

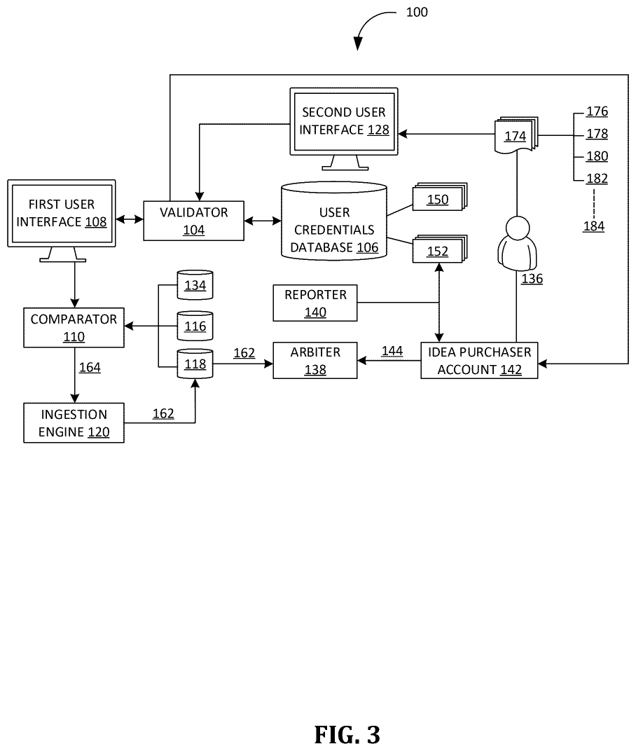

FIG. 1-FIG. 3 illustrate an embodiment of an idea trading platform 100. The idea trading platform 100 comprises a first user interface 108, a comparator 110, a validator 104, a user credentials database 106, ingestion engine 120, a listings generator 122, an arbiter 138, an idea trading platform database 118, a reporter 140, and a second user interface 128. The user credentials database 106 comprises plurality of idea generator account 150 and plurality of idea purchaser accounts 152. The comparator 110 communicates with patent publication databases 134, non-patent databases 116, and the idea trading platform database 118. The validator 104 communicates with the first user interface 108 and the user credentials database 106. The ingestion engine 120 communicates with the comparator 110, the listings generator 122, and the idea trading platform database 118. The arbiter 138 communicates with the idea trading platform database 118 and a secure document viewer 148 of the second user interface 128. The reporter 140 communicates with the plurality of idea purchaser accounts 152.

In an embodiment, the idea trading platform 100 receives first user credentials 132 comprising a first user identity 166, a first user nationality 168, and a first user account type 170 from a first user 102 through the first user interface 108. The first user account type 170 for the first user 102 is an idea generator 172. The idea trading platform 100 validates the first user credentials 132 of the first user 102 received through the first user interface 108 to create an idea generator account 146.

Once the idea generator account 146 has been created, the idea trading platform 100 receives an idea package 112 comprising a disclosure 164, idea classification 130, a declaration of ownership 190, and at least one list price 186 from the idea generator account 146, wherein the disclosure 164 comprises an idea title 194, an idea summary 154, and an idea specification 156. The idea trading platform 100 evaluates the disclosure 164 for novelty, obviousness, and usefulness through operation of a comparator 110, wherein the comparator 110 compares the idea classification 130 and the disclosure 164 to other intellectual property on patent publication databases 134, non-patent databases 116, and idea trading platform databases 118. The idea trading platform 100 operates an ingestion engine 120 to extract the idea title 194, the idea summary 154, and the idea specification 156 from the disclosure 164 and encoding the idea summary 154 and the idea specification 156 into an encoded package 162 comprising an encoded idea summary 158 and an encoded idea specification 160 for storage in the idea trading platform database 118. The idea trading platform 100 generates an idea listing 124, comprising the at least one list price 186 and the idea title 194, for display through a listings catalog 114 on a second user interface 128 comprising a plurality of idea listings 126 organized by the idea classifications 130 of the plurality of idea listings 126 through operation of the listings generator 122. The idea trading platform 100 notifies a plurality of idea purchaser accounts 152 of the idea listing 124 through operation of a reporter 140. The idea trading platform 100 receives funds 144 from an idea purchaser account 142 for the at least one list price 186 and retrieves the encoded package 162 through operation of an arbiter 138. The idea trading platform 100 decodes the encoded package 162 and displays a secure document viewer 148 through the second user interface 128. The idea trading platform 100 transfers the funds 144 to the idea generator account 146 through operation of the arbiter 138 and removes the idea listing 124 from the listings catalog 114.

In an embodiment, the idea trading platform 100 receives the first user credentials 132, comprising a first user identity 166, a first user nationality 168, and a first user account type 170, wherein the first user account type 170 is selected as an idea generator 172. The idea trading platform 100 operates a validator 104 to check the first user credentials 132 against a plurality of stored accounts in a user credentials database 106, wherein the plurality of stored accounts comprises a plurality of idea generator account 150 and the plurality of idea purchaser accounts 152. The idea trading platform 100 generates the idea generator account 146 for the first user 102 based on absence of matching both the first user identity 166 and the first user nationality 168, in the plurality of idea generator account 150 and the plurality of idea purchaser accounts 152.

In an embodiment, the idea trading platform 100 receives second user credentials 174 from the second user 136 comprising a second user identity 176, a second user nationality 178, second user organization 180, and a second user account type 182, wherein the second user account type 182 is selected as an idea purchaser 184. The idea trading platform 100 operates a validator 104 to check the second user credentials 174 against a plurality of stored accounts in a user credentials database 106, wherein the plurality of stored accounts comprises a plurality of idea generator account 150 and the plurality of idea purchaser accounts 152. The idea trading platform 100 generates the idea purchaser account 142 for the second user 136 based on absence of matching the second user identity 176 and the second user nationality 178, and absence of restrictions for the second user organization 180 in the plurality of idea generator account 150 and the plurality of idea purchaser accounts 152.

In an embodiment, the at least one list price 186 comprises an idea summary list price and an idea specification list price. The idea trading platform 100 receives the funds 144 from the idea purchaser account 142 for the idea summary list price and retrieves the encoded package 162 through operation of the arbiter 138. The idea trading platform 100 decodes the encoded package 162 and extracts the encoded idea summary 158. The idea trading platform 100 communicates the encoded idea summary 158 to the secure document viewer 148 on the second user interface 128. The idea trading platform 100 operates the secure document viewer 148 to decode and display the idea summary 154 on the second user interface 128.

In an embodiment, the idea trading platform 100 receives the funds 144 from the idea purchaser account 142 for the idea specification list price and retrieves the encoded package 162 through operation of the arbiter 138. The idea trading platform 100 decodes the encoded package 162 and extracts the encoded idea summary 158 and the encoded idea specification 160. The idea trading platform 100 communicates the encoded idea summary 158 and the encoded idea specification 160 to the secure document viewer 148 on the second user interface 128. The method operates the secure document viewer 148 to decode and display the idea summary 154 and the idea specification 156 on the second user interface 128.

In an embodiment, the idea listing 124 is automatically removed after a predetermined time.

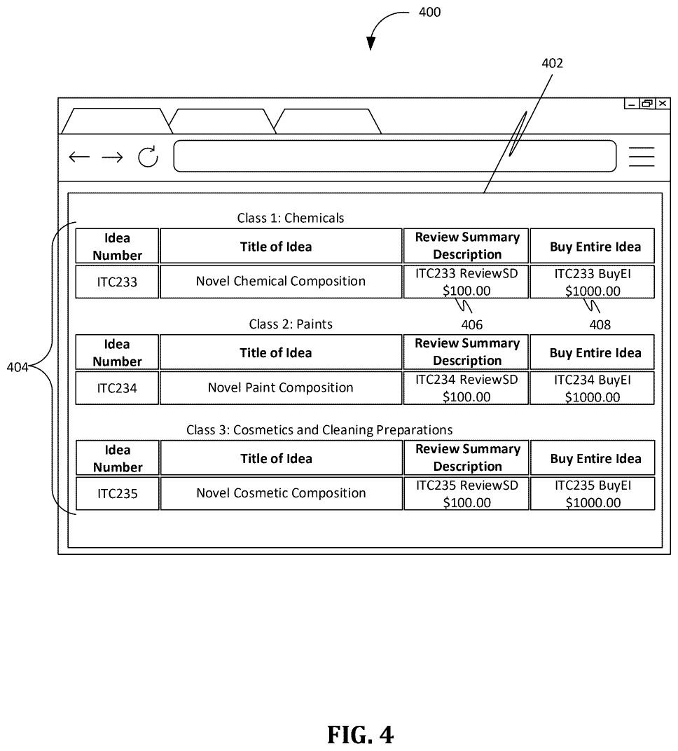

FIG. 4 illustrates a user interface 400 in accordance with one embodiment. The user interface 400 shows a listings catalog 402 displaying a plurality of idea listings 404 each comprising an idea summary list price 406 and an idea specification list price 408.

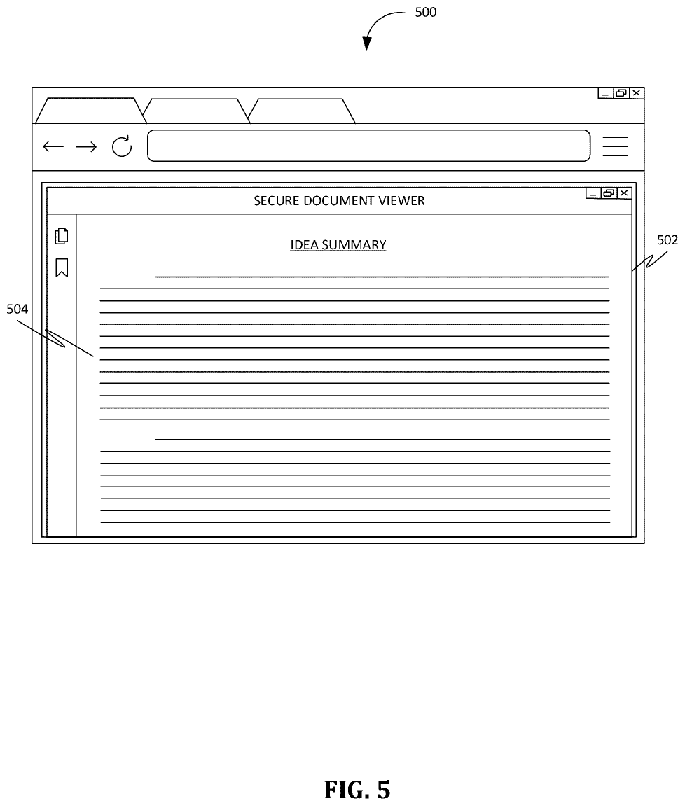

FIG. 5 illustrates a user interface 500 in accordance with one embodiment, the user interface 500 shows a secure document viewer 502 displayed within a browser window of the user interface 500. The secure document viewer 502 displays the decoded idea summary 504.

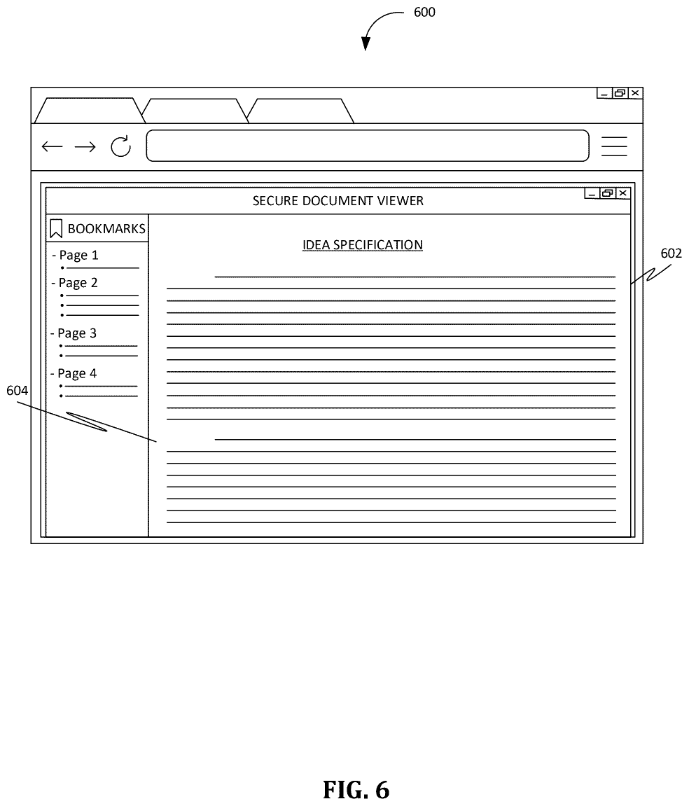

FIG. 6 illustrates a user interface 600 in accordance with one embodiment. The user interface 600 shows a secure document viewer 602 displayed in a browser window of the user interface 600. The secure document viewer 602 displays the decoded idea specification 604.

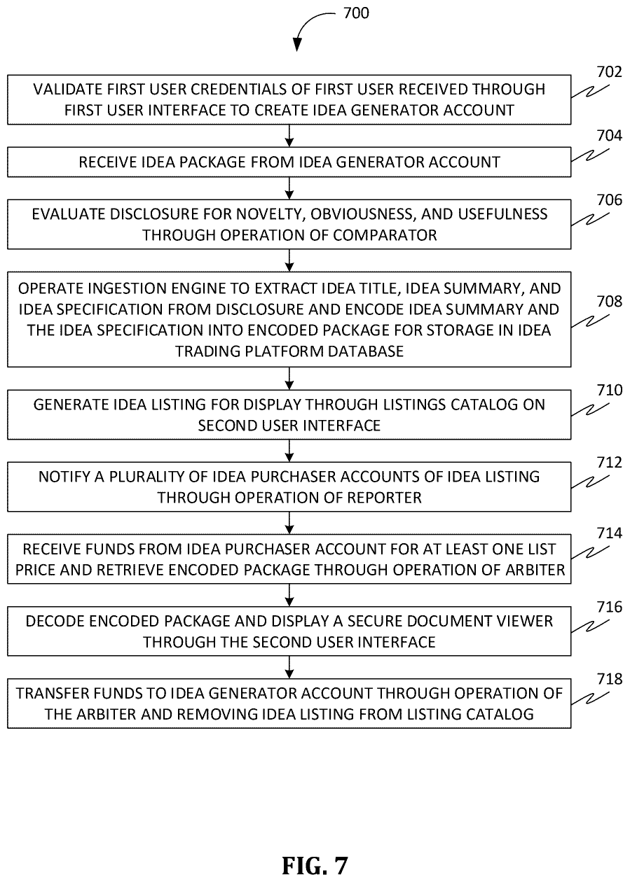

FIG. 7 illustrates a routine 700 for operating the idea trading platform in accordance with one embodiment. In block 702, the routine 700 validates first user credentials of a first user received through a first user interface to create an idea generator account. In block 704, routine 700 receives an idea package comprising a disclosure, idea classification, a declaration of ownership, and at least one list price from the idea generator account. The disclosure comprises an idea title, an idea summary, and an idea specification. In block 706, the routine 700 evaluates the disclosure for novelty, obviousness, and usefulness through operation of a comparator. The comparator compares the idea classification and the disclosure to other intellectual property on patent publication databases, non-patent databases, and idea trading platform databases. In block 708, the routine 700 operates an ingestion engine to extract the idea title, the idea summary, and the idea specification from the disclosure and encodes the idea summary and the idea specification into an encoded package comprising an encoded idea summary and an encoded idea specification for storage in the idea trading platform database. In block 710, the routine 700 generates an idea listing, comprising the at least one list price and the idea title, for display through a listings catalog on a second user interface comprising a plurality of idea listings organized by the idea classifications of the plurality of idea listings through operation of the listings generator. In block 712, the routine 700 notifies a plurality of idea purchaser accounts of the idea listing through operation of a reporter. In block 714, the routine 700 receives funds from an idea purchaser account for the at least one list price and retrieves the encoded package through operation of an arbiter. In block 716, the routine 700 decodes the encoded package and displays a secure document viewer through the second user interface. In block 718, the routine 700 transfers the funds to the idea generator account through operation of the arbiter and removes the idea listing from the listings catalog.

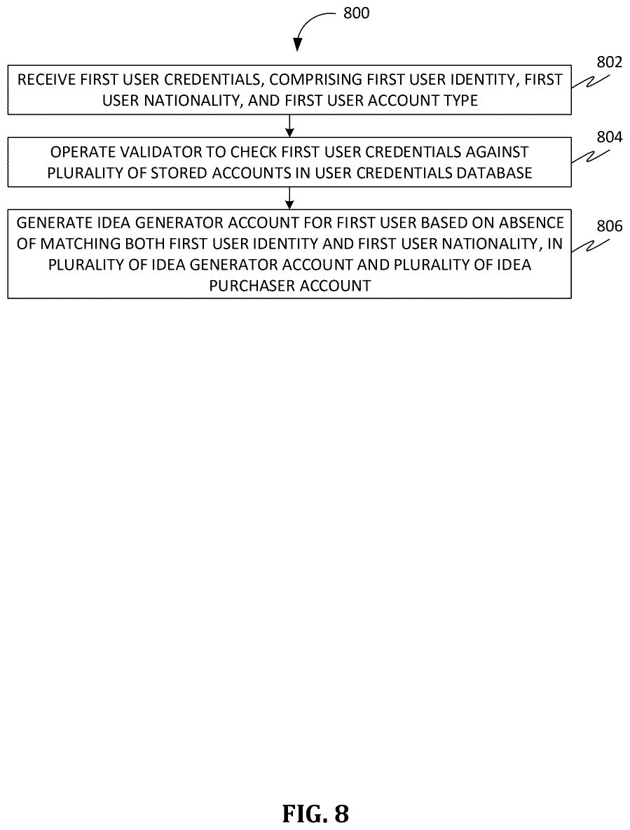

FIG. 8 illustrates a routine 800 for operating the idea trading platform in accordance with one embodiment. In block 802, the routine 800 receives the first user credentials, comprising a first user identity, a first user nationality, and a first user account type, wherein the first user account type is selected as an idea generator. In block 804, the routine 800 operates a validator to check the first user credentials against a plurality of stored accounts in a user credentials database, wherein the plurality of stored accounts comprises a plurality of idea generator account and the plurality of idea purchaser accounts. In block 806, the routine 800 generates the idea generator account for the first user based on absence of matching both the first user identity and the first user nationality, in the plurality of idea generator account and the plurality of idea purchaser accounts.

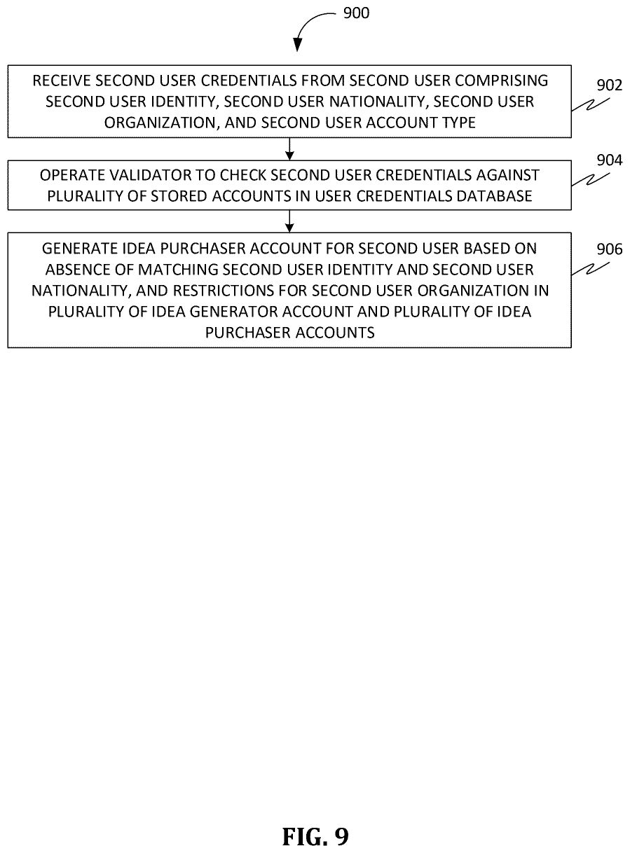

FIG. 9 illustrates a routine 900 for operating the idea trading platform in accordance with one embodiment. In block 902, the routine 900 receives second user credentials from the second user comprising a second user identity, a second user nationality, second user organization, and a second user account type, wherein the second user account type is selected as an idea purchaser. In block 904, the routine 900 operates a validator to check the second user credentials against a plurality of stored accounts in a user credentials database, wherein the plurality of stored accounts comprises a plurality of idea generator account and the plurality of idea purchaser accounts. In block 906, the routine 900 generates the idea purchaser account for the second user based on absence of matching the second user identity and the second user nationality, and absence of restrictions for the second user organization in the plurality of idea generator account and the plurality of idea purchaser accounts.

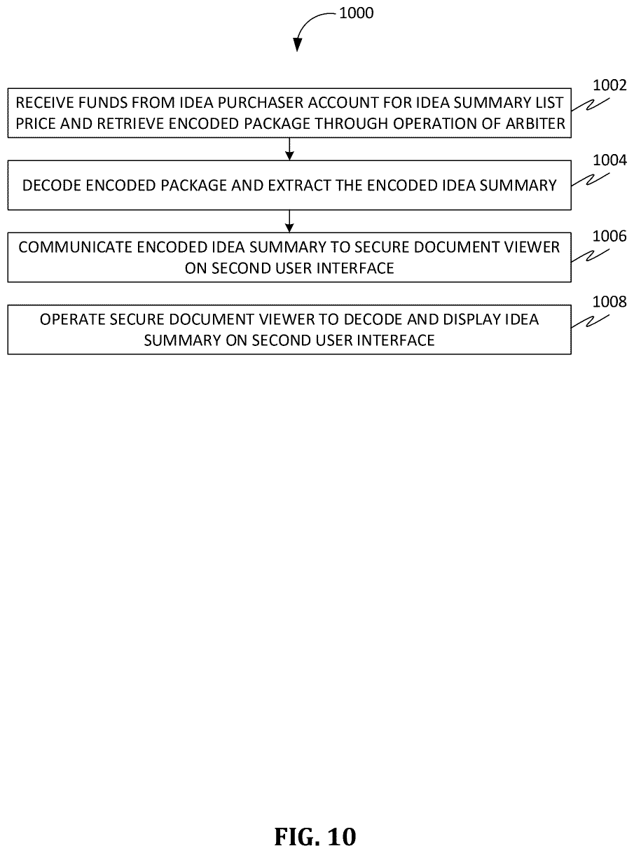

FIG. 10 illustrates a routine 1000 for operating the idea trading platform in accordance with one embodiment. In block 1002, the routine 1000 receives the funds from the idea purchaser account for the idea summary list price and retrieves the encoded package through operation of the arbiter. In block 1004, the routine 1000 decodes the encoded package and extracts the encoded idea summary. In block 1006, the routine 1000 communicates the encoded idea summary to the secure document viewer on the second user interface. In block 1008, the routine 1000 operates the secure document viewer to decode and display the idea summary on the second user interface.

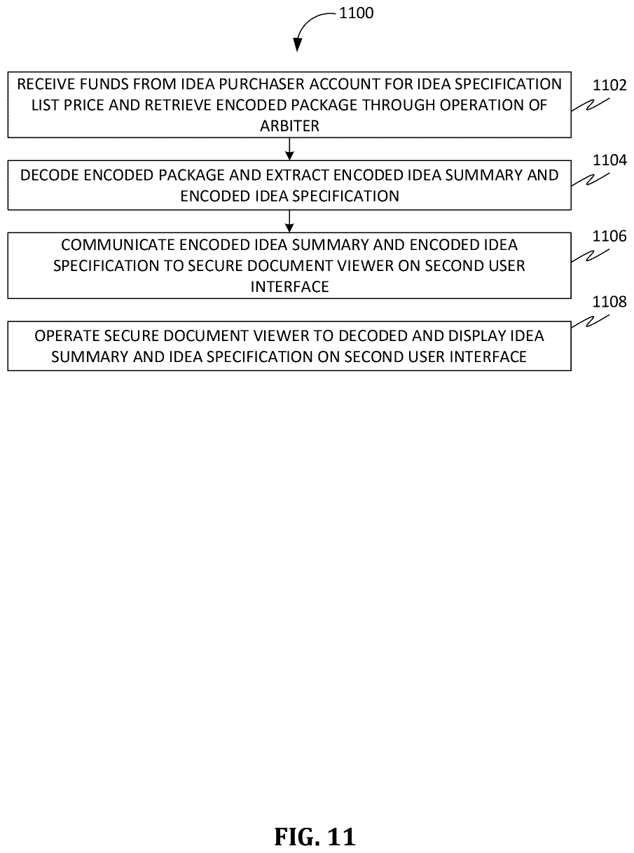

FIG. 11 illustrates a routine 1100 for operating the idea trading platform in accordance with one embodiment. In block 1102, the routine 1100 receives the funds from the idea purchaser account for the idea specification list price and retrieves the encoded package through operation of the arbiter. In block 1104, the routine 1100 decodes the encoded package and extract the encoded idea summary and the encoded idea specification. In block 1106, the routine 1100 communicates the encoded idea summary and the encoded idea specification to the secure document viewer on the second user interface. In block 1108, the routine 1100 operates the secure document viewer to decode and display the idea summary and the idea specification on the second user interface.

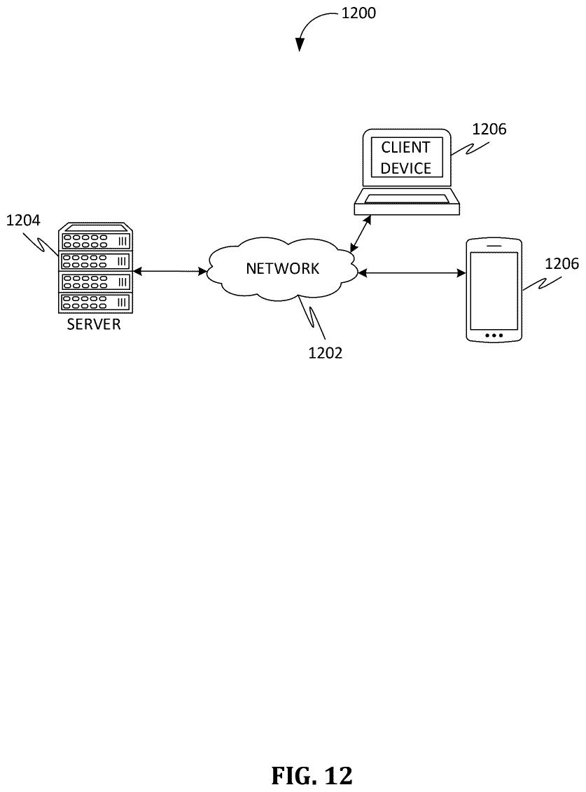

FIG. 12 illustrates a system 1200 in which a server 1204 and a client device 1206 are connected to a network 1202.

In various embodiments, the network 1202 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 1202 may also include a voice network that conveys not only voice communications, but also non-voice data such as Short Message Service (“SMS”) messages, as well as data communicated via various cellular data communication protocols, and the like.

In various embodiments, the client device 1206 may include desktop PCs, mobile phones, laptops, tablets, wearable computers, or other computing devices that are capable of connecting to the network 1202 and communicating with the server 1204, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 1204 and the client device 1206 may be implemented via various combinations of physical and/or logical devices. However, it is not necessary to show such infrastructure and implementation details in FIG. 12 in order to describe an illustrative embodiment.

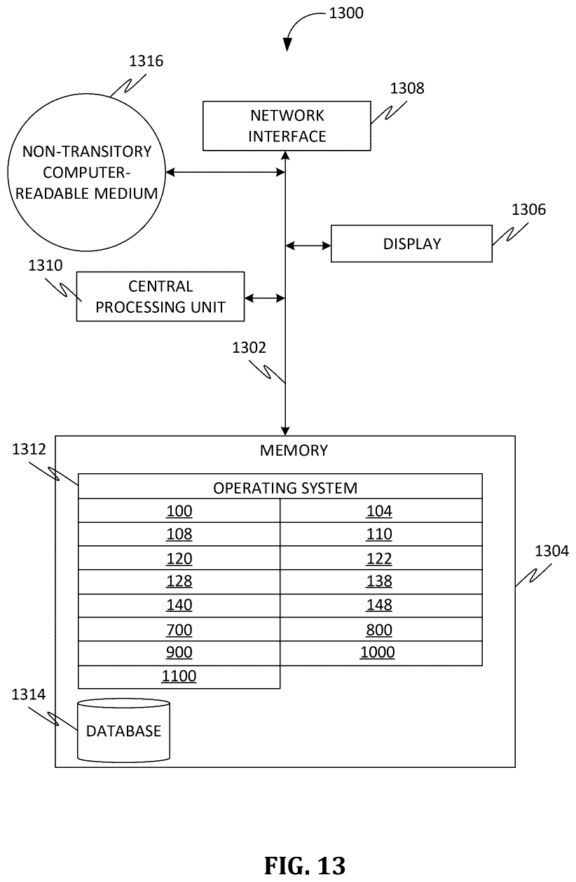

FIG. 13 illustrates several components of an exemplary system 1300 in accordance with one embodiment. In various embodiments, system 1300 may include a desktop PC, server, workstation, mobile phone, laptop, tablet, set-top box, appliance, or other computing device that is capable of performing operations such as those described herein. In some embodiments, system 1300 may include many more components than those shown in FIG. 13. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 1300 may comprise one or more physical and/or logical devices that collectively provide the functionalities described herein. In some embodiments, system 1300 may comprise one or more replicated and/or distributed physical or logical devices.

In some embodiments, system 1300 may comprise one or more computing resources provisioned from a “cloud computing” provider, for example, Amazon Elastic Compute Cloud (“Amazon EC2”), provided by Amazon.com, Inc. of Seattle, Washington; Sun Cloud Compute Utility, provided by Sun Microsystems, Inc. of Santa Clara, California; Windows Azure, provided by Microsoft Corporation of Redmond, Washington, and the like.

System 1300 includes a bus 1302 interconnecting several components including a network interface 1308, a display 1306, a central processing unit 1310, and a memory 1304.

Memory 1304 generally comprises a random access memory (“RAM”) and permanent non-transitory mass storage device, such as a hard disk drive or solid-state drive. Memory 1304 stores an operating system 1312. In some configurations, the memory 1304 stores instructions for operating the idea trading platform 100, the validator 104, the first user interface 108, the comparator 110, the ingestion engine 120, the listings generator 122, the second user interface 128, the arbiter 138, the reporter 140, the secure document viewer 148, the routine 700, the routine 800, the routine 900, the routine 1000, and the routine 1100.

These and other software components may be loaded into memory 1304 of system 1300 using a drive mechanism (not shown) associated with a non-transitory computer-readable 1316, such as a DVD/CD-ROM drive, memory card, network download, or the like.

Memory 1304 also includes database 1314. In some embodiments, system 1300 may communicate with database 1314 via network interface 1308, a storage area network (“SAN”), a high-speed serial bus, and/or via the other suitable communication technology.

In some embodiments, database 1314 may comprise one or more storage resources provisioned from a “cloud storage” provider, for example, Amazon Simple Storage Service (“Amazon S3”), provided by Amazon.com, Inc. of Seattle, Washington, Google Cloud Storage, provided by Google, Inc. of Mountain View, California, and the like.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

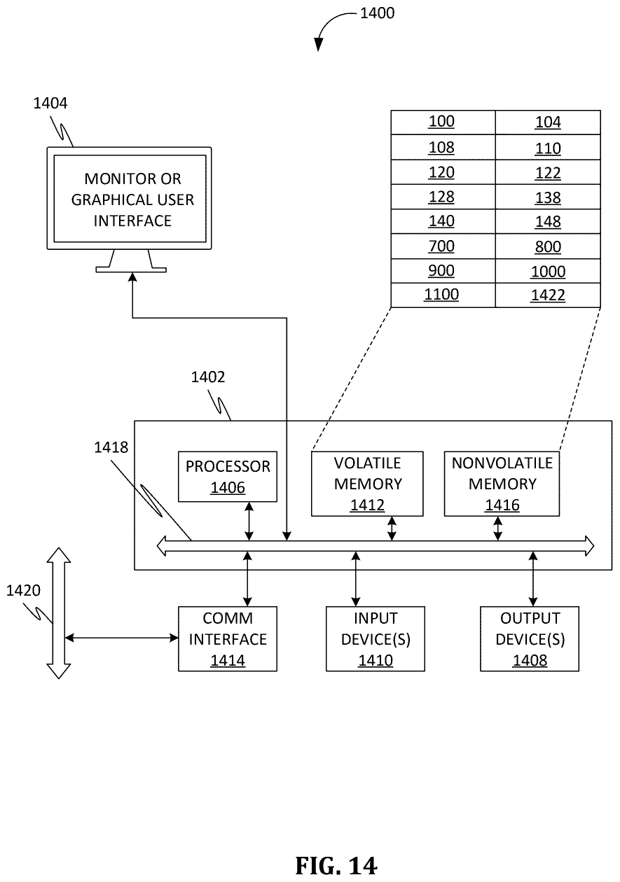

FIG. 14 is an example block diagram of a computing device 1400 that may incorporate embodiments of the present invention. FIG. 14 is merely illustrative of a machine system to carry out aspects of the technical processes described herein, and does not limit the scope of the claims. One of ordinary skill in the art would recognize other variations, modifications, and alternatives. In one embodiment, the computing device 1400 typically includes a monitor or graphical user interface 1404, a data processing system 1402, a communication network interface 1414, input device(s) 1410, output device(s) 1408, and the like.

As depicted in FIG. 14, the data processing system 1402 may include one or more processor(s) 1406 that communicate with a number of peripheral devices via a bus subsystem 1418. These peripheral devices may include input device(s) 1410, output device(s) 1408, communication network interface 1414, and a storage subsystem, such as a volatile memory 1412 and a nonvolatile memory 1416.

The volatile memory 1412 and/or the nonvolatile memory 1416 may store computer-executable instructions and thus forming logic 1422 that when applied to and executed by the processor(s) 1406 implement embodiments of the processes disclosed herein. In addition, the volatile memory 1412 and the nonvolatile memory 1416 may store logic for operating the operating the idea trading platform 100, the validator 104, the first user interface 108, the comparator 110, the ingestion engine 120, the listings generator 122, the second user interface 128, the arbiter 138, the reporter 140, the secure document viewer 148, the routine 700, the routine 800, the routine 900, the routine 1000, and the routine 1100.

The input device(s) 1410 include devices and mechanisms for inputting information to the data processing system 1402. These may include a keyboard, a keypad, a touch screen incorporated into the monitor or graphical user interface 1404, audio input devices such as voice recognition systems, microphones, and other types of input devices. In various embodiments, the input device(s) 1410 may be embodied as a computer mouse, a trackball, a track pad, a joystick, wireless remote, drawing tablet, voice command system, eye tracking system, and the like. The input device(s) 1410 typically allow a user to select objects, icons, control areas, text and the like that appear on the monitor or graphical user interface 1404 via a command such as a click of a button or the like.

The output device(s) 1408 include devices and mechanisms for outputting information from the data processing system 1402. These may include the monitor or graphical user interface 1404, speakers, printers, infrared LEDs, and so on as well understood in the art.

The communication network interface 1414 provides an interface to communication networks (e.g., communication network 1420) and devices external to the data processing system 1402. The communication network interface 1414 may serve as an interface for receiving data from and transmitting data to other systems. Embodiments of the communication network interface 1414 may include an Ethernet interface, a modem (telephone, satellite, cable, ISDN), (asynchronous) digital subscriber line (DSL), FireWire, USB, a wireless communication interface such as Bluetooth or WiFi, a near field communication wireless interface, a cellular interface, and the like.

The communication network interface 1414 may be coupled to the communication network 1420 via an antenna, a cable, or the like. In some embodiments, the communication network interface 1414 may be physically integrated on a circuit board of the data processing system 1402, or in some cases may be implemented in software or firmware, such as “soft modems”, or the like.

The computing device 1400 may include logic that enables communications over a network using protocols such as HTTP, TCP/IP, RTP/RTSP, IPX, UDP and the like.

The volatile memory 1412 and the nonvolatile memory 1416 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1412 and the nonvolatile memory 1416 may be configured to store the basic programming and data constructs that provide the functionality of the disclosed processes and other embodiments thereof that fall within the scope of the present invention.

Logic 1422 that implements embodiments of the present invention may be stored in the volatile memory 1412 and/or the nonvolatile memory 1416. Said logic 1422 may be read from the volatile memory 1412 and/or nonvolatile memory 1416 and executed by the processor(s) 1406. The volatile memory 1412 and the nonvolatile memory 1416 may also provide a repository for storing data used by the logic 1422.

The volatile memory 1412 and the nonvolatile memory 1416 may include a number of memories including a main random access memory (RAM) for storage of instructions and data during program execution and a read only memory (ROM) in which read-only non-transitory instructions are stored. The volatile memory 1412 and the nonvolatile memory 1416 may include a file storage subsystem providing persistent (non-volatile) storage for program and data files. The volatile memory 1412 and the nonvolatile memory 1416 may include removable storage systems, such as removable flash memory.

The bus subsystem 1418 provides a mechanism for enabling the various components and subsystems of data processing system 1402 communicate with each other as intended. Although the communication network interface 1414 is depicted schematically as a single bus, some embodiments of the bus subsystem 1418 may utilize multiple distinct busses.

It will be readily apparent to one of ordinary skill in the art that the computing device 1400 may be a device such as a smartphone, a desktop computer, a laptop computer, a rack-mounted computer system, a computer server, or a tablet computer device. As commonly known in the art, the computing device 1400 may be implemented as a collection of multiple networked computing devices. Further, the computing device 1400 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

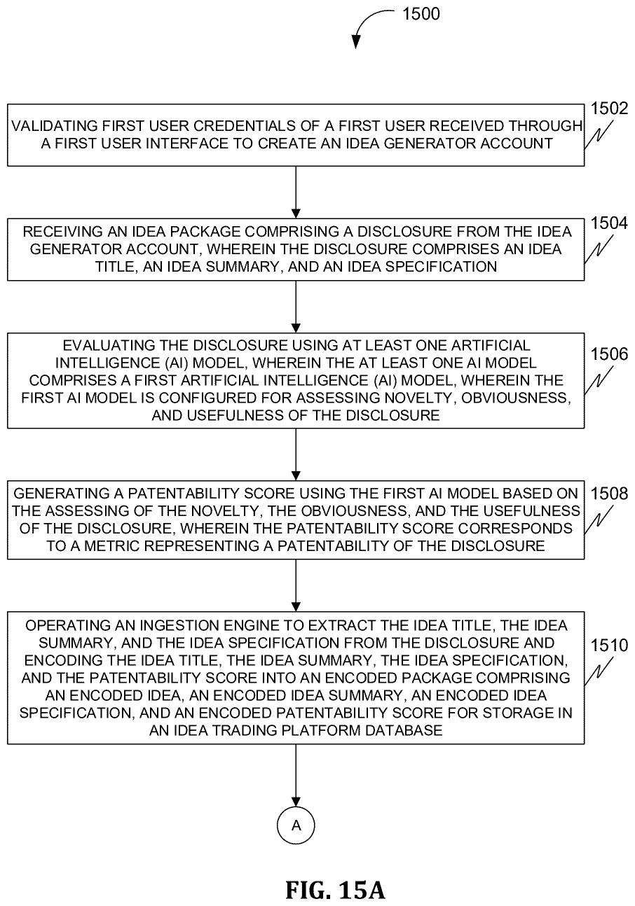

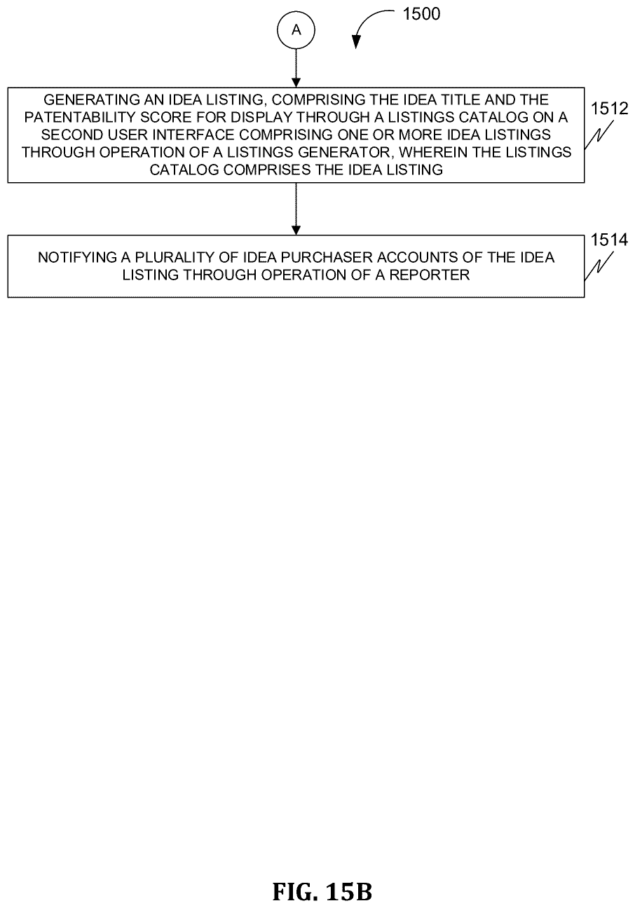

FIG. 15A and FIG. 15B illustrate a flowchart of a method 1500 of operating an idea trading platform using artificial intelligence (AI) models, in accordance with some embodiments.

Accordingly, the method 1500 may include a step 1502 of validating first user credentials of a first user received through a first user interface to create an idea generator account. Further, the method 1500 may include a step 1504 of receiving an idea package comprising a disclosure from the idea generator account. Further, the disclosure includes an idea title, an idea summary, and an idea specification. Further, the method 1500 may include a step 1506 of evaluating the disclosure using one or more artificial intelligence (AI) models. Further, the one or more AI models includes a first artificial intelligence (AI) model. Further, the first AI model may be configured for assessing novelty, obviousness, and usefulness of the disclosure. Further, the method 1500 may include a step 1508 of generating a patentability score using the first AI model based on the assessing of the novelty, the obviousness, and the usefulness of the disclosure. Further, the patentability score corresponds to a metric representing a patentability of the disclosure. Further, the method 1500 may include a step 1510 of operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database. Further, the method 1500 may include a step 1512 of generating an idea listing, comprising the idea title and the patentability score for display through a listings catalog on a second user interface comprising one or more idea listings through operation of a listings generator. Further, the listings catalog includes the idea listing. Further, the method 1500 may include a step 1514 of notifying two or more idea purchaser accounts of the idea listing through operation of a reporter.

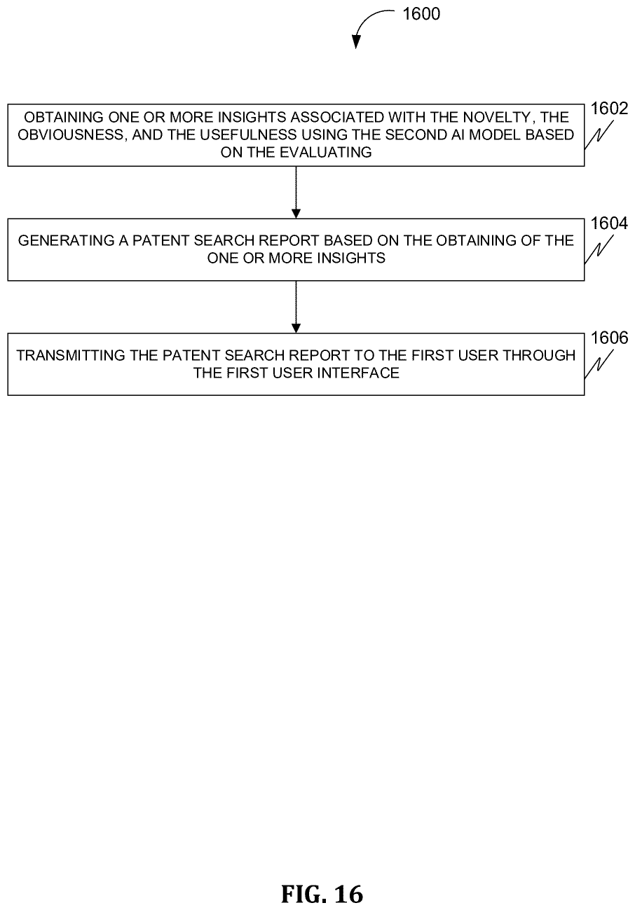

FIG. 16 illustrates a flowchart of a method 1600 of operating an idea trading platform using artificial intelligence (AI) models including generating a patent search report, in accordance with some embodiments.

Further, in some embodiments, the one or more AI models further may include a second artificial intelligence (AI) model. Further, the method 1600 may include a step 1602 of obtaining one or more insights associated with the novelty, the obviousness, and the usefulness using the second AI model based on the evaluating. Further, the method 1600 may include a step 1604 of generating a patent search report based on the obtaining of the one or more insights. Further, the method 1600 may include a step 1606 of transmitting the patent search report to the first user through the first user interface.

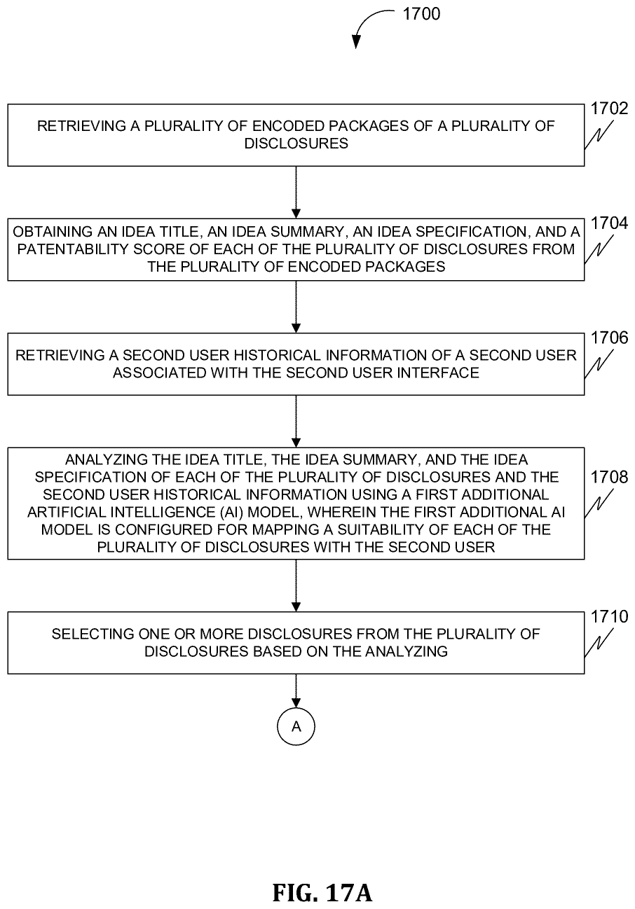

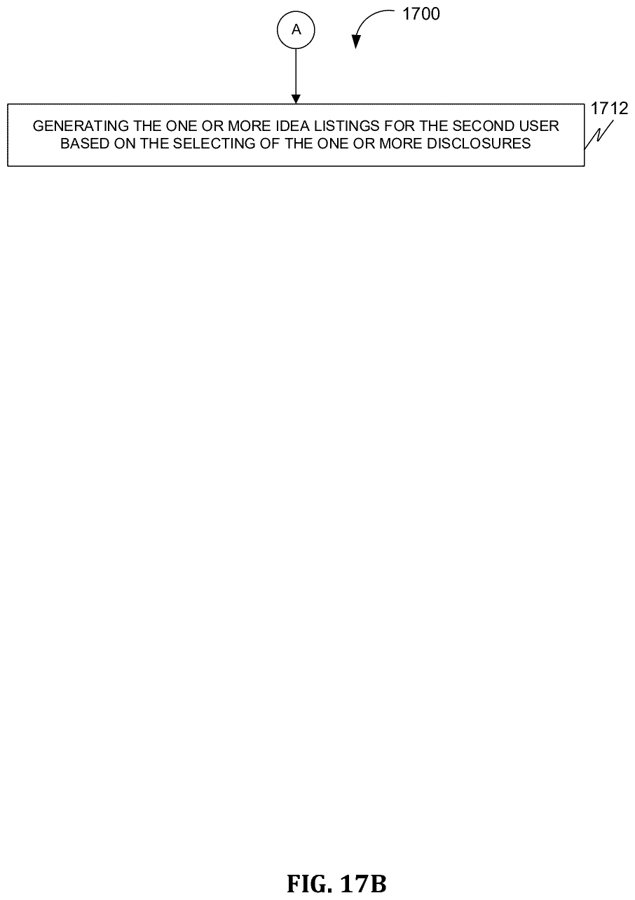

FIG. 17A and FIG. 17B illustrate a flowchart of a method 1700 of operating an idea trading platform using artificial intelligence (AI) models including generating the one or more idea listings for the second user, in accordance with some embodiments.

Further, in some embodiments, the method 1700 further may include a step 1702 of retrieving two or more encoded packages of two or more disclosures. Further, in some embodiments, the method 1700 further may include a step 1704 of obtaining an idea title, an idea summary, an idea specification, and a patentability score of each of the two or more disclosures from the two or more encoded packages. Further, in some embodiments, the method 1700 further may include a step 1706 of retrieving a second user historical information of a second user associated with the second user interface. Further, in some embodiments, the method 1700 further may include a step 1708 of analyzing the idea title, the idea summary, and the idea specification of each of the two or more disclosures and the second user historical information using a first additional artificial intelligence (AI) model. Further, the first additional AI model may be configured for mapping a suitability of each of the two or more disclosures with the second user. Further, in some embodiments, the method 1700 further may include a step 1710 of selecting one or more disclosures from the two or more disclosures based on the analyzing. Further, in some embodiments, the method 1700 further may include a step 1712 of generating the one or more idea listings for the second user based on the selecting of the one or more disclosures.

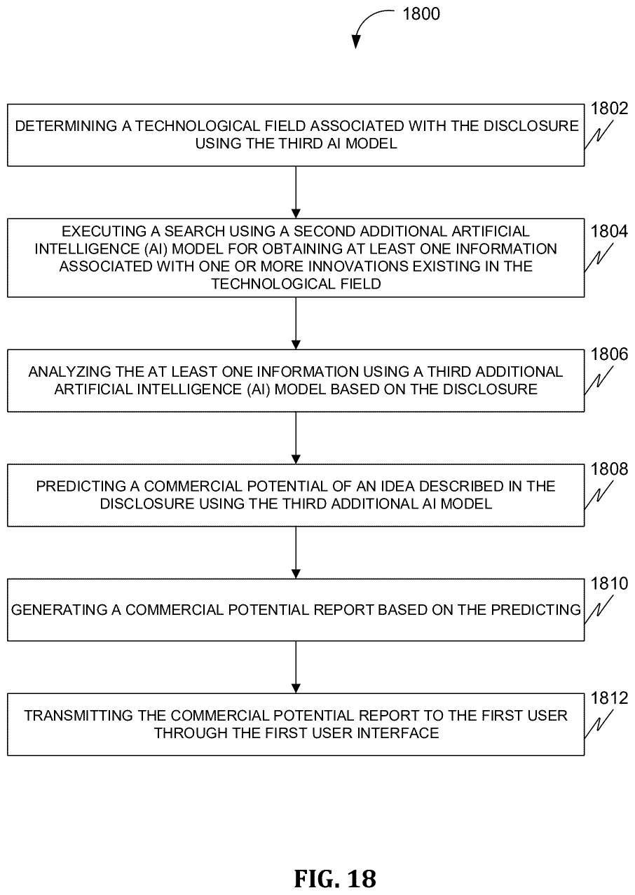

FIG. 18 illustrates a flowchart of a method 1800 of operating an idea trading platform using artificial intelligence (AI) models including generating a commercial potential report, in accordance with some embodiments.

Further, in some embodiments, the one or more AI models may include a third artificial intelligence (AI) model. Further, the method 1800 may include a step 1802 of determining a technological field associated with the disclosure using the third AI model. Further, the method 1800 may include a step 1804 of executing a search using a second additional artificial intelligence (AI) model for obtaining one or more information associated with one or more innovations existing in the technological field. Further, the method 1800 may include a step 1806 of analyzing the one or more information using a third additional artificial intelligence (AI) model based on the disclosure. Further, the method 1800 may include a step 1808 of predicting a commercial potential of an idea described in the disclosure using the third additional AI model. Further, the method 1800 may include a step 1810 of generating a commercial potential report based on the predicting. Further, the method 1800 may include a step 1812 of transmitting the commercial potential report to the first user through the first user interface.

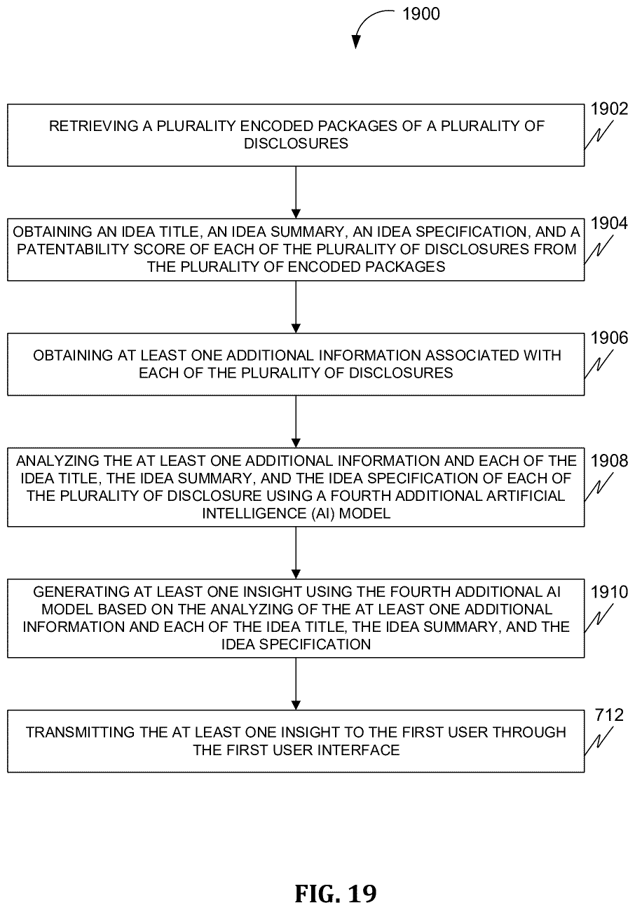

FIG. 19 illustrates a flowchart of a method 1900 of operating an idea trading platform using artificial intelligence (AI) models including generating at least one insight using the fourth additional AI model, in accordance with some embodiments.

Further, in some embodiments, the method 1900 further may include a step 1902 of retrieving a plurality encoded packages of two or more disclosures. Further, in some embodiments, the method 1900 further may include a step 1904 of obtaining the idea title, the idea summary, the idea specification, and the patentability score of each of the two or more disclosures from the two or more encoded packages. Further, in some embodiments, the method 1900 further may include a step 1906 of obtaining one or more additional information associated with each of the two or more disclosures. Further, in some embodiments, the method 1900 further may include a step 1908 of analyzing the one or more additional information and each of the idea title, the idea summary, and the idea specification of each of the two or more disclosures using a fourth additional artificial intelligence (AI) model. Further, in some embodiments, the method 1900 further may include a step 1910 of generating one or more insights using the fourth additional AI model based on the analyzing of the one or more additional information and each of the idea title, the idea summary, and the idea specification. Further, in some embodiments, the method 1900 further may include a step 1912 of transmitting the one or more insights to the first user through the first user interface.

In some embodiments, the method 1900 may further include retaining the one or more AI models using the one or more insights. Further, the evaluating may be further based on the retraining of the one or more AI models. Further, the retaining of the one or more AI models improves an ability of the first AI model for the assessing of the novelty, the obviousness, and the usefulness of the disclosure.

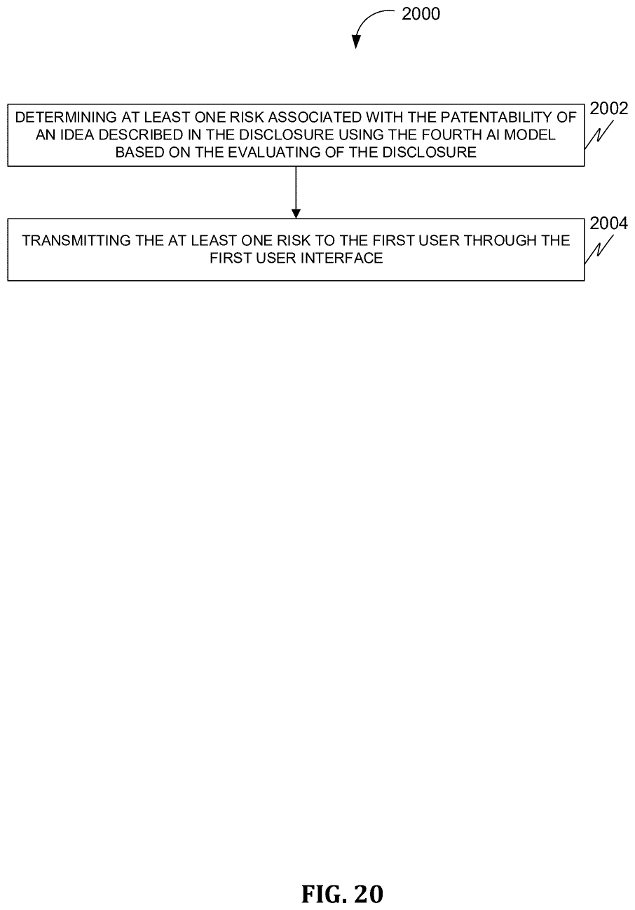

FIG. 20 illustrates a flowchart of a method 2000 of operating an idea trading platform using artificial intelligence (AI) models including determining at least one risk associated with the patentability of an idea described in the disclosure using the fourth AI model, in accordance with some embodiments.

Further, in some embodiments, the one or more AI models may include a fourth artificial intelligence (AI) model. Further, the method 2000 may include a step 2002 of determining one or more risks associated with the patentability of an idea described in the disclosure using the fourth AI model based on the evaluating of the disclosure. Further, the method 2000 may include a step 2004 of transmitting the one or more risks to the first user through the first user interface.

Accordingly, the computing apparatus may include a processor. Further, the computing apparatus may include a processor. Further, the computing apparatus may include a memory storing instructions to be executed by the processor. Further, the computing apparatus may be configured for validating first user credentials of a first user received through a first user interface to create an idea generator account. Further, the computing apparatus may be configured for receiving an idea package comprising a disclosure from the idea generator account. Further, the disclosure includes an idea title, an idea summary, and an idea specification. Further, the computing apparatus may be configured for evaluating the disclosure using one or more artificial intelligence (AI) models. Further, the one or more AI models includes a first artificial intelligence (AI) model. Further, the first AI model may be configured for assessing novelty, obviousness, and usefulness of the disclosure. Further, the computing apparatus may be configured for generating a patentability score using the first AI model based on the assessing of the novelty, the obviousness, and the usefulness of the disclosure. Further, the patentability score corresponds to a metric representing a patentability of the disclosure. Further, the computing apparatus may be configured for operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database. Further, the computing apparatus may be configured for generating an idea listing, comprising the idea title and the patentability score for display through a listings catalog on a second user interface comprising one or more idea listings through operation of a listings generator. Further, the listings catalog includes the idea listing. Further, the computing apparatus may be configured for generating notifying two or more idea purchaser accounts of the idea listing through operation of a reporter.

Further, in some embodiments, the one or more AI models further may include a second artificial intelligence (AI) model. Further, the computing apparatus may be further configured for obtaining one or more insights associated with the novelty, the obviousness, and the usefulness using the second AI model based on the evaluating. Further, the computing apparatus may be further configured for generating a patent search report based on the obtaining of the one or more insights. Further, the computing apparatus may be further configured for transmitting the patent search report to the first user through the first user interface.

Further, in some embodiments, the computing apparatus further may be configured for retrieving two or more encoded packages of two or more disclosures. Further, in some embodiments, the computing apparatus further may be configured for obtaining an idea title, an idea summary, an idea specification, and a patentability score of each of the two or more disclosures from the two or more encoded packages. Further, in some embodiments, the computing apparatus further may be configured for retrieving a second user historical information of a second user associated with the second user interface. Further, in some embodiments, the computing apparatus further may be configured for analyzing the idea title, the idea summary, and the idea specification of each of the two or more disclosures and the second user historical information using a first additional artificial intelligence (AI) model. Further, the first additional AI model may be configured for mapping a suitability of each of the two or more disclosures with the second user. Further, in some embodiments, the computing apparatus further may be configured for selecting one or more disclosures from the two or more disclosures based on the analyzing. Further, in some embodiments, the computing apparatus further may be configured for generating the one or more idea listings for the second user based on the selecting of the one or more disclosures.

Further, in some embodiments, the one or more AI models may include a third artificial intelligence (AI) model. Further, the computing apparatus may be further configured for determining a technological field associated with the disclosure using the third AI model. Further, the computing apparatus may be further configured for executing a search using a second additional artificial intelligence (AI) model for obtaining one or more information associated with one or more innovations existing in the technological field. Further, the computing apparatus may be further configured for analyzing the one or more information using a third additional artificial intelligence (AI) model based on the disclosure. Further, the computing apparatus may be further configured for predicting a commercial potential of an idea described in the disclosure using the third additional AI model. Further, the computing apparatus may be further configured for generating a commercial potential report based on the predicting. Further, the computing apparatus 00 may be further configured for transmitting the commercial potential report to the first user through the first user interface.

Further, in some embodiments, the computing apparatus further may be configured for retrieving a plurality encoded packages of two or more disclosures. Further, in some embodiments, the computing apparatus further may be configured for obtaining an idea title, an idea summary, an idea specification, and a patentability score of each of the two or more disclosures from the two or more encoded packages. Further, in some embodiments, the computing apparatus further may be configured for obtaining one or more additional information associated with each of the two or more disclosures. Further, in some embodiments, the computing apparatus further may be configured for analyzing the one or more additional information and each of the idea title, the idea summary, and the idea specification of each of the two or more disclosures using a fourth additional artificial intelligence (AI) model. Further, in some embodiments, the computing apparatus further may be configured for generating one or more insights using the fourth additional AI model based on the analyzing of the one or more additional information and each of the idea title, the idea summary, and the idea specification. Further, in some embodiments, the computing apparatus further may be configured for transmitting the one or more insights to the first user through the first user interface.

In some embodiments, the computing apparatus may be further configured for retaining the one or more AI models using the one or more insights. Further, the evaluating may be further based on the retraining of the one or more AI models. Further, the retaining of the one or more AI models improves an ability of the first AI model for the assessing of the novelty, the obviousness, and the usefulness of the disclosure.

Further, in some embodiments, the one or more AI models may include a fourth artificial intelligence (AI) model. Further, the computing apparatus may be further configured for determining one or more risks associated with the patentability of an idea described in the disclosure using the fourth AI model based on the evaluating of the disclosure. Further, the computing apparatus may be further configured for transmitting the one or more risks to the first user through the first user interface.

The present disclosure provides a computer-readable storage medium for operating an idea trading platform using artificial intelligence (AI) models. Further, the computer-readable storage medium may include instructions that when executed by a computer, configure the computer for validating first user credentials of a first user received through a first user interface to create an idea generator account. Further, the computer-readable storage medium may include instructions that when executed by a computer, configure the computer for receiving an idea package comprising a disclosure from the idea generator account. Further, the disclosure includes an idea title, an idea summary, and an idea specification. Further, the computer-readable storage medium may include instructions that when executed by a computer, configure the computer for evaluating the disclosure using one or more artificial intelligence (AI) models. Further, the one or more AI models includes a first artificial intelligence (AI) model. Further, the first AI model may be configured for assessing novelty, obviousness, and usefulness of the disclosure. Further, the computer-readable storage medium may include instructions that when executed by a computer, configure the computer for generating a patentability score using the first AI model based on the assessing of the novelty, the obviousness, and the usefulness of the disclosure. Further, the patentability score corresponds to a metric representing a patentability of the disclosure. Further, the computer-readable storage medium may include instructions that when executed by a computer, configure the computer for operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database. Further, the computer-readable storage medium may include instructions that when executed by a computer, configure the computer for generating an idea listing, comprising the idea title and the patentability score for display through a listings catalog on a second user interface comprising one or more idea listings through operation of a listings generator. Further, the listings catalog includes the idea listing. Further, the computer-readable storage medium may include instructions that when executed by a computer, configure the computer for notifying two or more idea purchaser accounts of the idea listing through operation of a reporter.

Further, in some embodiments, the present disclosure provides the computer-readable storage medium. Further, the one or more AI models further may include a second artificial intelligence (AI) model. Further, the computer may be further configured for obtaining one or more insights associated with the novelty, the obviousness, and the usefulness using the second AI model based on the evaluating. Further, the computer may be further configured for generating a patent search report based on the obtaining of the one or more insights. Further, the computer may be further configured for transmitting the patent search report to the first user through the first user interface.

Further, in some embodiments, the present disclosure provides the computer-readable storage medium. Further, the computer may be further configured for retrieving two or more encoded packages of two or more disclosures. Further, the computer may be further configured for obtaining an idea title, an idea summary, an idea specification, and a patentability score of each of the two or more disclosures from the two or more encoded packages. Further, the computer may be further configured for retrieving a second user historical information of a second user associated with the second user interface. Further, the computer may be further configured for analyzing the idea title, the idea summary, and the idea specification of each of the two or more disclosures and the second user historical information using a first additional artificial intelligence (AI) model. Further, the first additional AI model may be configured for mapping a suitability of each of the two or more disclosures with the second user. Further, the computer may be further configured for selecting one or more disclosures from the two or more disclosures based on the analyzing. Further, the computer may be further configured for generating the one or more idea listings for the second user based on the selecting of the one or more disclosures.

Further, in some embodiments, the present disclosure provides the computer-readable storage medium. Further, the one or more AI models may include a third artificial intelligence (AI) model. Further, the computer may be further configured for determining a technological field associated with the disclosure using the third AI model. Further, the computer may be further configured for executing a search using a second additional artificial intelligence (AI) model for obtaining one or more information associated with one or more innovations existing in the technological field. Further, the computer may be further configured for analyzing the one or more information using a third additional artificial intelligence (AI) model based on the disclosure. Further, the computer may be further configured for predicting a commercial potential of an idea described in the disclosure using the third additional AI model. Further, the computer may be further configured for generating a commercial potential report based on the predicting. Further, the computer may be further configured for transmitting the commercial potential report to the first user through the first user interface.

Further, in some embodiments, the present disclosure provides the computer-readable storage medium. Further, the computer may be further configured for retrieving a plurality encoded packages of two or more disclosures. Further, the computer may be further configured for obtaining an idea title, an idea summary, an idea specification, and a patentability score of each of the two or more disclosures from the two or more encoded packages. Further, the computer may be further configured for obtaining one or more additional information associated with each of the two or more disclosures. Further, the computer may be further configured for analyzing the one or more additional information and each of the idea title, the idea summary, and the idea specification of each of the two or more disclosures using a fourth additional artificial intelligence (AI) model. Further, the computer may be further configured for generating one or more insights using the fourth additional AI model based on the analyzing of the one or more additional information and each of the idea title, the idea summary, and the idea specification. Further, the computer may be further configured for transmitting the one or more insights to the first user through the first user interface.

In some embodiments, the computer may be further configured for retaining the one or more AI models using the one or more insights. Further, the evaluating may be further based on the retraining of the one or more AI models. Further, the retaining of the one or more AI models improves an ability of the first AI model for the assessing of the novelty, the obviousness, and the usefulness of the disclosure.

In some embodiments, the second user historical information includes one or more of a user past interest data, a user sector focus data, and a user patent portfolio data. Further, the user past interest data represents a past interest associated with the second user. Further, the user sector focus data represents a sector-of-focus associated with the second user. Further, the user patent portfolio data represents a patent portfolio associated with the second user.

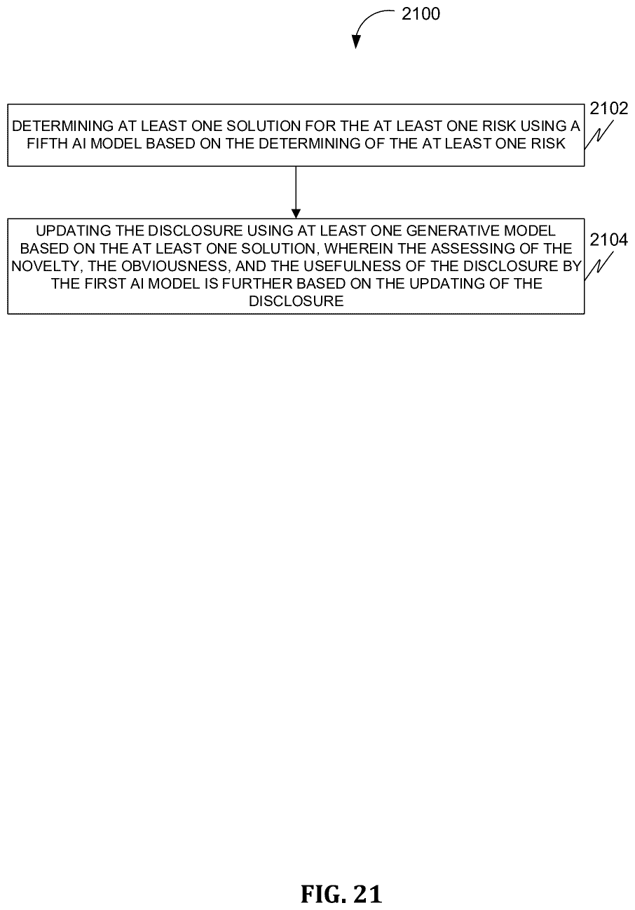

FIG. 21 illustrates a flowchart of a method 2100 of operating an idea trading platform using artificial intelligence (AI) models including updating the disclosure 920 using at least one generative model, in accordance with some embodiments.

Further, in some embodiments, the one or more AI models may include a fifth artificial intelligence (AI) model. Further, the method 2100 further may include a step 2102 of determining one or more solutions for the one or more risks using a fifth AI model based on the determining of the one or more risks. Further, the method 2100 further may include a step 2104 of updating the disclosure using one or more generative models based on the one or more solutions. Further, the assessing of the novelty, the obviousness, and the usefulness of the disclosure by the first AI model may be further based on the updating of the disclosure.

In some embodiments, the one or more AI models includes a sixth artificial intelligence (AI) model. Further, the method 1500 further includes generating a novelty score using the sixth AI model based on the evaluating of the disclosure. Further, the novelty score corresponds to the metric representing the novelty associated with the disclosure.

In some embodiments, the obtaining of the one or more insights may be from an external database. Further, the external database includes one or more of a patent database, a non-patent database, and an idea trading platform database.

In some embodiments, the at least insight includes an innovation trend data representing an innovation trend across one or more of an industry and a geographical area.

In some embodiments, the industry includes a goods and services industry.

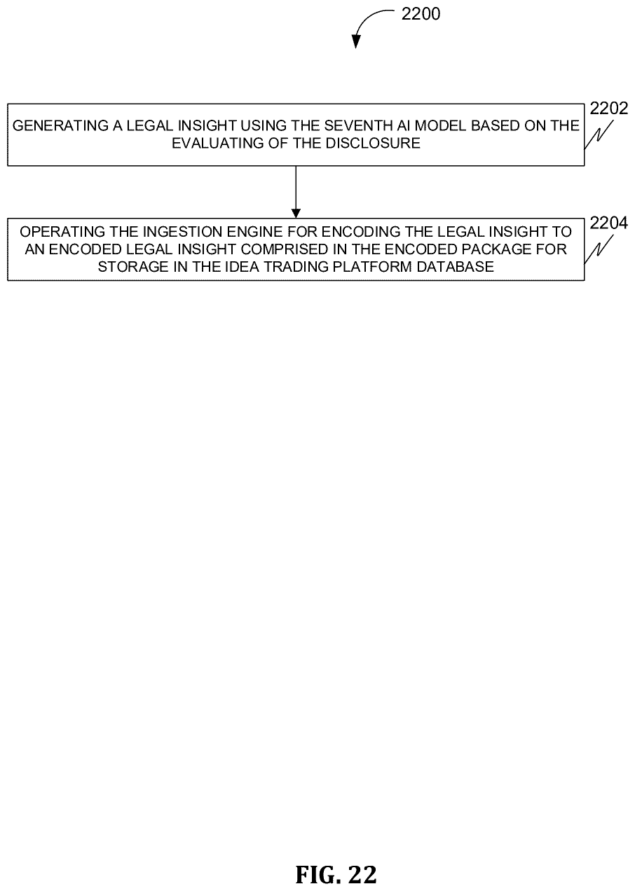

FIG. 22 illustrates a flowchart of a method 2200 of operating an idea trading platform using artificial intelligence (AI) models including operating the ingestion engine for encoding the legal insight to an encoded legal insight comprised in the encoded package for storage in the idea trading platform database, in accordance with some embodiments.

Further, in some embodiments, the one or more AI models may include a seventh artificial intelligence (AI) model. Further, the method 2200 further may include a step 2202 of generating a legal insight using the seventh AI model based on the evaluating of the disclosure. Further, the method 2200 further may include a step 2204 of operating the ingestion engine for encoding the legal insight to an encoded legal insight comprised in the encoded package for storage in the idea trading platform database.

In some embodiments, the idea package further includes an idea registration form corresponding to a standardized form populated by the first user.

In some embodiments, the idea registration form includes a provisional patent application associated with one or more of United States, India, Australia, New Zealand, and South Africa.

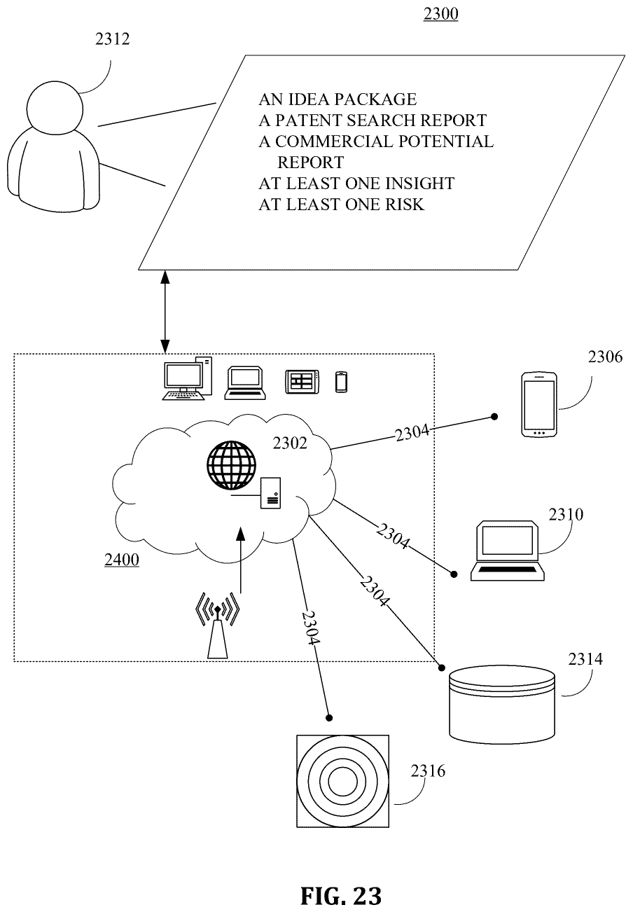

FIG. 23 is an illustration of an online platform 2300 consistent with various embodiments of the present disclosure. By way of non-limiting example, the online platform 2300 may be hosted on a centralized server 2302, such as, for example, a cloud computing service. The centralized server 2302 may communicate with other network entities, such as, for example, a mobile device 2306 (such as a smartphone, a laptop, a tablet computer etc.), other electronic devices 2310 (such as desktop computers, server computers etc.), databases 2314, and sensors 2316 over a communication network 2304, such as, but not limited to, the Internet. Further, users of the online platform 2300 may include relevant parties such as, but not limited to, end-users, administrators, service providers, service consumers and so on. Accordingly, in some instances, electronic devices operated by the one or more relevant parties may be in communication with the platform.

A user 2312, such as the one or more relevant parties, may access online platform 2300 through a web based software application or browser. The web based software application may be embodied as, for example, but not be limited to, a website, a web application, a desktop application, and a mobile application compatible with a computing device 2400.

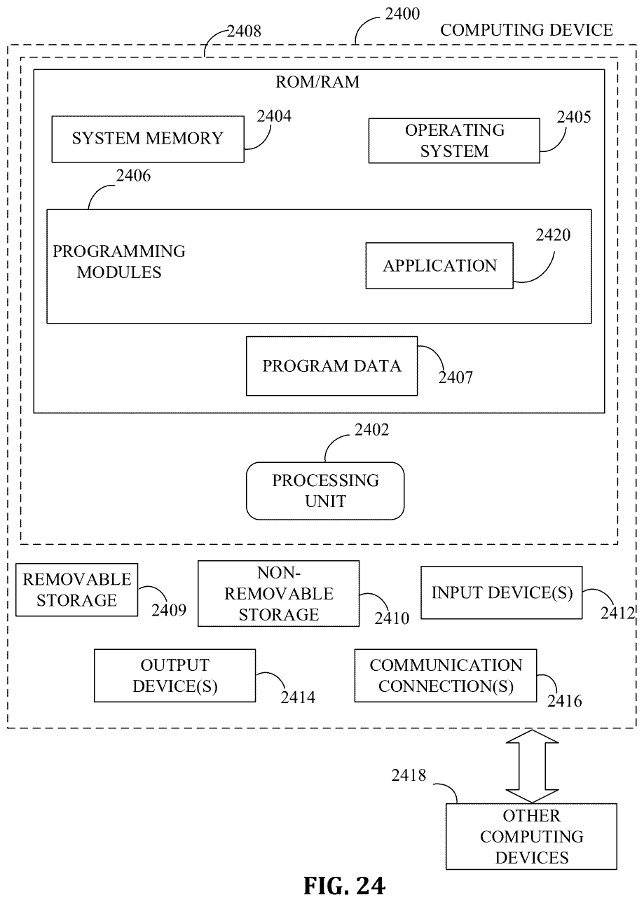

With reference to FIG. 24, a system consistent with an embodiment of the disclosure may include a computing device or cloud service, such as computing device 2400. In a basic configuration, computing device 2400 may include at least one processing unit 2402 and a system memory 2404. Depending on the configuration and type of computing device, system memory 2404 may comprise, but is not limited to, volatile (e.g. random-access memory (RAM)), non-volatile (e.g. read-only memory (ROM)), flash memory, or any combination. System memory 2404 may include operating system 2405, one or more programming modules 2406, and may include a program data 2407. Operating system 2405, for example, may be suitable for controlling computing device 2400's operation. In one embodiment, programming modules 2406 may include image-processing module, machine learning module. Furthermore, embodiments of the disclosure may be practiced in conjunction with a graphics library, other operating systems, or any other application program and is not limited to any particular application or system. This basic configuration is illustrated in FIG. 24 by those components within a dashed line 2408.

Computing device 2400 may have additional features or functionality. For example, computing device 2400 may also include additional data storage devices (removable and/or non-removable) such as, for example, magnetic disks, optical disks, or tape. Such additional storage is illustrated in FIG. 24 by a removable storage 2409 and a non-removable storage 2410. Computer storage media may include volatile and non-volatile, removable and non-removable media implemented in any method or technology for storage of information, such as computer-readable instructions, data structures, program modules, or other data. System memory 2404, removable storage 2409, and non-removable storage 2410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2400. Any such computer storage media may be part of device 2400. Computing device 2400 may also have input device(s) 2412 such as a keyboard, a mouse, a pen, a sound input device, a touch input device, a location sensor, a camera, a biometric sensor, etc. Output device(s) 2414 such as a display, speakers, a printer, etc. may also be included. The aforementioned devices are examples and others may be used.

Computing device 2400 may also contain a communication connection 2416 that may allow device 2400 to communicate with other computing devices 2418, such as over a network in a distributed computing environment, for example, an intranet or the Internet. Communication connection 2416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2404, including operating system 2405. While executing on processing unit 2402, programming modules 2406 (e.g., application 2420 such as a media player) may perform processes including, for example, one or more stages of methods, algorithms, systems, applications, servers, databases as described above. The aforementioned process is an example, and processing unit 2402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A method of operating an idea trading platform using artificial intelligence (AI) models, the method comprising:
validating first user credentials of a first user received through a first user interface to create an idea generator account;
receiving an idea package comprising a disclosure from the idea generator account, wherein the disclosure comprises an idea title, an idea summary, and an idea specification;
evaluating the disclosure using at least one artificial intelligence (AI) model, wherein the at least one AI model comprises a first artificial intelligence (AI) model, wherein the first AI model is configured for assessing novelty, obviousness, and usefulness of the disclosure;
generating a patentability score using the first AI model based on the assessing of the novelty, the obviousness, and the usefulness of the disclosure, wherein the patentability score corresponds to a metric representing a patentability of the disclosure;
operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database;
generating an idea listing, comprising the idea title and the patentability score for display through a listings catalog on a second user interface comprising one or more idea listings through operation of a listings generator, wherein the listings catalog comprises the idea listing; and
notifying a plurality of idea purchaser accounts of the idea listing through operation of a reporter.

2. The method of claim 1, wherein the at least one AI model further comprises a second artificial intelligence (AI) model, wherein the method comprises:
obtaining one or more insights associated with the novelty, the obviousness, and the usefulness using the second AI model based on the evaluating;
generating a patent search report based on the obtaining of the one or more insights; and
transmitting the patent search report to the first user through the first user interface.

3. The method of claim 1 further comprising:
retrieving a plurality of encoded packages of a plurality of disclosures;
obtaining the idea title, the idea summary, the idea specification, and the patentability score of each of the plurality of disclosures from the plurality of encoded packages;
retrieving a second user historical information of a second user associated with the second user interface;
analyzing the idea title, the idea summary, and the idea specification of each of the plurality of disclosures and the second user historical information using a first additional artificial intelligence (AI) model, wherein the first additional AI model is configured for mapping a suitability of each of the plurality of disclosures with the second user;
selecting one or more disclosures from the plurality of disclosures based on the analyzing; and
generating the one or more idea listings for the second user based on the selecting of the one or more disclosures.

4. The method of claim 1, wherein the at least one AI model comprises a third artificial intelligence (AI) model, wherein the method comprises:
determining a technological field associated with the disclosure using the third AI model;
executing a search using a second additional artificial intelligence (AI) model for obtaining at least one information associated with one or more innovations existing in the technological field;
analyzing the at least one information using a third additional artificial intelligence (AI) model based on the disclosure;
predicting a commercial potential of an idea described in the disclosure using the third additional AI model;
generating a commercial potential report based on the predicting; and
transmitting the commercial potential report to the first user through the first user interface.

5. The method of claim 1 further comprising:
retrieving a plurality encoded packages of a plurality of disclosures;
obtaining an idea title, an idea summary, an idea specification, and a patentability score of each of the plurality of disclosures from the plurality of encoded packages;
obtaining at least one additional information associated with each of the plurality of disclosures;
analyzing the at least one additional information and each of the idea title, the idea summary, and the idea specification of each of the plurality of disclosure using a fourth additional artificial intelligence (AI) model;
generating at least one insight using the fourth additional AI model based on the analyzing of the at least one additional information and each of the idea title, the idea summary, and the idea specification; and
transmitting the at least one insight to the first user through the first user interface.

6. The method of claim 5 further comprising retaining the at least one AI model using the at least one insight, wherein the evaluating is further based on the retraining of the at least one AI model, wherein the retaining of the at least one AI model improves an ability of the first AI model for the assessing of the novelty, the obviousness, and the usefulness of the disclosure.

7. The method of claim 1, wherein the at least one AI model comprises a fourth artificial intelligence (AI) model, wherein the method comprises:
determining at least one risk associated with the patentability of an idea described in the disclosure using the fourth AI model based on the evaluating of the disclosure; and
transmitting the at least one risk to the first user through the first user interface.

8. A computing apparatus for operating an idea trading platform using artificial intelligence (AI) models, the computing apparatus comprising:
a processor; and
a memory storing instructions that, when executed by the processor, configure the computing apparatus for:
validating first user credentials of a first user received through a first user interface to create an idea generator account;
receiving an idea package comprising a disclosure from the idea generator account, wherein the disclosure comprises an idea title, an idea summary, and an idea specification;
evaluating the disclosure using at least one artificial intelligence (AI) model, wherein the at least one AI model comprises a first artificial intelligence (AI) model, wherein the first AI model is configured for assessing novelty, obviousness, and usefulness of the disclosure;
generating a patentability score using the first AI model based on the assessing of the novelty, the obviousness, and the usefulness of the disclosure, wherein the patentability score corresponds to a metric representing a patentability of the disclosure;
operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database;
generating an idea listing, comprising the idea title and the patentability score for display through a listings catalog on a second user interface comprising one or more idea listings through operation of a listings generator, wherein the listings catalog comprises the idea listing; and
notifying a plurality of idea purchaser accounts of the idea listing through operation of a reporter.

9. The computing apparatus of claim 8, wherein the at least one AI model further comprises a second artificial intelligence (AI) model, wherein the computing apparatus is further configured for:
obtaining one or more insights associated with the novelty, the obviousness, and the usefulness using the second AI model based on the evaluating;
generating a patent search report based on the obtaining of the one or more insights; and
transmitting the patent search report to the first user through the first user interface.

10. The computing apparatus of claim 8 further configured for:
retrieving a plurality of encoded packages of a plurality of disclosures;
obtaining an idea title, an idea summary, an idea specification, and a patentability score of each of the plurality of disclosures from the plurality of encoded packages;
retrieving a second user historical information of a second user associated with the second user interface;
analyzing the idea title, the idea summary, and the idea specification of each of the plurality of disclosures and the second user historical information using a first additional artificial intelligence (AI) model, wherein the first additional AI model is configured for mapping a suitability of each of the plurality of disclosures with the second user;
selecting one or more disclosures from the plurality of disclosures based on the analyzing; and
generating the one or more idea listings for the second user based on the selecting of the one or more disclosures.

11. The computing apparatus of claim 8, wherein the at least one AI model comprises a third artificial intelligence (AI) model, wherein the computing apparatus is further configured for:
determining a technological field associated with the disclosure using the third AI model;
executing a search using a second additional artificial intelligence (AI) model for obtaining at least one information associated with one or more innovations existing in the technological field;
analyzing the at least one information using a third additional artificial intelligence (AI) model based on the disclosure;
predicting a commercial potential of an idea described in the disclosure using the third additional AI model;
generating a commercial potential report based on the predicting; and
transmitting the commercial potential report to the first user through the first user interface.

12. The computing apparatus of claim 8 further configured for:
retrieving a plurality encoded packages of a plurality of disclosures;
obtaining an idea title, an idea summary, an idea specification, and a patentability score of each of the plurality of disclosures from the plurality of encoded packages;
obtaining at least one additional information associated with each of the plurality of disclosures;
analyzing the at least one additional information and each of the idea title, the idea summary, and the idea specification of each of the plurality of disclosure using a fourth additional artificial intelligence (AI) model;
generating at least one insight using the fourth additional AI model based on the analyzing of the at least one additional information and each of the idea title, the idea summary, and the idea specification; and
transmitting the at least one insight to the first user through the first user interface.

13. The computing apparatus of claim 12 further configured for retaining the at least one AI model using the at least one insight, wherein the evaluating is further based on the retraining of the at least one AI model, wherein the retaining of the at least one AI model improves an ability of the first AI model for the assessing of the novelty, the obviousness, and the usefulness of the disclosure.

14. The computing apparatus of claim 8, wherein the at least one AI model comprises a fourth artificial intelligence (AI) model, wherein the computing apparatus is further configured for:
determining at least one risk associated with the patentability of an idea described in the disclosure using the fourth AI model based on the evaluating of the disclosure; and
transmitting the at least one risk to the first user through the first user interface.

15. A computer-readable storage medium for operating an idea trading platform using artificial intelligence (AI) models, the computer-readable storage medium including instructions that when executed by a computer, configure the computer for:
validating first user credentials of a first user received through a first user interface to create an idea generator account;
receiving an idea package comprising a disclosure from the idea generator account, wherein the disclosure comprises an idea title, an idea summary, and an idea specification;
evaluating the disclosure using at least one artificial intelligence (AI) model, wherein the at least one AI model comprises a first artificial intelligence (AI) model, wherein the first AI model is configured for assessing novelty, obviousness, and usefulness of the disclosure;
generating a patentability score using the first AI model based on the assessing of the novelty, the obviousness, and the usefulness of the disclosure, wherein the patentability score corresponds to a metric representing a patentability of the disclosure;
operating an ingestion engine to extract the idea title, the idea summary, and the idea specification from the disclosure and encoding the idea title, the idea summary, the idea specification, and the patentability score into an encoded package comprising an encoded idea, an encoded idea summary, an encoded idea specification, and an encoded patentability score for storage in an idea trading platform database;
generating an idea listing, comprising the idea title and the patentability score for display through a listings catalog on a second user interface comprising one or more idea listings through operation of a listings generator, wherein the listings catalog comprises the idea listing; and
notifying a plurality of idea purchaser accounts of the idea listing through operation of a reporter.

16. The computer-readable storage medium of claim 15, wherein the at least one AI model further comprises a second artificial intelligence (AI) model, wherein the computer is further configured for:
obtaining one or more insights associated with the novelty, the obviousness, and the usefulness using the second AI model based on the evaluating;
generating a patent search report based on the obtaining of the one or more insights; and
transmitting the patent search report to the first user through the first user interface.

17. The computer-readable storage medium of claim 15, wherein the computer is further configured for:
retrieving a plurality of encoded packages of a plurality of disclosures;
obtaining an idea title, an idea summary, an idea specification, and a patentability score of each of the plurality of disclosures from the plurality of encoded packages;
retrieving a second user historical information of a second user associated with the second user interface;
analyzing the idea title, the idea summary, and the idea specification of each of the plurality of disclosures and the second user historical information using a first additional artificial intelligence (AI) model, wherein the first additional AI model is configured for mapping a suitability of each of the plurality of disclosures with the second user;
selecting one or more disclosures from the plurality of disclosures based on the analyzing; and
generating the one or more idea listings for the second user based on the selecting of the one or more disclosures.

18. The computer-readable storage medium of claim 15, wherein the at least one AI model comprises a third artificial intelligence (AI) model, wherein the computer is further configured for:
determining a technological field associated with the disclosure using the third AI model;
executing a search using a second additional artificial intelligence (AI) model for obtaining at least one information associated with one or more innovations existing in the technological field;
analyzing the at least one information using a third additional artificial intelligence (AI) model based on the disclosure;
predicting a commercial potential of an idea described in the disclosure using the third additional AI model;
generating a commercial potential report based on the predicting; and
transmitting the commercial potential report to the first user through the first user interface.

19. The computer-readable storage medium of claim 15, wherein the computer is further configured for:
retrieving a plurality encoded packages of a plurality of disclosures;
obtaining an idea title, an idea summary, an idea specification, and a patentability score of each of the plurality of disclosures from the plurality of encoded packages;
obtaining at least one additional information associated with each of the plurality of disclosures;
analyzing the at least one additional information and each of the idea title, the idea summary, and the idea specification of each of the plurality of disclosure using a fourth additional artificial intelligence (AI) model;
generating at least one insight using the fourth additional AI model based on the analyzing of the at least one additional information and each of the idea title, the idea summary, and the idea specification; and
transmitting the at least one insight to the first user through the first user interface.

20. The computer-readable storage medium of claim 19, wherein the computer is further configured for retaining the at least one AI model using the at least one insight, wherein the evaluating is further based on the retraining of the at least one AI model, wherein the retaining of the at least one AI model improves an ability of the first AI model for the assessing of the novelty, the obviousness, and the usefulness of the disclosure.
